(19) United States
(12) Patent Application Publication
(10) Pub. No.: US 2001/0046008 A1
(43) Pub. Date: Nov. 29, 2001

(54) Multi-layer display panel and method of manufacturing the same

(76) Inventors: Masahide Ueda, Kashihara-Shi (JP); Nobuhisa Ishida, Kyoto-Shi (JP); Masakazu Okada, Kyoto-Shi (JP)

Correspondence Address: SIDLEY AUSTIN BROWN & WOOD, 717 NORTH HARWOOD, SUITE 3400, DALLAS, TX, 75201, US

(21) Appl. No.: 09/838,482

(22) Filed: Apr. 19, 2001

(30) Foreign Application Priority Data
Apr. 21, 2000 (JP) 2000-121580

(51) Int. Cl. G02F 1/1347

(52) U.S. Cl. 349/74

(57) ABSTRACT

A method of manufacturing multi-layer display panel provided with a plurality of panel elements layered together, including: a step of forming each of the panel elements using first and substrates each having an electrode; a step of adhering the panel elements; and a step of connecting the electrode on the substrate to a driver element. The multi-layer display panel is manufactured such that the substrate of the each panel element is provided with an overlap portion and a connection portion used for connecting the electrode on the substrate to the driver element. In the adhering step, the panel elements are adhered together while handling at least one of the panel elements to be adhered together as a base panel element, and handling at least one of the panel elements to be adhered together as an additional-adhered panel element. The driver element connecting step with respect to the connection portion, having the electrode formation surface to be hidden by the additional-adhered panel element (or base panel element) after adhering the base and additional-adhered panel elements, of the base panel element (or additional-adhered) is performed before adhering the base and additional-adhered panel elements. Alternatively, the driver element connecting step with respect to the connection portion of only one of the substrates of the additional-adhered panel element is performed before adhering the base and additional-adhered panel elements.

This application is based on patent application No. 2000-121580 pat. filed in Japan, the contents of which are hereby incorporated by reference.

### BACKGROUND OF THE INVENTION

1. Field of the Invention

The present invention relates to a multi-layer display panel including a plurality of panel elements layered together.

Also, the invention relates to a method of manufacturing a multi-layer display panel.

2. Description of the Background Art

Display panels such as a liquid crystal display panel, an electro-luminescence (EL) display panel and a plasma display panel (PDP) have been known. In recent years, the liquid crystal display panels, EL display panels, and PDPs have been used in many cases instead of CRTs.

A multi-layer display panel including a plurality of display panels (panel elements) layered together has been proposed for color display. In the multi-layer display panel, neighboring panel elements are usually adhered together by an adhesive.

In either the single-layer display panel formed of only one panel element or the multi-layer display panel including the plurality of panel elements layered together, each panel element is connected to a driver device for driving the panel element.

For driving the panel element by the driver device, each of substrates of the panel element is provided with an electrode. The electrode on the panel element substrate is usually connected to a driver element (e.g., driver IC) of the driver device, and through the driver element, a voltage is applied to the electrode of the panel element by a control portion (control unit) of the driver device for driving the panel element to perform display.

The driver element is, for example, mounted directly on the substrate of the panel element, and is directly connected to the electrode on the panel element substrate. When directly mounting the driver element on the panel element substrate, a junction substrate is usually connected to the panel element substrate for connecting the driver element on the panel element substrate to the control portion of the driver device.

In some cases, a driver element carrier substrate, which carries the driver element, such as a TCP (Tape Carrier package) is connected to the panel element substrate for connecting the electrode on the panel element substrate to the driver element on the driver element carrier substrate.

When producing the display panel having only one panel element, producing steps are usually performed such that, after forming the panel element, the mounting of the driver element onto the panel element substrate and the connection of the junction substrate are performed, or the connection of the driver element carrier substrate to the panel element substrate is performed.

However, a manner of mounting the driver element and others has not been proposed in connection with the manufacturing of the multi-layer display panel including the plurality of panel elements layered together.

For manufacturing the multi-layer display panel, it may be envisaged that the operation such as driver element mounting is performed after overlaying the panel elements together.

However, this manner may result in such a situation that the mounting surface, onto which the driver element is to be mounted, of the panel element substrate is hidden by the other panel element because the plurality of panel elements are layered in the multi-layer display panel. Further, the connection surface, to which the junction substrate is to be connected, of the panel element substrate may be hidden by the other panel element. If hidden, it is extremely difficult to perform mounting of the driver element and connection of the junction substrate.

For producing the multi-layer display panel, it may be envisaged to employ such a manner that the driver element is mounted onto each panel element before overlaying the panel elements, and the junction substrate is connected to each panel element before overlaying the panel elements.

However, according to the above manner, bubbles may remain between the neighboring panel elements when overlaying and adhering the neighboring panel elements. This is because that the driver IC and junction substrate, which are already mounted and connected to the panel element, impede employment of a manner of preventing remaining of bubbles between the panel elements when performing overlaying and adhering the neighboring panel elements.

The above disadvantage occurs not only when directly mounting the driver IC onto the panel element substrate in the multi-layer display panel but also when connecting the driver element carrier substrate carrying the driver element to the panel element substrate.

### SUMMARY OF THE INVENTION

An object of the invention is to provide a method of manufacturing a multi-layer display panel provided with a plurality of panel elements layered together, and particularly to provide the method of manufacturing the multi-layer display panel in which an operation such as driver element mounting (e.g., mounting of a driver element, connection of a junction substrate and/or connection of a driver element carrier substrate) can be performed easily.

Another object of the invention is to provide a method of manufacturing a multi-layer display panel, which can suppress remaining of bubbles between panel elements, and allows easy the operation such as driver element mounting.

Still another object of the invention is to provide a multi-layer display panel provided with a plurality of panel elements layered together, and particularly to provide the multi-layer display panel which allows easy the operation such as driver element mounting, and thereby easy manufacturing.

Further another object of the invention is to provide a multi-layer display panel having a small frame width.

(1) Multi-layer Display Panel

The invention provides a multi-layer display panel including a plurality of panel elements layered together.

Each of the panel elements has first and second substrates opposed to each other.

A column electrode is formed on an electrode formation surface of the first substrate of each of the panel elements. The electrode formation surface of the first substrate of the panel element is opposed to the second substrate of the same panel element.

A row electrode is formed on an electrode formation surface of the second substrate of each of the panel elements. The electrode formation surface of the second substrate of the panel element is opposed to the first substrate of the same panel element.

The first substrate of each of the panel elements has an overlap portion overlapping with all the other substrates, and a connection portion extending from the overlap portion and used for connecting the column electrode on the first substrate to a driver element.

The second substrate of each of the panel elements has an overlap portion overlapping with all the other substrates, and a connection portion extending from the overlap portion and used for connecting the row electrode on the second substrate to a driver element.

All extending directions of the connection portions of the first substrates of the panel elements are same, and

all extending directions of the connection portions of the second substrates of the panel elements are same.

(2) Method of Manufacturing Multi-layer Display Panel

The invention also provides a method of manufacturing a multi-layer display panel provided with a plurality of panel elements layered together.

The method includes:

a panel element forming step of forming each of the panel elements using a first substrate provided with a column electrode at an electrode formation surface and a second substrate provided with a row electrode at an electrode formation surface;

an adhering step of adhering the panel elements in a predetermined order; and

a driver element connecting step of connecting the electrode on the substrate of the panel element to a driver element by mounting the driver element onto the substrate of the panel element or by connecting a driver element carrier substrate carrying the driver element to the substrate of the panel element.

The multi-layer display panel is manufactured such that the first substrate of each of the panel elements is provided with an overlap portion overlapping with all the other substrates of the panel elements, and a connection portion extending from the overlap portion and used for connecting the column electrode on the first substrate to the driver element.

The multi-layer display panel is manufactured such that the second substrate of each of the panel elements is provided with an overlap portion overlapping with all the other substrates of the panel elements, and a connection portion extending from the overlap portion and used for connecting the row electrode on the second substrate to the driver element.

In the panel element forming step, the first and second substrates of the same panel element are overlaid together to form the panel element such that each of the column and row electrodes is located at an inner side of the overlaid first and second substrates.

In the driver element connecting step, the driver element is mounted onto the connection portion of the substrate of the panel element, or the driver element carrier substrate is connected to the connection portion of the substrate of the panel element, for connecting the electrode on the substrate of the panel element to the driver element.

In the adhering step, the panel elements are adhered together while handling at least one of the panel elements to be adhered together as a base panel element, and handling at least one of the panel elements to be adhered together as an additional-adhered panel element to be adhered to the base panel element.

(2-1) In an aspect of the invention,

the driver element connecting step with respect to the connection portion, having the electrode formation surface to be hidden by the additional-adhered panel element after adhering the base and additional-adhered panel elements, of the substrate of the base panel element is performed before adhering the base and additional-adhered panel elements, and

the driver element connecting step with respect to the connection portion, having the electrode formation surface to be hidden by the base panel element after adhering the base and additional-adhered panel elements, of the substrate of the additional-adhered panel element is performed before adhering the base and additional-adhered panel elements.

(2-2) In another aspect of the invention,

the driver element connecting step with respect to the connection portion of only one of the first and second substrates of the additional-adhered panel element is performed before adhering the base and additional-adhered panel elements, and

the driver element connecting step with respect to the connection portion of the other substrate of the additional-adhered panel element is performed after adhering the base and additional-adhered panel elements.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1(A) is a schematic perspective view of an example of a multi-layer liquid crystal display panel (multi-layer LCD panel) according to the invention viewed from a front side, and

FIG. 1(B) is a schematic perspective view of the LCD panel viewed from a back side;

FIGS. 2(A) and 2(B) are schematic perspective views of the multi-layer LCD panel shown in FIGS. 1(A) and 1(B) with drive ICs and junction substrates removed, respectively;

FIG. 3(A) is a schematic plan showing the front side of the multi-layer LCD panel shown in FIG. 1(A), and FIG. 3(B) is a schematic plan showing the back side of the LCD panel;

FIG. 4(A) is a schematic cross section of the multi-layer LCD panel taken along line 4A-4A in FIG. 3(A), and FIG. 4(B) is a schematic cross section of the LCD panel taken along line 4B-4B in FIG. 3(A);

FIGS. 5(A) and 5(B) are schematic side views of the multi-layer LCD panel shown in FIG. 1(A);

FIG. 6 shows a display region of the multi-layer LCD panel shown in FIG. 1(A);

FIG. 7 is a schematic block diagram showing an example of a drive device;

FIG. 8 is an exploded view of the multi-layer LCD panel shown in FIG. 1(A);

FIG. 9 is a side view showing the multi-layer LCD panel shown in FIG. 1(A) with its junction substrate folded back;

FIG. 10 is a schematic perspective view of another example of the multi-layer LCD panel according to the invention;

FIG. 11 is a schematic perspective view of still another example of the multi-layer LCD panel according to the invention viewed from a front side;

FIG. 12 is a schematic perspective view of the multi-layer LCD panel in FIG. 11 viewed from a back side;

FIG. 13 is a schematic perspective view of yet another example of the multi-layer LCD panel according to the invention viewed from a front side;

FIG. 14 is a schematic perspective view of the multi-layer LCD panel in FIG. 13 viewed from a back side;

FIG. 15 is a schematic perspective view of further another example of the multi-layer LCD panel according to the invention viewed from a front side;

FIG. 16 is a schematic perspective view of the multi-layer LCD panel in FIG. 15 viewed from a back side;

FIG. 17 is a schematic plan of the multi-layer LCD panel in FIG. 15 viewed from the front side;

FIG. 18(A) is a schematic plan of a further example of the multi-layer LCD panel according to the invention viewed from a front side, and FIG. 18(B) is a schematic plan of the LCD panel in FIG. 18(A) viewed from a back side;

FIG. 19 is a schematic plan of a further example of the multi-layer LCD panel according to the invention viewed from a front side;

FIG. 20 is a schematic plan of a further example of the multi-layer LCD panel according to the invention viewed from a front side;

FIG. 21 is a schematic block diagram of another example of the drive device;

FIG. 22 is a step diagram showing an example of manufacturing the panel element of the multi-layer LCD panel shown in FIG. 1(A);

FIGS. 23 and 24 are step diagrams showing an example of manufacturing the multi-layer LCD panel shown in FIG. 1(A), respectively;

FIG. 25 is a step diagram showing an example of a manner of manufacturing the multi-layer LCD panel shown in FIG. 13;

FIGS. 26 and 27(A) and 27(B) are step diagrams showing another example of the manner of manufacturing the multi-layer LCD panel shown in FIG. 13;

FIG. 28 shows alignment marks arranged on a connection portion of a substrate;

FIG. 29(A) shows a coating film formed on a surface, opposite to a mounting surface, of a drive IC, and FIG. 29(B) shows a coating film formed on a back surface of a drive IC mounting region of a substrate connecting portion;

FIGS. 30(A)-30(C) shows an example of manner of mounting the drive IC with ACF; and

FIG. 31 shows a manner of mounting the drive IC in a condition that a heat insulator is located between the substrate, on which the drive IC is to be mounted, and the drive IC which is already mounted.

### DESCRIPTION OF THE PREFERRED EMBODIMENTS

[1] Multi-layer Display Panel

[1-1] The multi-layer display panel has a plurality of panel elements (panel cells), which are layered together.

For preventing shifting of positions, the neighboring panel elements may be adhered together by an adhesive such as a adhesive film, double-sided adhesive tape or liquid adhesive. If the neighboring panel elements are adhered to eliminate an air layer therebetween, an amount of transmitted light increases and the display quality can be improved. The plurality of panel elements layered together may be held, e.g., by a holding member for preventing shifting of positions thereof.

The panel element may be, e.g., an liquid crystal display panel (LCD panel) of light transmission type, an LCD panel of light reflection type, an organic electro-luminescence display panel (organic EL display panel), an inorganic electro-luminescence display panel (inorganic EL display panel) or a plasma display panel (PDP).

In the multi-layer display panel, all the panel elements may be of the same kind, or may be of different kinds. The multi-layer display panel may have a plurality of the LCD panels, as the panel elements, layered together.

The multi-layer display panel may have three panel elements layered together, and these three panel elements may be panel elements for display in red, green and blue. This enables full-color or multi-color display.

Each of the panel elements has a pair of substrates, i.e., first and second substrates. In the panel elements, the first and second substrates are opposed to each other with a predetermined space therebetween. The substrate may be a resin substrate, a glass substrate or others. The resin substrate may take a film form or a sheet form. Employment of the resin film substrate(s) as the first and/or second substrate can reduce a whole thickness and a weight of the multi-layer display panel. The material for the resin substrate may be, e.g., polyether sulfone (PES), polycarbonate (PC), polyethylene terephthalate (PET), polyarylate (PA), polyether ether ketone (PEEK), acrylics (PMMA) or ABS.

In each of the panel elements, a column electrode is formed on the first substrate, and a row electrode is formed on the second substrate. These column and row electrodes are provided for driving the panel element to perform display. In the following description, the first substrate carrying the column electrode may be referred to as a “column substrate”. The second substrate carrying the row electrode may be referred to as a “row substrate”.

The column substrate (first substrate) may be provided with an insulating layer, an orientation film and/or other layer(s) in addition to the column electrode, if necessary. Likewise, the row substrate (second substrate) may be provided with an insulating layer, an orientation film and/or other layer(s) in addition to the row electrode, if necessary.

The column electrode may include, e.g., a plurality of belt-like electrodes (belt-like electrode portions), which are parallel to each other, and are arranged at least in a display region with predetermined pitches. Likewise, the row electrode may include, e.g., a plurality of belt-like electrodes, which are parallel to each other, and are arranged at least in the display region with predetermined pitches. For example, the belt-like electrodes forming the column electrode and the belt-like electrodes forming the row electrode may be perpendicular to each other to form a so-called matrix structure.

The column and row electrodes (X-electrode and Y-electrode) may be provided, e.g., for performing simple matrix drive of the panel element.

The column and row electrodes may be provided for performing active matrix drive using, e.g., MIM (Metal Insulator Metal) elements. In this case, one of the column and row electrodes (belt-like electrodes forming the column or row electrode) may be connected to a plurality of MIM elements, and the belt-like electrodes of the other electrode may be arranged in the positions opposed to the respective MIM elements. The MIM elements may be formed on the substrate, which carries the electrode connected to the MIM elements.

The column and row electrodes may be provided for performing, e.g., 7-segment display or character display.

One of the column and row electrodes may be utilized as a so-called data electrode (signal electrode), and the other may be utilized as a so-called scanning electrode.

In any cases, the column electrode is formed on one of two surfaces of the column substrate (first substrate) of the panel element, and particularly on the surface opposed to the row substrate (second substrate) of the same panel element. Likewise, the row electrode is formed on one of two surfaces of the row substrate (second substrate) of the panel element, and particularly on the surface opposed to the column substrate (first substrate) of the same panel element.

The column electrode is to be connected to one or more driver element(s) for driving the panel element. Likewise, the row electrode is to be connected to one or more driver element(s) for driving the panel element. The driver element may be, e.g., a driver IC.

Each of the driver elements to be connected to the column electrode and the row electrode is a part of a driver device for driving the panel element. In addition to the driver element, the driver device may have, e.g., a control portion (control unit) for controlling driving of the driver element. The driver device, which has driver elements to be connected to the column electrode and the row electrode, respectively, may be configured to drive the whole multi-layer display panel or to drive the panel element independently of the other panel element(s).

The column electrode may be connected, e.g., directly to the driver element on the column substrate carrying this column electrode. In other words, the driver element may be directly mounted on the column substrate, and may be directly connected to the column electrode on the column substrate. Similarly, the row electrode may be directly connected to the driver element on the row substrate. In the case where the driver element is directly mounted on the column or row substrate of the panel element, a junction substrate or the like may be additionally connected to the panel element substrate for connecting the driver element mounted on the panel element substrate to the control portion of the driver device.

The column electrode may be indirectly connected to the driver element by connecting a driver element carrier substrate, which carries the driver element(s), such as a TCP (Tape Carrier Package) to the column substrate. Similarly, the row electrode may be indirectly connected to the driver element by connecting a driver element carrier substrate to the row substrate. In the case where the driver element carrier substrate is connected to the substrate of the panel element, a junction substrate may be connected to the driver element carrier substrate for connecting the driver element on the driver element carrier substrate to the control portion of the driver device. Alternatively, the driver element carrier substrate may be directly connected to the control portion of the driver device without interposing the junction substrate therebetween.

In the multi-layer display panel, the plurality of layered panel elements are overlaid partially (not entirely) with each other. In the multi-layer display panel, at least a portion (typically, a majority) of a lap-over portion, where all the panel elements are overlapping to each other, of the multi-layer display panel may be utilized as a display region. The lap-over portion where the panel elements are overlapping to each other may be typically rectangular. The display region may be typically rectangular.

More specifically, in the multi-layer display panel, each column substrate (first substrate) provided with the column electrode has an overlap portion overlapping with all the other substrates, and each row substrate (second substrate) provided with the row electrode has an overlap portion overlapping with all the other substrates. For example, in the multi-layer display panel having three panel elements layered together, each column substrate has the overlap portion overlapping with all the other five substrates, and each row substrate has the overlap portion overlapping with all the other five substrates.

In the multi-layer display panel, each of the column substrates has, in addition to the overlap portion, a connection portion extending in a predetermined extending direction from its overlap portion and used for connecting the column electrode to the driver element. Likewise, each of the row substrates has, in addition to the overlap portion, a connection portion extending in a predetermined extending direction from its overlap portion and used for connecting the row electrode to the driver element.

The connection portion of the column substrate may be utilized as follows. In the case where the driver element is to be directly mounted on the column substrate, this driver element is to be mounted on the connection portion of the column substrate for connecting the column electrode to the driver element on the column substrate. In the case where the driver element is not to be directly mounted on the column substrate, and the driver element carrier substrate, carrying the driver element, is to be connected to the column substrate, this driver element carrier substrate is to be connected to the connection portion of the column substrate for connecting the column electrode on the column substrate to the driver element on the driver element carrier substrate. In the case where the driver element is not to be directly mounted on the column substrate, and a junction substrate not carrying the driver element is to be connected to the column substrate, this junction substrate is to be connected to the connection portion of the column substrate for connecting the column electrode on the column substrate to the driver element in the position other than the column substrate via the junction substrate. The connection portion of the row substrate may be utilized similar to the connection portion of the column substrate.

The extending direction in which the connection portion of the column substrate extends from the overlap portion may be parallel, e.g., to the direction in which the column electrode extends in the display region. Likewise, the extending direction in which the connection portion of the row substrate extends from the overlap portion may be parallel, e.g., to the direction in which the row electrode extends in the display region.

The connection portion of the column substrate is provided at its column electrode formation surface with an electrode pattern for connecting the column electrode to the driver element. In the case where the driver element is to be mounted directly on the column substrate, this electrode pattern may be configured, e.g., for transforming the column electrode pitch in the display region to an output lead pitch of the driver element. Likewise, the connection portion of the row substrate is provided at its row electrode formation surface with an electrode pattern for connecting the row electrode to the driver element.

The connection portion of the column electrode does not overlap with all the other substrates. Likewise, the connection portion of the row electrode does not overlap with all the other substrates. The connection portion of each of the column and row substrates may overlap with one or more other substrate(s) of the panel element(s) but not all of them.

The column substrate and the row substrate of the same panel element overlap only partially with each other. The overlap portion of the column substrate of the panel element (i.e., the column substrate portion overlapping with all the other substrates including the substrates of the other panel element(s)) is at least a portion (typically, a whole or major portion) of the column substrate portion overlapping with the row substrate of the same panel element. Likewise, the overlap portion of the row substrate of the panel element (i.e., the row substrate portion overlapping with all the other substrates including the substrates of the other panel element(s)) is at least a portion (typically, a whole or major portion) of the row substrate portion overlapping with the column substrate of the same panel element.

In the multi-layer display panel, the panel elements may be layered such that the substrates of the respective panel elements are arranged in the following order.

For example, the plurality of panel elements may be layered such that one of the neighboring two substrates of the neighboring two panel elements is the column substrate (first substrate) and the other is the row substrate (second substrate). That is, if the multi-layer display panel has panel elements of N (N is a natural number, and equal to or larger than two) in number, and if first, second, third, . . . and Nth panel elements are layered together in this order, the respective substrates of these panel elements may be layered in the following order. For example, these substrates may be layered in the order of the column substrate of first panel element, the row substrate of first panel element, the column substrate of second panel element, the row substrate of second panel element, the column substrate of third panel element, the row substrate of third panel element, . . . , the column substrate of (N−1)th panel element, the row substrate of (N-1)th panel element, the column substrate of Nth panel element and the row substrate of Nth panel element. Alternatively, these substrates may be layered in the order of the row substrate of first panel element, the column substrate of first panel element, the row substrate of second panel element, the column substrate of second panel element, the row substrate of third panel element, the column substrate of third panel element, . . . , the row substrate of (N−1)th panel element, the column substrate of (N−1)th panel element, the row substrate of Nth panel element and the column substrate of Nth panel element. By layering the substrates in the above order, the electrode formation surfaces of the respective column substrates are directing in the same direction, and further, the electrode formation surfaces of the respective row substrates are directing in the same direction, which is opposite to the direction of the electrode formation surface of the column substrate. The direction of the electrode formation surface of the substrate represents whether the electrode is formed on the front or back surface of the substrate.

Alternatively, the plurality of panel elements may be layered such that each of the neighboring two substrates of the neighboring two panel elements is the column substrate (first substrate) or the row substrate (second substrate). That is, if the multi-layer display panel has panel elements of N (N is a natural number, and equal to or larger than two) in number, and if first, second, third, . . . and Nth panel elements are layered together in this order, the respective substrates of these panel elements may be layered in the following order. If N is an odd number, these substrates may be layered in the order of the column substrate of first panel element, the row substrate of first panel element, the row substrate of second panel element, the column substrate of second panel element, the column substrate of third panel element, the row substrate of third panel element, . . . , the column substrate of Nth panel element and the row substrate of Nth panel element.

In the multi-layer display panel, the connection portions of the column and row substrates of the same panel element extend in the directions forming an angle of 90 degrees therebetween with respect to a center defined by the lap-over portion where all the panel elements are overlapping to each other.

In the following description, the extending direction in which the connection portion of the column or row substrate extends with respect to the center defined by the lap-over portion, where all the panel elements are overlapping to each other (i.e., where all the panel element substrates are overlapping to each other), of the multi-layer display panel may be merely referred to as extending direction of the connection portion of the column or row substrate. In other words, the extending direction of the connection portion of the column substrate is the direction in which this connection portion extends from the overlap portion of this column substrate. Likewise, the extending direction of the connection portion of the row substrate is the direction in which this connection portion extends from the overlap portion of this row substrate.

[1-2] In the multi-layer display panel, all the connection portions of the first substrates of the panel elements extend in the same direction, and all the connection portions of the second substrates of the panel elements extend in the same direction.

Thus, in the multi-layer display panel, the connection portions of the respective substrates extends only two directions, i.e., the extending direction of the connection portion of the first substrate and the extending direction of the connection portion of the second substrate. The extending direction of the connection portion of the second substrate is perpendicular to the extending direction of the connection portion of the first substrate. Accordingly, the frame size of the whole multi-layer display panel can be smaller, compared with the case where the connection portions of the substrates extend in three or four directions.

[1-3] In the multi-layer display panel, the connection portions of the respective substrates may selectively have the structures as described in the following items [1-3-1], [1-3-2] and [1-3-3].

[1-3-1] Overlapping Structure

All the connection portions of the first substrates of all the panel elements may have the same or substantially same width in their extending direction, and may overlap with each other.

Similarly, all the connection portions of the second substrates of all the panel elements may have the same or substantially same width in their extending direction, and may overlap with each other.

In the following description, the above structure of the connection portions of the first (or second) substrates may be referred to as an “overlapping structure”.

According to the overlapping structure of the connection portions of the first (or second) substrates, the width of the connection portion of each first (or second) substrate in its extending direction is merely required to be of a minimum value required for mounting the driver element, connecting the junction substrate and/or connecting the driver element carrier substrate in the state where the panel element is not laid over the other panel element. Thereby, the frame width can be small in the extending direction of the connection portion of the first (or second) substrate. The frame width can be smaller when employing the overlapping structure, compared with the case where a stepwise structure, which will be described later, is employed.

In the overlapping structure of the connection portions of the first (or second) substrates, the width of the connection portion of each first (or second) substrate in a perpendicular direction perpendicular to the extending direction of the connection portion of the first (or second) substrate may be equal to the width of the overlap portion, from which the connection portion is extended, in the same perpendicular direction.

By employing the overlapping structure in the connection portions of the first (or second) substrates, such the advantage can be obtained that the frame width in the extending direction of the connection portions of the first (or second) substrate can be small. However, the electrode formation surface of the connection portion of the first (or second) substrate of the panel element may be hidden by the other panel element, because the connection portions of the first (or second) substrates overlap with each other in the overlapping structure. In the case where the driver element is to be directly mounted on the connection portion, the electrode formation surface of the connection portion is a driver element mounting surface on which the driver element is to be mounted. Therefore, it is difficult to effect the operation such as driver element mounting to one or more of the connection portions of the first (or second) substrates in the overlapping structure after the panel element is overlaid together.

A method of manufacturing the multi-layer display panel will be described later, in which operation such as driver element mounting can be easily effected even onto the connection portion having the electrode formation surface to be hidden by the other panel element after the panel elements are layered together.

[1-3-2] Stepwise Structure

In the case where all the connection portions of the first substrates of all the panel elements have the electrode formation surfaces directing in the same direction, or other case, the respective connection portions of the first substrates of the panel elements may have the different widths in their extending direction, and the widths of the respective connection portions of the first substrates may be increased in the layering order of the first substrates.

Similarly, in the case where all the connection portions of the second substrates of all the panel elements have the electrode formation surfaces directing in the same direction, or other case, the respective connection portions of the second substrates of the panel elements may have the different widths in their extending direction, and the widths of the respective connection portions of the second substrates may be increased in the layering order of the second substrates.

In the following description, the above structure of the connection portions of the first (or second) substrates may be referred to as a “stepwise structure”.

In the stepwise structure of the connection portions of the first (or second) substrates, at least a portion of the electrode formation surface of the connection portion of each of the first (or second) substrates can be exposed.

In the stepwise structure of the connection portions of the first (or second) substrates, the width of the connection portion of each of the first (or second) substrates in the extending direction of the same connection portion may be adjusted to allow mounting of the driver element onto the exposed portion of the connection portion, connection of the junction substrate to the exposed portion and/or connection of the driver element carrier substrate to the exposed portion.

In the stepwise structure of the connection portions of the first (or second) substrates, and in the case where all the connection portions of the first (or second) substrates of all the panel elements have the electrode formation surfaces directing in the same direction, the connection portions of the first (or second) substrates may have the widths, in their extending direction, which increase when viewed from the side allowing viewing of the electrode formation surface. That is, the connection portion nearest to the side allowing viewing of the electrode formation surface has the smallest width, and the connection portion remotest from the side allowing viewing of the electrode formation surface has the largest width. Thereby, at least a portion of the electrode formation surface of the connection portion of each first (or second) substrate can be exposed.

In the stepwise structure of the connection portions of the first (or second) substrates, the connection portion of the first (or second) substrate may have the width, in the perpendicular direction perpendicular to the extending direction of the connection portion of the first (or second) substrate, equal to the width, in the same perpendicular direction, of the overlap portion from which the connection portion is extended.

Although the stepwise structure increases the frame width, it allows operation such as driver element mounting to the connection portion of the first (or second) substrate in the stepwise structure even after the panel elements are overlaid together, because at least a portion of the electrode formation surface of the connection portion of each first substrate (or second substrate) is exposed. Further, repairing of the operation such as driver element mounting can be performed even in the state where the panel elements are overlaid together.

[1-3-3] Shift Structure

At least a portion of the connection portion of the first substrate of each panel element may have a width, in the perpendicular direction perpendicular to the extending direction of the connection portion of the first substrate, smaller than the width, in the same perpendicular direction, of the overlap portion from which the connection portion is extended, and the positions of the respective connection portions of respective first substrates may be shifted from each other in the same perpendicular direction to expose at least a portion of the electrode formation surface of the connection portion of each of the first substrates.

Similarly, at least a portion of the connection portion of the second substrate of each panel element may have a width, in the perpendicular direction perpendicular to the extending direction of the connection portion of the second substrate, smaller than the width, in the same perpendicular direction, of the overlap portion from which the connection portion is extended, and the positions of the respective connection portions of respective second substrates may be shifted from each other in the same perpendicular direction to expose at least a portion of the electrode formation surface of the connection portion of each of the second substrates.

In the following description, the above structure of the connection portions of the first (or second) substrates may be referred to as a “shift structure”.

In the shift structure of the connection portions of the first (or second) substrates, the width of connection portion of each of the first (or second) substrates in the perpendicular direction perpendicular to the extending direction of connection portion of the first (or second) substrate may be adjusted to allow the mounting of the driver element to the exposed portion of the connection portion of the first (or second) substrate, connection of the junction substrate to the exposed portion and/or connection of the driver element carrier substrate to the exposed portion.

In the shift structure of the connection portions of the first (or second) substrates, the connection portion of each first (or second) substrate may partially overlap with the connection portion of the other first (or second) substrate.

In the shift structure of the connection portions of the first (or second) substrates, all the connection portions of the first (or second) substrates may have the same width in the extending direction of the connection portion of the first (or second) substrate.

The shift structure of the connection portions of the first (or second) substrates allows operation such as driver element mounting to the connection portions of each of the first (or second) substrates even after the panel elements are overlaid together, because at least a portion of the electrode formation surface of the connection portion of each first (or second) substrate is exposed. Further, repairing of the operation such as driver element mounting can be performed even in the state where the panel elements are overlaid together.

[1-4] The foregoing structures (overlapping structure, stepwise structure and shift structure) of the connection portions may be applied to the connection portions of the first substrates or the connection portions of the second substrates. The above structures may be combined to provide the following structures in the connection portions of the first and second substrates in the multi-layer display panel.

(1) For example, the overlapping structure may be employed in the connection portions of the first substrates of the panel elements, and the overlapping structure may be employed also in the connection portions of the second substrates of the panel elements.

According to the above structure, the frame width in the extending direction of the connection portion of the first substrate as well as the frame width in the extending direction of the connection portion of the second substrate can be small so that the frame size of the whole multi-layer display panel can be small.

(2) The overlapping structure may be employed in the connection portions of the first substrates of the panel elements, and the stepwise structure may be employed in the connection portions of the second substrates of the panel elements.

(3) The overlapping structure may be employed in the connection portions of the first substrates of the panel elements, and the shift structure may be employed in the connection portions of the second substrates of the panel elements.

(4) The stepwise structure may be employed in the connection portions of the first substrates of the panel elements, and the overlapping structure may be employed in the connection portions of the second substrates of the panel elements.

(5) The stepwise structure may be employed in the connection portions of the first substrates of the panel elements, and the stepwise structure may be employed also in the connection portions of the second substrates of the panel elements.

Thereby, all the electrode formation surfaces of connection portions of all the substrates of all the panel elements can be at least partially exposed.

(6) The stepwise structure may be employed in the connection portions of the first substrates of the panel elements, and the shift structure may be employed in the connection portions of the second substrates of the panel elements.

Thereby, all the electrode formation surfaces of connection portions of all the substrates of all the panel elements can be at least partially exposed.

(7) The shift structure may be employed in the connection portions of the first substrates of the panel elements, and the overlapping structure may be employed in the connection portions of the second substrates of the panel elements.

(8) The shift structure may be employed in the connection portions of the first substrates of the panel elements, and the stepwise structure may be employed in the connection portions of the second substrates of the panel elements.

Thereby, all the electrode formation surfaces of connection portions of all the substrates of all the panel elements can be at least partially exposed.

(9) The shift structure may be employed in the connection portions of the first substrates of the panel elements, and the shift structure may be employed also in the connection portions of the second substrates of the panel elements.

Thereby, all the electrode formation surfaces of connection portions of all the substrates of all the panel elements can be at least partially exposed.

[1-5] The driver element may be directly mounted on the connection portion of the substrate of the panel element, as already described.

For this mounting of the driver element (e.g., driver IC), an anisotropic conductive adhesive such as an ACF (Anisotropic Conductive Film) or anisotropic conductive paste may be used.

The driver elements mounted on the connection portions of the first substrates (or second substrates) having the same extending direction may be located at positions overlapping to each other.

The driver elements mounted on the connection portions of the first substrates (or second substrates) having the same extending direction may be located at positions not overlapping with each other.

In the case where the driver element is mounted directly on the connection portion of the substrate of the panel element, a junction substrate may be additionally connected to the same connection portion for connecting the driver element mounted on the connection portion to the control portion of the driver device.

For connection of this junction substrate, the anisotropic conductive adhesive such as ACF may be used.

The junction substrate may be a flexible substrate. The flexible junction substrate can be folded toward the back side of the observation side of the multi-layer display panel so that the frame width can be small.

[1-6] The driver element carrier substrate (e.g., TCP) carrying the driver element may be connected to the connection portion of the panel element substrate, instead of mounting the driver element directly on the connection portion.

The anisotropic conductive adhesive such as ACF may be used for connection of the driver element carrier substrate.

The driver element carrier substrate may be a flexible substrate. The flexible driver element carrier substrate can be folded toward the back side of the observation side of the multi-layer display panel so that the frame width can be reduced.

[1-7] In the multi-layer display panel, each panel element may be a liquid crystal panel element, in which a liquid crystal is disposed between the column substrate provided with the column electrode and the row substrate provided with the row electrode.

The liquid crystal (liquid crystal composition) to be arranged between the substrates may be a liquid crystal composition including a liquid crystal exhibiting a cholesteric phase, e.g., in a room temperature. The liquid crystal exhibiting the cholesteric phase selectively reflects the light of the wavelength depending on the helical pitch of liquid crystal. Therefore, the liquid crystal panel element including the liquid crystal exhibiting the cholesteric phase can be used as the liquid crystal display panel element of the reflection type.

The liquid crystal exhibiting the cholesteric phase may be a cholesteric liquid crystal which exhibits the cholesteric phase by itself, or a chiral nematic liquid crystal composition including a nematic liquid crystal composition and a chiral agent added thereto. The chiral nematic liquid crystal composition has such an advantage that the helical pitch can be adjusted by controlling an amount of the added chiral agent, and thereby the selective reflection wavelength can be easily adjusted.

[2] Method of Manufacturing Multi-layer Display Panel

In the following description, a method of manufacturing a multi-layer display panel is presented, which can be employed for manufacturing the foregoing multi-layer display panel.

In the following description, two types, i.e., first and second types of method of manufacturing the multi-layer display panel are presented. The contents already described in connection with the multi-layer display panel in the above item [1] can be also true with respect to the first and second types of manufacturing method described below as well as the multi-layer display panels manufactured by the first and second types of manufacturing method.

Description will now be given on the respective types of methods of manufacturing the multi-layer display panel.

[2-1] First Type of Method of Manufacturing Multi-layer Display Panel

[2-1-1] According to the first type of manufacturing method, it is possible to manufacture the multi-layer display panel having any one of the foregoing structures.

The first type of manufacturing method is useful for manufacturing the multi-layer display panel, in which the electrode formation surface of at least one connection portion of the panel element substrate is hidden by the other panel element (substrate of the other panel element).

The first type of manufacturing method may be employed for manufacturing the multi-layer display panel, in which the foregoing overlapping structure is employed in the connection portions of the first substrates (or second substrates).

The first type of manufacturing method includes a panel element forming step, an adhering step and a driver element connecting step. These steps will now be described.

(a) Panel Element Forming Step

In the panel element forming step, each panel element for composing the multi-layer display panel is formed. Each panel element is formed by using the first substrate (column substrate) provided with the column electrode and the second substrate (row substrate) provided with the row electrode.

Each panel element is formed such that the electrode formation surface of each of the substrates is opposed to the other substrate. More specifically, the first and second substrates are overlaid together to form the panel element such that each of the column and row electrodes are located at an inner side of the overlaid first and second substrates.

(b) Adhering Step

In the adhering step, the panel elements thus formed are adhered together in a predetermined order. The neighboring panel elements are adhered together with, e.g., an adhesive such as adhesive film, double-sided adhesive tape or liquid adhesive. For manufacturing the multi-layer display panel having three or more of the panel elements layered together, the adhering of panel elements may be performed two or more times.

(c) Driver Element Connecting Step

In the driver element connecting step, the electrode (column or row electrode) on the substrate (column substrate or row substrate) of the panel element is connected to the driver element. The electrodes on the substrates of the panel elements are connected to the driver elements, respectively.

In the driver element connecting step, the electrode on the substrate of the panel element is connected to the driver element by mounting the driver element directly on the connection portion of the substrate of the panel element, or by connecting the driver element carrier substrate carrying the driver element to the connection portion of the substrate of the panel element.

The driver elements may be mounted on all the substrate connection portions of the multi-layer display panel, respectively, or the driver element carrier substrates may be connected to all the substrate connection portions of the multi-layer display panel, respectively. Alternatively, the driver element(s) may be mounted on one or more substrate connection portion(s) of the multi-layer display panel, and the driver element carrier substrate(s) may be connected to the remaining substrate connection portion(s), respectively.

In the case where the driver element is to be directly mounted on the connection portion of the panel element substrate, the driver element is mounted onto the electrode formation surface of the connection portion of the panel element substrate. In the case where the driver element carrier substrate is to be connected to the connection portion of the panel element substrate, the driver element carrier substrate is likewise connected to the electrode formation surface of the connection portion of the panel element substrate. Therefore, when the driver element connecting step with respect to the connection portion of the panel element substrate is performed, in other words, when the connection portion of the panel element substrate is subjected to the driver element connecting step, in further other words, when performing connection of the driver element by mounting the driver element onto the connection portion of the panel element substrate or by connecting the driver element carrier substrate to the connection portion of the panel element substrate, it is preferable that the electrode formation surface of the connection portion of the panel element substrate is not hidden by the other panel element (more specifically, by the substrate of the other panel element), and is exposed.

In the first type of manufacturing method, the timing of performing the driver element connecting step with respect to the connection portion of the panel element substrate depends on whether the electrode formation surface of this connection portion is hidden by the other panel element or not after adhering the panel elements together or other situation. The driver element connecting step with respect to the respective connection portions may not be performed in the same timing in some cases. In the case of manufacturing the multi-layer display panel, in which at least one of the connection portions is hidden by the other panel element, the timings of performing the driver element connecting step with respect to the respective connection portions of the panel element substrates are different.

The timing of performing the driver element connecting step is closely related to the timing of performing the adhering step, and it is not necessary that these steps are performed in such a manner that the driver element connecting step with respect to all the connection portions is performed after all the panel elements are adhered together. The adhering steps and the driver element connecting steps with respect to the respective connection portions may be performed alternately.

The adhering step and the driver element connecting step will now be described below in greater detail.

[2-1-2] In the adhering step, the panel elements are adhered together while handling at least one of the panel elements to be adhered together as a “base panel element”, and handling at least one of the panel elements to be adhered together as an “additional-adhered panel element” to be adhered to the base panel element. In other words, the panel elements are adhered together in the adhering step while handling at least one of the panel elements to be adhered together as the base panel element, and handling the remaining panel element(s) as the additional-adhered panel element to be adhered to the base panel element.

More specifically, firstly, two panel elements are adhered together in the adhering step. In this operation of adhering the two panel elements, one of the two panel elements is handled as the base panel element, and the other panel element is handled as the additional-adhered panel element to be adhered to the base panel element.

In the case where three or more panel elements are adhered together for producing the multi-layer display panel provided with three or more panel elements layered together, these panel elements may be adhered in the following manner.

For example, two panel elements among the three or more panel elements are firstly adhered together, and thereafter the remaining panel element(s) are adhered one by one to the panel elements already adhered. Thereby, all the three or more panel elements can be efficiently adhered together.

In the operation of adhering the one panel element to the two or three panel elements already adhered, the panel elements already adhered may be handled as the base panel element, to which the one panel element is adhered as the additional-adhered panel element.

More specifically, in the case where the first to Nth (N: natural number larger than one) panel elements of N in number are to be adhered in this order, these panel elements may be adhered in the following manner. First, the first and second panel elements are adhered. In the operation of adhering the first and second panel elements, the first panel element may be handled as the base panel element, and the second panel element may be handled as the additional-adhered panel element. Then, the third panel element is adhered to the first and second panel elements thus adhered while handling the first and second panel elements as the base panel element, and handling the third panel element as the additional-adhered panel element. Thus, in the operation of adhering of the third panel element, the second panel element composes the base panel element, in other words, the second panel element is a part of the base panel element. Thereafter, the fourth, fifth . . . and Nth panel elements are adhered one by one to the panel elements already adhered together in a similar manner as described above.

In the adhering step, the order of adhering the panel elements is not restricted to the order described above. The plurality of panel elements may be adhered in an order other than that already described. The additional-adhered panel element in the adhering step may be composed of a plurality of the panel elements already adhered together.

In any one of the foregoing cases, one or more panel element(s) are handled as the base panel element, and one or more panel element(s) are handled as the additional-adhered panel element to be adhered to the base panel element. The panel element to be firstly handled as the base panel element may be the panel element to be located at the outermost side after adhering all the panel elements together.

In the adhering step, the base and additional-adhered panel elements may be adhered together from one end portion to the other end portion. More specifically, the base and additional-adhered panel elements may be adhered together while moving the portions subjected to the adhering from one end portion to the other end portion. The base and additional-adhered panel elements may be adhered together from one end portion to the other end portion such that, for example, the base panel element is always kept flat, the additional-adhered panel element is adhered from one end portion to the other end portion to the base panel element while bending or curving the additional-adhered panel element during the operation of the adhering, and the additional-adhered panel element becomes finally flat by decreasing the bending angle thereof in the operation of the adhering. By employing, e.g., a flexible substrate such as a resin substrate as each of the first and second substrates of the panel element, the panel element can be bent. By adhering the panel elements in above manner, it is possible to suppress remaining of bubbles between the panel elements. Further, wrinkling of the panel elements can be suppressed. Thereby, the multi-layer display panel of a high display quality can be manufactured.

In the adhering step, the base and additional-adhered panel elements may be adhered together from the center portion to the opposite end portions. More specifically, the base and additional-adhered panel elements may be adhered together while moving the portions to be adhered from the center portion to the opposite end portions. The base and additional-adhered panel elements may be adhered together from center portion to the opposite end portions such that, for example, the base panel element is always kept flat, the additional-adhered panel element is adhered from the center portion to the opposite end portions to the base panel element while bending the additional-adhered panel element during the operation of the adhering, and the additional-adhered panel element becomes finally flat by decreasing the bending angle thereof in the operation of the adhering. By employing, e.g., a flexible substrate such as a resin substrate as each of the first and second substrates of the panel element, the panel element can be bent. By adhering the panel elements in this manner, it is also possible to suppress remaining of bubbles between the panel elements. Further, wrinkling of the panel element can be suppressed.

However, even by employing the above manner for suppressing remaining of bubbles and wrinkling of the panel element, it is difficult to suppress remaining of bubbles between the panel elements and wrinkling, if all the connection portions of the first and second substrates of the additional-adhered panel element are already subjected to the driver element connecting step before adhering the base and additional-adhered panel elements together, in other words, if the connections of the driver elements are already effected to the respective connection portions of the first and second substrates of the additional-adhered panel element before adhering the base and additional-adhered panel elements together. In the case where the additional-adhered panel element is composed of two or more panel elements, it is difficult to suppress remaining of bubbles between the panel elements and wrinkling, if the connection portion of the first substrate of at least one panel element of the additional-adhered panel element and the connection portion of the second substrate of at least one panel element of the additional-adhered panel element are already subjected to the driver element connecting step before adhering the base and additional-adhered panel elements together.

This is because that it is difficult to uniformly bend the additional-adhered panel element in the operation of adhering the base and additional-adhered panel elements together, or the bending itself of the additional-adhered panel element is difficult, if the driver elements, junction substrates or the driver element carrier substrates were connected to both the connection portions of the first and second substrates of the additional-adhered panel element. If the additional-adhered panel element is not bent uniformly in the operation of adhering the base and additional-adhered panel elements together, it is difficult to suppress the remaining of bubbles and wrinkling even if the adhering of the base and additional-adhered panel elements is performed, e.g., from one end portion to the other end portion.

Accordingly, in view of suppressing the bubbles between the panel elements and suppressing the wrinkling of the panel element, it is preferable that the driver element connecting step with respect to one of the connection portions of the first and second substrates of the additional-adhered panel element is not performed before adhering the base and additional-adhered panel elements together, or the driver element connecting step with respect to neither of the connection portion of the first substrate nor the connection portion of the second substrate of the additional-adhered panel element is performed before adhering the base and additional-adhered panel elements together.

In view of the above, it is preferable that the additional-adhered panel element in the adhering step is not composed of a plurality of the panel elements already adhered together, and thus the additional-adhered panel element is composed of the single panel element. This is because as the following reason. In the case where the additional-adhered panel element is composed of a plurality of the panel elements adhered together, the driver element connecting steps with respect to the connection portion of at least one first substrate of the additional-adhered panel element and with respect to the connection portion of at least one second substrate of the additional-adhered panel element are performed before adhering the base and additional-adhered panel elements together, if the driver element connecting steps are performed in accordance with the timing as described later.

[2-1-3] In the first type of manufacturing method, the driver element connecting step with respect to the following connection portions of the base and additional-adhered panel elements is performed in advance before adhering the base and additional-adhered panel elements.

The driver element connecting step with respect to the connection portion, having the electrode formation surface to be hidden by the additional-adhered panel element after adhering the base and additional-adhered panel elements, of the substrate of the base panel element is performed before adhering the base and additional-adhered panel elements.

Also, the driver element connecting step with respect to the connection portion, having the electrode formation surface to be hidden by the base panel element after adhering the base and additional-adhered panel elements, of the substrate of the additional-adhered panel element is performed before adhering the base and additional-adhered panel elements.

Thereby, the driver element connecting step can be easily performed even with respect to the connection portion, of which electrode formation surface is finally hidden by the other panel element after all the panel elements are adhered together. More specifically, the driver element connecting step can be easily performed even with respect to the connection portion, of which electrode formation surface is finally hidden by the other panel element to such an extent that the driver element connecting step cannot be performed easily after all the panel elements are adhered together.

In the case where the connection portion, of which electrode formation surface is hidden by the additional-adhered panel element after adhering the base and additional-adhered panel elements, of the base panel element does not exist, it is not necessary to perform the driver element connecting step with respect to the connection portion of the base panel element before adhering the base and additional-adhered panel elements. Naturally, even in the above case, the driver element connecting step with respect to the connection portion of the substrate of the base panel element may be performed before adhering the base and additional-adhered panel elements. The connection portion of the substrate, to be located remoter from the additional-adhered panel element, between the first and second substrates of the base panel element has a possibility that its electrode formation surface is hidden by the additional-adhered panel element after adhering the base and additional-adhered panel elements. In the case where the base panel element is composed of a plurality of the panel elements, the connection portions of the substrates, to be located remoter from the additional-adhered panel element, among the first and second substrates of the panel elements composing the base panel element have possibilities that their electrode formation surface are hidden by the additional-adhered panel element after adhering the base and additional-adhered panel elements.

Similar to the above, in the case where the connection portion, of which electrode formation surface is hidden by the base panel element after adhering the base and additional-adhered panel elements, of the additional-adhered panel element does not exist, it is not necessary to perform the driver element connecting step with respect to the connection portion of the additional-adhered panel element before adhering the base and additional-adhered panel elements. Naturally, even in the above case, the driver element connecting step with respect to the connection portion of the substrate of the additional-adhered panel element may be performed before adhering the base and additional-adhered panel elements. The connection portion of the substrate to be located remoter from the base panel element between the first and second substrates of the additional-adhered panel element has a possibility that its electrode formation surface is hidden by the additional-adhered panel element after adhering the base and additional-adhered panel elements.

In the case where the additional-adhered panel element is composed of only one panel element, the driver element connecting step with respect to the connection portion of the additional-adhered panel element can be performed in the condition that the additional-adhered panel element is not overlapping with the other panel element. Therefore, this driver element connection can be performed easily.

The driver element connecting step with respect to the connection portion, of which electrode formation surface is exposed even after the adhering the base and additional-adhered panel elements, of the substrate of the additional-adhered panel element may be performed, e.g., after adhering these panel elements. Thereby, in the case where the additional-adhered panel element is composed of only one panel element, the connection portion of the additional-adhered panel element to be subjected to the driver element connecting step before adhering the base and additional-adhered panel elements is one in number at the most. Accordingly, if employing the foregoing manner for suppressing remaining of bubbles and others, this manner functions to obtain the intended effects.

In the case where the electrode formation surface of the connection portion of the substrate of the additional-adhered panel element is exposed after adhering the base and additional-adhered panel elements and even after adhering all the panel elements, the driver element connecting step with respect to this connection portion of the substrate of the additional-adhered panel element may be performed, e.g., after adhering all the panel elements.

In the case that the additional-adhered panel element (first additional-adhered panel element) is adhered to the base panel element, and then the other additional-adhered panel element (second additional-adhered panel element) is further adhered thereto, the adhering of the second additional-adhered panel element may be performed as follows. The first additional-adhered panel element may be handled as the base panel element (a part of the base panel element) in the operation of adhering of the second additional-adhered panel element. In this case, the driver element connecting step is performed in advance before adhering the base panel element and the second additional-adhered panel element, with respect to the connection portion of the first additional-adhered panel element (which is handled as the base panel element in the operation of adhering of the second additional-adhered panel element), more particularly, with respect to the connection portion of the first additional-adhered panel element, of which electrode formation surface is hidden by the second additional-adhered panel element after the adhering the base panel element (including the first additional-adhered panel element) and the second additional-adhered panel element.

[2-1-4] More specifically, the driver element connecting step with respect to the respective connection portions may be performed in the following manner in the case where the first to Nth (N: natural number larger than one) panel elements of N in number are adhered together in this order. In the following description, first to Nth panel elements are adhered together such that the first panel element is firstly handled as the base panel element, and the second, third, . . . , Nth panel elements are adhered one by one as the additional-adhered panel element.

(1) Before adhering the first and second panel elements together in the condition that the first panel element is handled as the base panel element, and the second panel element is handled as the additional-adhered panel element, the driver element connecting step is performed with respect to the following connection portion.

The driver element connecting step is performed in advance with respect to the connection portion, having the electrode formation surface to be hidden by the second panel element, of the first panel element (base panel element).

Also, the driver element connecting step is performed in advance with respect to the connection portion, having the electrode formation surface to be hidden by the first panel element, of the second panel element (additional-adhered panel element).

(2) After adhering the first and second panel elements, and before adhering the third panel element to the first and second panel elements already adhered in the condition that the third panel element is handled as the additional-adhered panel element, the driver element connecting step is performed with respect to the following connection portion.

The driver element connecting step is performed with respect to the connection portion, having the electrode formation surface to be hidden by the third panel element (additional-adhered panel element), of the first and second panel element (base panel element).

Also, the driver element connecting step is performed with respect to the connection portion, having the electrode formation surface to be hidden by the first and/or second panel elements, of the third panel element.

(3) Thereafter, the driver element connecting step is performed in the similar manner as described above when adhering the fourth−Nth panel elements.

[2-1-5] If the driver element connecting step is performed in accordance with the foregoing timing, the electrode formation surface of the connection portion not subjected to the driver element connecting step is exposed even after all the panel elements are adhered together.

Any timing can be selected for performing the driver element connecting step with respect to the connection portion, of which electrode formation surface is exposed even after adhering all the panel elements. In the case where the foregoing stepwise structure or the shift structure is employed in the connection portions, the multi-layer display panel has at least one connection portion, of which electrode formation surface is exposed even after adhering all the panel elements. Although any timing is employed for performing the driver element connecting step with respect to the connection portion of which electrode formation surface is exposed even after adhering all the panel elements, the driver element connecting step with respect to such the connection portion is preferably performed such that the foregoing manner for suppressing remaining of the bubbles functions to achieve the intended effects. The driver element connecting step with respect to the connection portion, of which electrode formation surface is exposed even after adhering all the panel element, may be performed, e.g., after adhering all the panel elements.

The driver element connecting step with respect to the connection portion of each of the first and second substrates of the panel element firstly handled as the base panel element may be performed before adhering the panel element firstly handled as the base panel element and the additional-adhered panel element. Thereby, the driver element connecting step can be easily and efficiently performed with respect to the connection portions of the first and second substrates of the panel element firstly handled as the base panel element. Even by doing this, the foregoing manner for suppressing the remaining of bubbles functions to obtain the intended effects, if the panel element firstly handled as the base panel element is not handled as the additional-adhered panel element in the subsequent operation of adhering.

[2-1-6] In the case where the multi-layer display panel, in which all the connection portions are exposed partially or entirely even after all the panel elements are adhered, is manufactured, the driver element connecting step with respect to the respective connection portions may be performed, e.g., after adhering all the panel elements. In the case where the multi-layer display panel is manufactured such that the connection portions of each of the first and second substrates have the foregoing stepwise structure or the shift structure, the driver element connecting step with respect to the respective connection portions may be performed after adhering all the panel elements.

[2-1-7] Junction Substrate Connecting Step

In the case the driver element is directly mounted on the connection portion of the substrate of the panel element for connecting the electrode on this panel element substrate to the driver element, the junction substrate may be further connected to the same connection portion for connecting the driver element on the panel element substrate to the control portion of the driver device.

This junction substrate connecting step may be performed in accordance with the following timing.

The junction substrate connecting step with respect to the connection portion, of which electrode formation surface is hidden by the panel element after adhering all the panel elements, of the panel element substrate may be performed, for example, in accordance with the same timing as the driver element connecting step with respect to this connection portion is performed (i.e., the mounting of the driver element onto this connection portion is performed). Thereby, the junction substrate connecting step with respect to the connection portion, of which electrode formation surface is finally hidden by the other panel element, can be performed before the electrode formation surface is hidden. Accordingly, the junction substrate connecting step can be performed easily.

The junction substrate connecting step with respect to each of the connection portions may be performed in the same timing as the driver element connecting step with respect to the same connection portion is performed.

Any timing is employed for performing the junction substrate connecting step with respect to the connection portion, of which electrode formation surface is exposed even after adhering all the panel elements. However, the junction substrate connecting step is preferably performed such that the foregoing manner for suppressing remaining of the bubbles functions to achieve the intended effects. The junction substrate connecting step with respect to the connection portion, of which electrode formation surface is exposed even after adhering all the panel element, may be performed, e.g., after adhering all the panel elements.

The junction substrate connecting step with respect to the connection portion of each of the first and second substrates of the panel element firstly handled as the base panel element may be performed before adhering the panel element firstly handled as the base panel element and the additional-adhered panel element. Thereby, the junction substrate connecting step can be easily and efficiently performed with respect to the connection portions of the first and second substrates of the panel element firstly handled as the base panel element. Even by doing this, the foregoing manner for suppressing the remaining of bubbles functions to achieve the intended effects, if the panel element firstly handled as the base panel element is not handled as the additional-adhered panel element in the subsequent operation of adhering.

[2-2] Second Type of Method of Manufacturing Multi-layer Display Panel

[2-2-1] The second type of manufacturing method can be employed for manufacturing the multi-layer display panel of any one of the structures already described in the item [1].

The second type of manufacturing method can provide the multi-layer display panel, in which the electrode formation surface of at least one connection portion is hidden by the other panel element (by the substrate of the other panel element).

In the case where the multi-layer display panel, in which the electrode formation surface of each connection portion is at least partially exposed even after the adhering all the panel elements, is manufactured, the driver element connecting step can be easily and efficiently performed according to the manufacturing method of the second type, compared with the case where the driver element connecting steps with respect to all the connection portions are performed after adhering all the panel elements.

The second type of manufacturing method includes a panel element forming step, an adhering step, and a driver element connecting step.

The contents already described in the items [2-1-1] and [2-1-2] relating to the panel element forming step, adhering step and driver element connecting step in the first type of manufacturing method can be true also with respect to the second type of manufacturing method except for the followings.

[2-2-2] In the second type of manufacturing method, the driver element connecting step with respect to the respective connection portions is performed in accordance with the following timing.

Even either the first or second type of manufacturing method is employed to manufacture the multi-layer display panel, the timing of the driver element connecting step with respect to the respective connection portions is same in some cases, or different in some cases, which depends on the final structure of the multi-layer display panel.

In the second type of manufacturing method, the driver element connecting step with respect to the connection portion of only one of the first and second substrates of the additional-adhered panel element is performed before adhering the base and additional-adhered panel elements, and the driver element connecting step with respect to the connection portion of the other substrate of the additional-adhered panel element is performed after adhering the base and additional-adhered panel elements.

In the second type of manufacturing method, it is likewise preferable, as already described in connection with the first type of manufacturing method, that the additional-adhered panel element in the adhering step is composed of only one panel element for functioning the manner for suppressing remaining of bubbles between the panel elements and the wrinkling of the panel element.

In the case where the additional-adhered panel element is composed of the single panel element, by performing the driver element connecting step with respect to the one of the connection portions of the additional-adhered panel element before adhering the additional-adhered panel element to the base panel element, this driver element connection can be performed under the condition that the additional-adhered panel element is not overlapping to the other panel element. This allows easy and efficient connection of the driver element to the connection portion. Further, Since the driver element connecting step is performed with respect to only one of the connection portions of the additional-adhered panel element in advance before adhering the additional-adhered panel element to the base panel element, the foregoing manner for suppressing remaining of bubbles can function to achieve the intended effects.

Between the two connection portions of the first and second substrates of the additional-adhered panel element, the connection portion of the substrate, to be located remoter from the base panel element, has a possibility that its electrode formation surface is to be hidden by the base panel element after adhering the base and additional-adhered panel elements. This is because each substrate is provided with the electrode on the surface opposed to the other substrate of the same panel element. Accordingly, the connection portion of the substrate of the panel element, with respect to which the driver element connecting step is performed before adhering the base and additional-adhered panel elements together, may be the connection portion of the substrate, to be located remoter from the base panel element, of the additional-adhered panel element. Naturally, either of the connection portions of the additional-adhered panel element may be selected as the connection portion to be subjected in advance to the driver element connecting step, if the electrode formation surface of each connection portion of the additional-adhered panel element is exposed even after adhering all the panel elements.

Likewise, the connection portion of the substrate, to be located remoter from the additional-adhered panel element, of the base panel element is the connection portion having a possibility that its electrode formation surface is to be hidden by the additional-adhered panel element after adhering the base and additional-adhered panel elements. Accordingly, the driver element connecting step may be performed with respect to the connection portion of the substrate, to be located remoter from the additional-adhered panel element, of the base panel element in advance before adhering the base and additional-adhered panel elements.

[2-2-3] More specifically, the driver element connecting step with respect to the respective connection portions may be performed in the following manner in the case where the first to Nth (N: natural number larger than one) panel elements of N in number are adhered together in this order. In the following description, first to Nth panel elements are adhered together such that the first panel element is firstly handled as the base panel element, and the second, third, . . . , Nth panel elements are adhered one by one as the additional-adhered panel element.

(1) Before adhering the first and second panel elements together in the condition that the first panel element is handled as the base panel element, and the second panel element is handled as the additional-adhered panel element, the driver element connecting step is performed with respect to the following connection portion.

The driver element connecting step with respect to one of the connection portions of the second panel element (additional-adhered panel element) is performed before adhering the base and additional-adhered panel elements. For example, the driver element connecting step may be performed with respect to the connection portion of the substrate, to be located remoter from the first panel element (base panel element), of the second panel element (additional-adhered panel element), i.e., with respect to the connection portion of the substrate of the second panel element (additional-adhered panel element) having the electrode formation surface which may be hidden.

The driver element connecting step is to be performed after adhering the first and second panel elements with respect to the other connection portion (e.g., the connection portion of the substrate to be located nearer to the first panel element) of the second panel element (additional-adhered panel element).

In the case where the electrode formation surface of the connection portion of the substrate of the first panel element (base panel element) is hidden by the second panel element (additional-adhered panel element) after adhering the base and additional-adhered panel elements, the driver element connecting step may be performed with respect to the connection portion, of which electrode formation surface is to be hidden by the second panel element, of the substrate of the first panel element. Even in the case where the electrode formation surface of the connection portion of the substrate of the first panel element (base panel element) is not hidden by the second panel element (additional-adhered panel element) after adhering the base and additional-adhered panel elements, the driver element connecting step may be performed with respect to the connection portion of the substrate, to be located remoter from the second panel element, of the first substrate.

(2) After adhering the first and second panel elements, and before adhering the third panel element to the first and second panel elements already adhered in the condition that the third panel element is handled as the additional-adhered panel element, the driver element connecting step is performed with respect to the following connection portion.

The driver element connecting step with respect to one of the connection portions of the third panel element (additional-adhered panel element) is performed before adhering the base and additional-adhered panel elements. For example, the driver element connecting step may be performed with respect to the connection portion of the substrate, to be located remoter from the first and second panel elements (base panel element), of the third panel element (additional-adhered panel element), i.e., with respect to the connection portion of the substrate of the third panel element (additional-adhered panel element) having the electrode formation surface which may be hidden.

The driver element connecting step is to be performed after adhering the third panel element to the first and second panel elements with respect to the other connection portion (e.g., the connection portion of the substrate to be located nearer to the first and second panel elements) of the third panel element (additional-adhered panel element).

In the case where the electrode formation surface of the connection portion of the substrate of the first or second panel element (base panel element) is hidden by the third panel element (additional-adhered panel element) after adhering the base and additional-adhered panel elements, the driver element connecting step may be performed with respect to the connection portion, of which electrode formation surface is hidden by the third panel element, of the substrate of the first or second panel element.

The connection portion of the substrate, to be located remoter from the third panel element, of the second panel element (i.e., the connection portion of the substrate, located nearer to the first panel element, of the second panel element) has a possibility that its electrode formation surface is hidden by the third panel element. The connection portion of the substrate, located nearer to the first panel element, of the second panel element (i.e., the connection portion of the substrate, to be located remoter from the third panel element, of the second panel element) has no possibility that its electrode formation surface is hidden by the first panel element in the operation of adhering (this adhering is already performed in this stage) the first and second panel elements.

Even in the case where the electrode formation surface of the connection portion of the substrate of the first or second panel element (base panel element) is not hidden by the third panel element (additional-adhered panel element) after adhering the base and additional-adhered panel elements, the driver element connecting step may be performed with respect to the connection portion of the substrate, to be located remoter from the third panel element, of the first or second substrate.

(3) In the subsequent steps of adhering the fourth to Nth panel elements, the driver element connecting step may be performed in a similar manner as described above.

[2-2-4] By performing the driver element connecting step in accordance with the timings as described above, the driver element connecting step can be easily performed with respect to any one of the connection portions even in the case of manufacturing the multi-layer display panel, in which at least one electrode formation surface of the connection portion is hidden by the other panel element after adhering the all panel elements.

According to the second type of the manufacturing method, even when manufacturing the multi-layer display panel, in which all the electrode formation surfaces of connection portions is exposed at least partially after adhering the all panel elements, the driver element connecting steps with respect to the respective connection portions can be performed efficiently since the driver element connecting step with respect to one of the connection portions of the additional-adhered panel element is performed in advance before adhering the additional-adhered panel element to the base panel element.

The driver element connecting step with respect to the connection portion of each of the first and second substrates of the panel element firstly handled as the base panel element may be performed before adhering the panel element firstly handled as the base panel element and the additional-adhered panel element. Thereby, the driver element connecting step can be easily and efficiently performed with respect to the connection portions of the first and second substrates of the panel element firstly handled as the base panel element. Even by doing this, the foregoing manner for suppressing the remaining of bubbles functions to obtain the intended effects, if the panel element firstly handled as the base panel element is not handled as the additional-adhered panel element in the subsequent operation of adhering.

[2-2-5] Junction Substrate Connecting Step

In the second type of manufacturing method, similarly to the first type of manufacturing method, the junction substrate may be further connected to the connection portion of the panel element substrate for connecting the driver element to the control portion of the driver device, in the case where the driver element is directly mounted on the connection portion of the panel element substrate for connecting the electrode on the panel element substrate to the driver element.

This connection of the junction substrate may be performed in accordance with the timing already described in the item [2-1-7].

[2-3] In any of the first and second types of manufacturing methods, if the panel element is formed in the panel element forming step such that the liquid crystal is arranged between the column substrate provided with the column electrode and the row substrate provided with the row electrode, the liquid crystal panel element can be formed.

The chiral nematic liquid crystal may be arranged between the substrates as described above, whereby the liquid crystal panel element of the reflection type can be formed.

[2-4] In any of the first and second types of manufacturing method, the adhering of the panel elements in the adhering step may be performed after positioning the panel elements to have a predetermined positional relationship therebetween.

For this positioning, the column substrate and/or row substrate of each panel element may be provided with one or more alignment mark(s) (registration mark(s)). For the positioning, a known manner such as an image processing manner may be employed. The alignment mark may be made of an electrode material. The alignment mark may be formed outside the display region of the substrate. Display may be performed at one or more predetermined dots (pixels) of the panel element for use as the alignment mark(s).

[2-5] Driver Element Connecting Step

In any of the first and second types of manufacturing method, the driver element connecting step may be performed, e.g., as follows.

[2-5-1] Driver Element Mounting Step

In the case where the driver element (e.g., driver IC) is to be directly mounted on the connection portion of the panel element substrate, this mounting of the driver element may be performed as described below.

(a) The mounting of the driver element may be performed using, e.g., an anisotropic conductive adhesive such as anisotropic conductive film (ACF) or anisotropic paste. This anisotropic conductive adhesive is disposed between the driver element and the substrate connection portion, and is subjected to the heat and pressure so that the driver element can be mounted.

(b) In the case where the connection portions of the first substrates of the panel elements have the foregoing overlapping structure, or other case, the driver elements may be mounted on the connection portions of the first substrates at the positions overlapping to each other.

Likewise, in the case where the connection portions of the second substrates of the panel elements have the overlapping structure, or other case, the driver elements may be mounted on the connection portions of the second substrates at the positions overlapping to each other.

In the case of mounting the driver elements at the overlapping positions as described above, the driver element may be mounted by applying heat and/or pressure via the driver element already mounted. The driver element mounting may be performed while using the driver element already mounted as a base member (a portion of the base member) when applying the pressure to the driver element to be currently mounted.

When mounting the driver element at the position, on the substrate of the panel element, overlapping with the driver element already mounted on the connection portion of the other substrate of the other panel element, a heat insulator may be arranged between the connection portion of the panel element substrate onto which the driver element is to be currently mounted and the driver element already mounted on the connection portion of the other panel element substrate.

By mounting the driver element with the heat insulator thus interposed, the conduction of the heat to the anisotropic conductive adhesive used for the driver element already mounted, even if the heat is applied to the anisotropic conductive adhesive used for currently mounting the driver element via the driver element already mounted and the anisotropic conductive adhesive used for the driver element already mounted. In the case where the anisotropic conductive adhesive, used for the driver element mounting, contains thermoplastic resin as a binder resin, if the anisotropic conductive adhesive of the driver element already mounted were heated to a temperature higher than the softening point of the binder resin, the binder resin might flow out so that the position of the driver element already mounted would change and/or the adhesion of the driver element to the connection portion would lower in some cases. These disadvantages can be suppressed by arranging the heat insulator as described above.

The specific heat of the insulator may be smaller than that of the substrate of the panel element. This effectively suppress the transfer of the heat to the anisotropic conductive adhesive, which is used for the driver element already mounted. In the case where the anisotropic conductive adhesive is used for mounting the driver element, such a heat insulator may be employed that the heat insulator can keep the temperature of the binder resin (adhesion layer) of the anisotropic conductive adhesive, which is used for the driver element already mounted, lower than or equal to about 120° C. when applying the heat of about 140° C. for about 20 seconds to the anisotropic conductive adhesive, which is used for currently mounting the driver element. Even in the case of using the anisotropic conductive adhesive including the thermoplastic resin as the binder resin, the foregoing problem can be suppressed because the softening point of the thermoplastic resin used in the anisotropic conductive adhesive is usually higher than about 120° C.

(c) In the case where the connection portions of the first substrates of the respective panel elements have the foregoing overlapping structure, or other case, the driver elements may be mounted at positions, which do not overlap with each other, on the connection portions of the respective first substrates of the panel elements. For example, these driver elements may be mounted in staggered positions, respectively.

Likewise, in the case where the connection portions of the second substrates of the panel elements have the foregoing overlapping structure, or other case, the driver elements may be mounted at the positions, which do not overlap with each other, on the connection portions of the respective second substrates of the panel elements.

(d) In either the case where the driver elements are mounted at the overlapping positions or at the positions not overlapping with each other, the electrode pattern may be formed in each connection portion such that the driver elements can be mounted at such positions.

[2-5-2] Junction Substrate Connecting Step

In the case where the driver element (e.g., driver IC) is to be directly mounted on the connection portion of the panel element substrate, the junction substrate may be further connected to the same connection portion for connecting the driver element on the connection portion to the control portion of the driver device as already described. The connection of the junction substrate may be performed as follows.

(a) The connection of the junction substrate may be performed using the anisotropic conductive adhesive such as anisotropic conductive film (ACF) or anisotropic paste.

(b) The junction substrate may be a flexible substrate.

The flexible junction substrate may be folded toward the back side of the observation side of the multi-layer display panel. This folding can reduce the frame width of the multi-layer display panel.

[2-5-3] Driver Element Carrier Substrate Connecting Step

In the case where the driver element carrier substrate carrying the driver element (e.g., driver IC) such as TCP is to be connected to the connection portion of the panel element substrate, this connection may be performed as follows.

(a) The connection of the driver element carrier substrate may be performed using the anisotropic conductive adhesive such as anisotropic conductive film (ACF) or anisotropic paste.

(b) The driver element carrier substrate may be a flexible substrate.

The flexible driver element carrier substrate may be folded toward the back side of the observation side of the multi-layer display panel. This folding can reduce the frame width of the multi-layer display panel.

[2-6] Positioning in Driver Element Connecting Step

In any one of the first and second manufacturing methods, the driver element connecting step may be performed as follows.

(a) In the driver element mounting step, one or more alignment mark(s) (registration mark(s) or target mark(s)) provided on the connection portion of the panel element substrate as well as one or more alignment mark(s) provided on the driver element may be utilized for positioning so that the driver element may be mounted at the predetermined position of the connection portion by aligning these alignment marks. The alignment mark used for mounting the driver element may be formed, e.g., within the driver element mounting region of the connection portion of the panel element substrate.

(b) Likewise, in the step of connecting the junction substrate, ore or more alignment mark(s) provided on the connection portion of the panel element substrate and one or more alignment mark(s) provided on the junction substrate may be utilized for positioning so that the junction substrate may be connected at the predetermined position by aligning these alignment marks.

(c) Likewise, in the step of connecting the driver element carrier substrate, one or more alignment mark(s) provided on the connection portion of the panel element substrate and one or more alignment mark(s) provided on the driver element carrier substrate may be utilized for positioning so that the driver element carrier substrate may be connected at the predetermined position of the connection portion of the panel element substrate by aligning these alignment marks.

(d) For each of these positionings, known image processing manner may be employed. The alignment mark may be read by a reading device such as a CCD camera or a microscope.

The alignment mark(s) provided on the connection portion of the panel element substrate may be made of an electrode material (e.g., ITO).

In the case where the driver elements are to be mounted at the overlapping positions on the connection portions of the respective first or second substrates as already described, the driver element (e.g., drive IC) already mounted on the connection portion may impede the reading of the alignment mark(s) formed on the connection portion onto which the driver element is to be currently mounted. For example, in the case where the driver element is a drive IC called a “bare chip”, and a back side surface, which is the back surface of the mounting surface, of the driver IC has a metal shine, the metal-shiny back side surface may impede the reading of the alignment mark(s) formed on the connection portion onto which the driver element is to be currently mounted.

For preventing the above, a predetermined coating or painting may be applied onto at least a driver element mounting corresponding portion of a back surface of the connection portion of the panel element substrate. The back surface, onto which the predetermined coating is applied, is a back surface of a driver element mounting surface, onto which the driver element is to be mounted, of the connection portion of the panel element substrate. The driver element mounting corresponding portion of the back surface of the connection portion is corresponding to the driver element mounting portion, onto which the driver element is to be mounted, of the connection portion of the panel element substrate. The coating may be applied in a whitish color. Since the alignment mark(s) formed on the driver element mounting portion of the connection portion of the panel element substrate is usually read from the same side as the driver element mounting surface of the connection portion of the panel element substrate, the coating formed on the back side of the driver element mounting portion allows reading of the alignment mark(s) even if the driver element having a metal shine is present on the rear side of the driver element mounting portion. Thereby, the driver element can be mounted precisely.

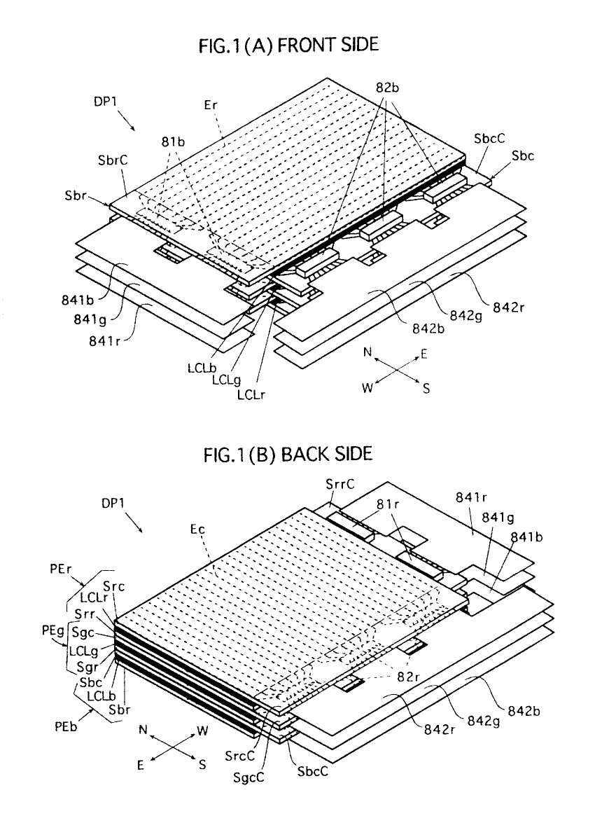

A predetermined coating or painting may be applied onto at least a portion of a surface of the driver element mounted on or to be mounted onto the connection portion of the panel element substrate. The surface, onto which the predetermined coating is applied, of the driver element is a back surface of a surface, opposed to or to be opposed to the connection portion of the panel element substrate, of the driver element. The coating may be applied in a whitish color. This coating can hide the metal-shine of the driver element already mounted so that the alignment mark(s) formed on the connection portion, onto which the driver element is to be currently mounted, can be read even if the driver element already mounted on the other connection portion is viewed through the connection portion onto which the driver element is to be currently mounted. This allows precise mounting of the driver element.

[3] Embodiments of the invention will now be described with reference to the drawings.

[3-1] FIGS. 1(A) and 1(B) are schematic perspective views of an example of the multi-layer display panel, i.e., a multi-layer liquid crystal display panel (multi-layer LCD panel) DP1. FIG. 1(A) shows the display panel DP1 viewed from the observation side (front side), and FIG. 1(B) shows the display panel DPI viewed from the back side, which is opposite side of the observation side. FIGS. 1(A) and 1(B) show the multi-layer LCD panel DP1 in a state, in which driver ICs and junction substrates are connected to each substrate of the display panel. The purpose of provision of the driver ICs and the junction substrates will be described later.

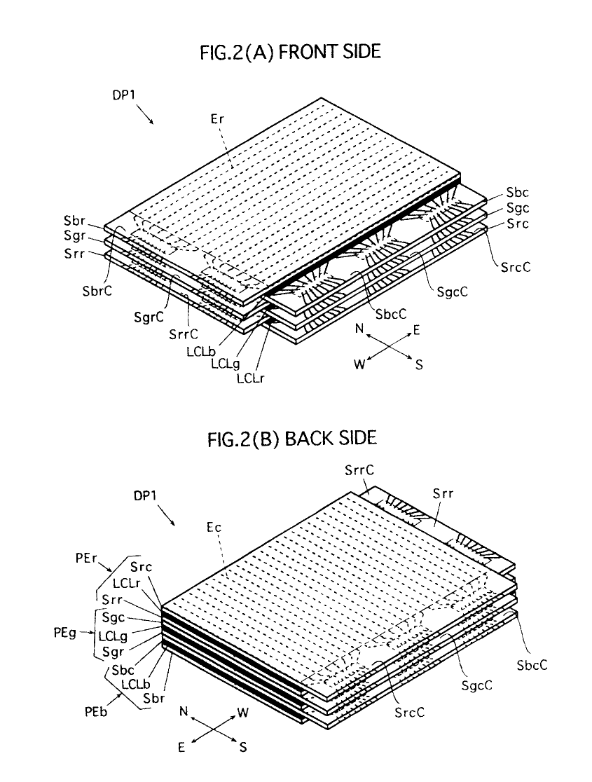

For easy understanding, the multi-layer LCD panel DPI, in which the driver ICs and the junction substrates are removed, is shown in FIGS. 2(A) and 2(B), which are schematic perspective views.

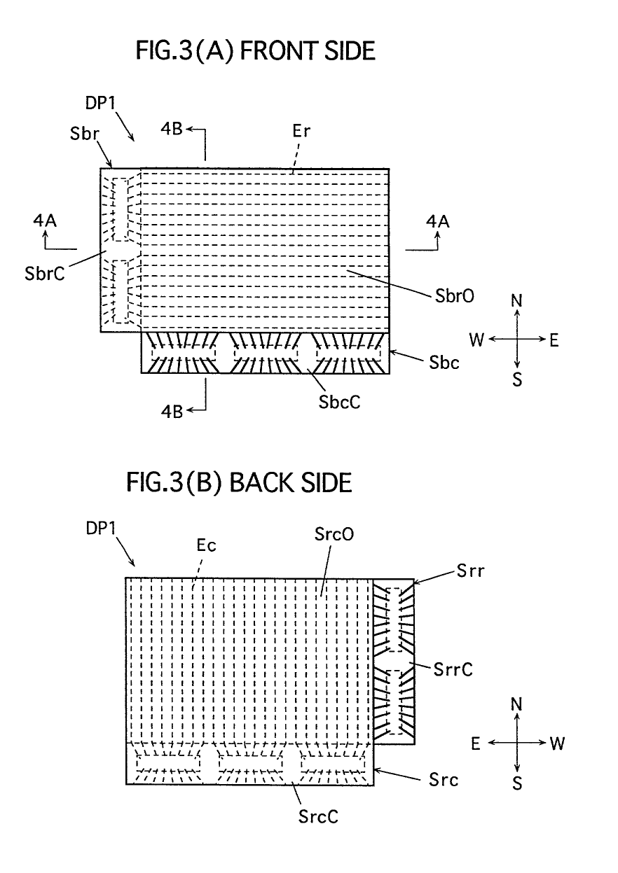

FIGS. 3(A) and 3(B) are plans showing the multi-layer LCD panel DP1 from the front and back sides, respectively. In FIGS. 3(A) and 3(B) the driver ICs and the junction substrates are not illustrated.

In FIG. 3(A), the upper, lower, left and right sides of the multi-layer LCD panel DP1 and the parts (e.g., the panel element) thereof may be referred to as north (N), south (S), west (W) and east (E) sides, respectively.

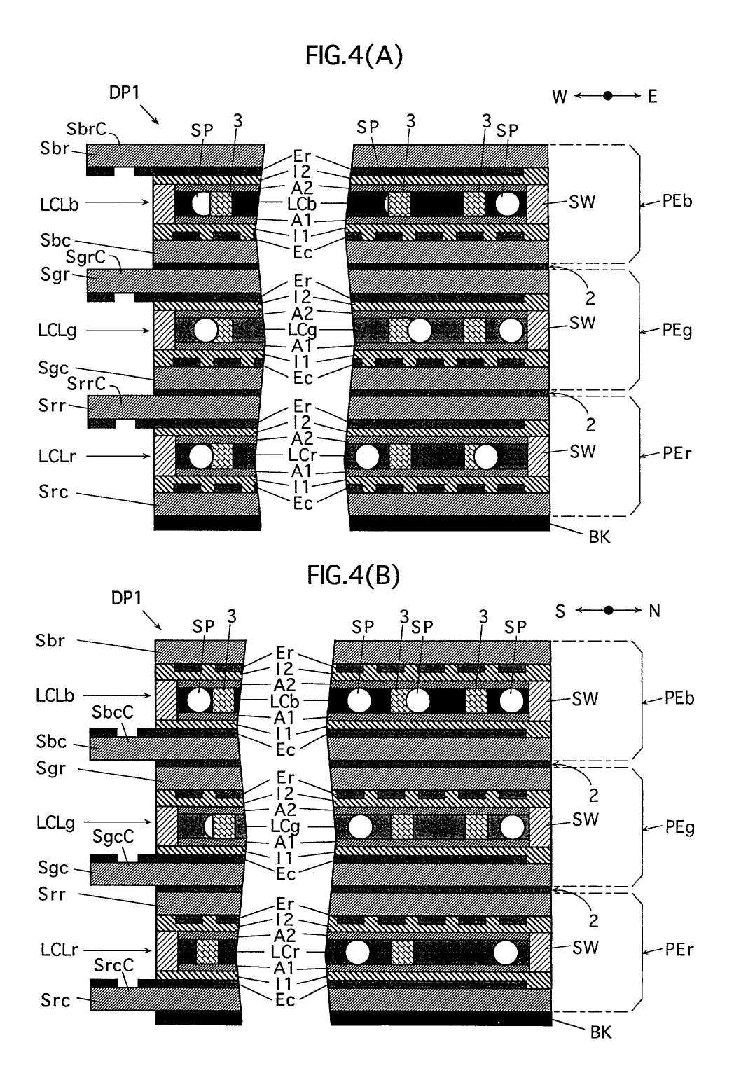

FIGS. 4(A) and 4(B) are schematic cross sections of the multi-layer LCD panel DP1 taken along line 4A-4A and 4B-4B shown in FIG. 3(A), respectively. In FIGS. 4(A) and 4(B), the driver ICs and the junction substrates are not illustrated.

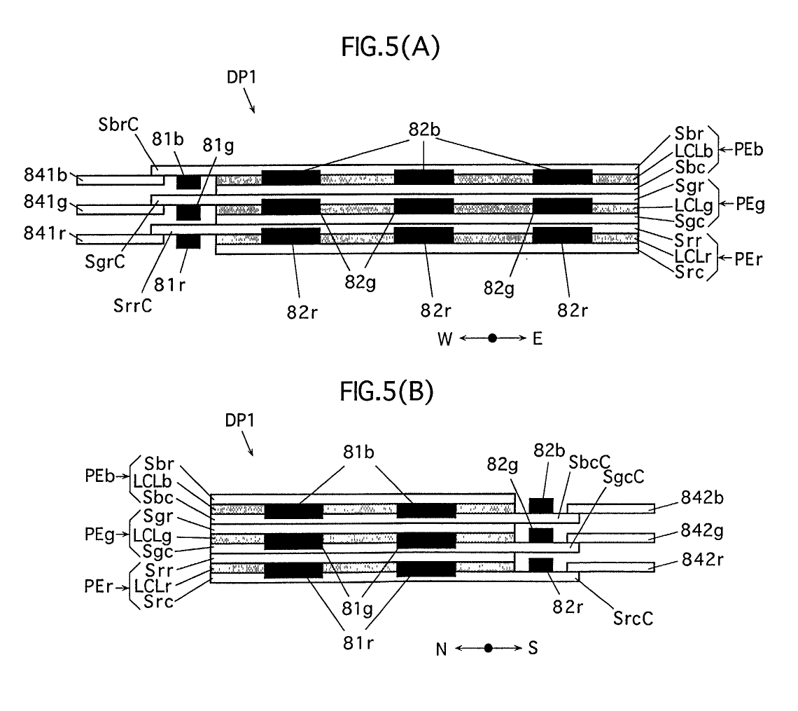

FIGS. 5(A) and 5(B) are schematic side views of the multi-layer LCD panel DP1. FIGS. 5(A) and 5(B) show the south side and the west side of the multi-layer LCD panel DP1, respectively. In FIGS. 5(A) and 5(B), some of the junction substrates are not illustrated.

[3-2] The multi-layer LCD panel DP1 is a color LCD panel of a reflection type.

The multi-layer LCD panel DP1 has three panel elements PEb, PEg and PEr layered together in this order as shown in FIG. 4(A) and others.

Each of the panel elements PEb, PEg and PEr is of the reflection type. The panel elements PEb, PEg and PEr are employed for display in blue, green and red, respectively. As will be described later in greater detail, the panel elements PEb, PEg and PEr contain liquid crystals having selective reflection wavelengths in blue, green and red ranges, respectively.

The display by the multi-layer LCD panel DP1 is viewed from the side of the panel element PEb (i.e., upper side in FIG. 4(A)). The panel element PEb is located nearest to the observation side, and the panel element PEr is located remotest from the observation side.

In the following description, the side viewed from the observation side may be referred to as front side, and the side remote from the observation side may be referred to as back side.

A black light absorber layer BK is formed on the back side of the panel element PEr located remotest from the observation side. In the figures other than FIGS. 4(A) and 4(B), the light absorber layer BK is not illustrated.

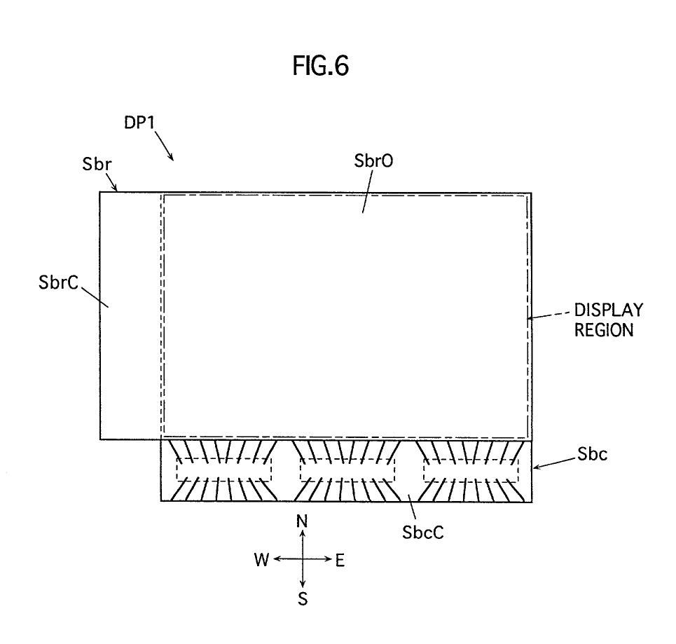

The multi-layer LCD panel DP1 has a lap-over portion where the panel elements PEb, PEg and PEr are overlapping with each other. In the multi-layer LCD panel DP1, a central portion of the lap-over portion is utilized as a display region, as shown in FIG. 6. The display region is rectangular.

The neighboring panel elements are adhered together by an adhesive 2 as shown in FIGS. 4(A) and 4(B). In the figures other than FIGS. 4(A) and 4(B), the adhesive 2 is not illustrated. In this example, adhesive film is employed as the adhesive 2. Instead of the adhesive film, double-faced adhesive tape or liquid adhesive may be used as the adhesive. The double-faced tape may include, e.g., acrylic adhesive. The liquid adhesive may be ultraviolet-curing resin or thermosetting silicone-containing adhesive. The liquid adhesive may be solidified by appropriate processing (e.g., irradiation with ultraviolet light or heating) depending on the kind of the adhesive after overlaying the panel elements. By employing the adhesive film, the whole transparency of the display panel DP1 can be increased since the adhesive film does not have a base film, compared with the case of employing the double-faced adhesive tape, which has the base film.

Each of the panel elements has a pair of substrates, between which a layer of the liquid crystal is held. In each panel element, each of the substrate is provided with an electrode for performing simple matrix driving of the panel element.

[3-3] Basic structures of the blue panel element PEb will now be described with reference to FIGS. 4(A) and 4(B).

The panel element PEb has a pair of substrates Sbr and Sbc spaced by a predetermined distance from each other.

The substrates Sbr and Sbc in this example are formed of polycarbonate (PC) film. The substrates Sbr and Sbc have different sizes, but both are rectangular.

A column electrode Ec, an insulating film I1 and an orientation film A1 are successively formed on the substrate Sbc. The substrate Sbc provided with the column electrode Ec may be referred to as column substrate hereinafter.

A row electrode Er, an insulating film I2 and an orientation film A2 are successively formed on the substrate Sbr. The substrate Sbr provided with the row electrode Er may be referred to as row substrate in the following description.

The column electrode Ec and row electrode Er in this example are both made of ITO.

The column electrode Ec includes a plurality of parallel belt-like electrodes arranged with predetermined pitches in the display region. Likewise, the row electrode Er includes a plurality of parallel belt-like electrodes arranged with predetermined pitches in the display region. The column and row electrodes Ec and Er extend perpendicularly to each other in the display region.

For easy understanding, the illustrated belt-like electrodes composing the row electrode Er as well as the illustrated belt-like electrodes composing the column electrode Ec are smaller in number than those which are actually employed.

The column electrode Ec and others are formed on a surface, opposed to the row substrate Sbr, of the substrate Sbc. Likewise, the row electrode Er and others are formed on a surface, opposed to the column substrate Sbc, of the substrate Sbr. The surface, on which the electrode is formed, of the substrate may be referred as electrode formation surface hereinafter.

A liquid crystal layer LCLb is held between the substrate Sbc provided with the column electrode Ec and the substrate Sbr provided with the row electrode Er.

The liquid crystal layer LCLb contains the liquid crystal LCb having the selective reflection wavelength in the blue range. The liquid crystal LCb in this example is a chiral nematic liquid crystal exhibiting a cholesteric phase in a room temperature. The liquid crystal layer LCLb includes, in addition to the liquid crystal LCb, spacers SP and columnar resin structures 3.

The spacer SP is arranged between the substrates Sbc and Sbr for controlling a thickness of the liquid crystal layer LCLb (thickness of liquid crystal LCb).

The columnar resin structure 3 is adhered to both the orientation films A1 and A2 on the substrates Sbc and Sbr. Thereby, the substrates Sbc and Sbr are adhered together. The columnar resin structure 3 increases the whole strength of the panel element PEb.

A seal wall SW made of resin is arranged at a peripheral portion of the liquid crystal layer LCLb between the substrates Sbc and Sbr for preventing leakage of the liquid crystal held between the substrates Sbc and Sbr.

[3-4] The basic structure of the blue panel element PEb has been described. The green and red panel elements PEg and PEr have the basic structures similar to that of the blue panel element PEb. The basic structures of the green and red panel elements PEg and PEr will be briefly described below.

The green panel element PEg has a column substrate Sgc provided with a column electrode Ec and a row substrate Sgr provided with a row electrode Er. In addition to the column electrode, the column substrate Sgc is also provided with an insulating film I1 and an orientation film A1. In addition to the row electrode, the row substrate Sgr is further provided with an insulating film I2 and an orientation film A2. In the green panel element PEg, a liquid crystal layer LCLg is arranged between the substrates Sgc and Sgr. The liquid crystal layer LCLg includes a liquid crystal LCg having the selective reflection wavelength in the green range.

The red panel element PEr has a column substrate Src provided with a column electrode Ec and a row substrate Srr provided with a row electrode Er. In addition to the column electrode, the column substrate Src is also provided with an insulating film I1 and an orientation film A1. In addition to the row electrode, the row substrate Srr is further provided with an insulating film I2 and an orientation film A2. In the red panel element PEr, a liquid crystal layer LCLr is arranged between the substrates Src and Srr. The liquid crystal layer LCLr includes a liquid crystal LCr having the selective reflection wavelength in the red range.

[3-5] As described above, each panel element is provided with the column and row electrodes for performing the simple matrix drive.

When performing the simple matrix drive of each panel element, the column electrode of each panel element is used as a scanning electrode in this example, and the row electrode of each panel element is used as a signal electrode (data electrode).

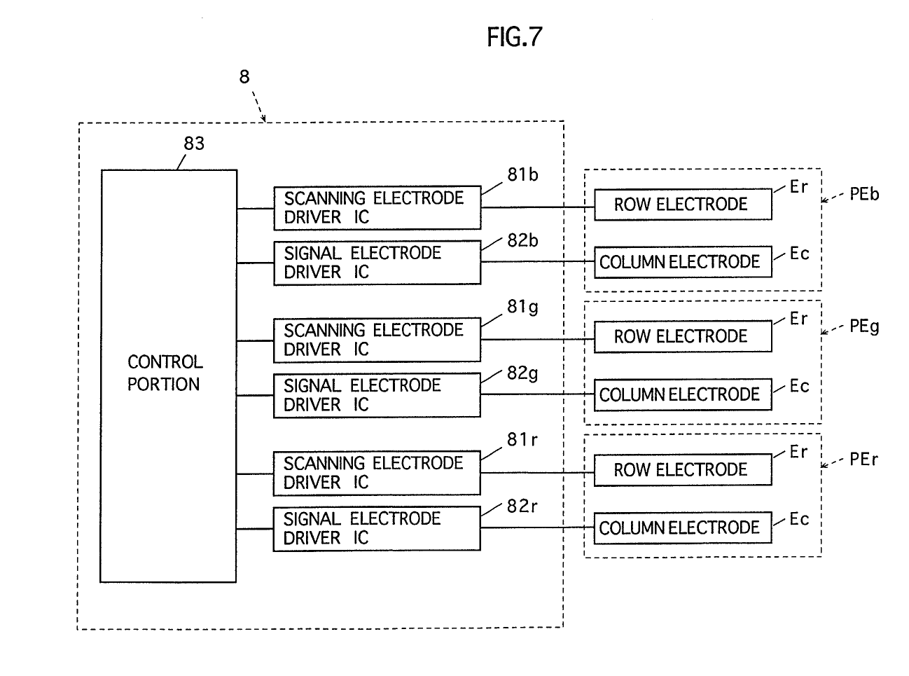

FIG. 7 is a schematic block diagram showing an example of a driver device for performing the full color display by performing the simple matrix driving of the respective panel elements of the multi-layer LCD panel DP1.

The driver device 8 shown in FIG. 7 has scanning electrode driver ICs 81b, 81g and 81r for driving the row electrodes (scanning electrodes) Er of the panel elements PEb, PEg and PEr. The driver device 8 further has signal electrode driver ICs 82b, 82g and 82r for driving the column electrodes (signal electrodes) Ec of the panel elements PEb, PEg and PEr.

These driver ICs are controlled by a control portion (control unit) 83. The control portion 83 applies a voltage across the column and row electrodes of each panel element via the driver ICs for driving each panel element to perform image display. The manner of driving each panel element by the driver device 8 will be described later in greater detail.

[3-6] In the multi-layer LCD panel DP1, each of the scanning electrode driver ICs and the signal electrode driver ICs is directly mounted on the corresponding substrate of the panel element, as shown in FIGS. 5(A), 5(B) and others. That is, a so-called COF (Chip On Film) structure is employed in the multi-layer LCD panel DP1.

FIGS. 2(A) and 2(B) show the display panel DP1 not carrying the driver ICs, and the positions for mounting the driver ICs are indicated by dotted line.

By directly mounting the driver IC on the substrate of the panel element, the electrode formed on the substrate is connected to the driver IC mounted on the same substrate.

The respective driver ICs mounted on the substrates of the panel elements are connected to the control portion 83 via respective junction substrates connected to the respective substrates.

In the blue panel element PEb, junction substrates 841b and 842b are connected to the substrates Sbr carrying the driver IC 81b and the substrate Sbc carrying the driver IC 82b, respectively.

In the green panel element PEg, junction substrates 841g and 842g are connected to the substrate Sgr carrying the driver IC 81g and the substrate Sgc carrying the driver IC 82g, respectively.

In the red panel element PEr, junction substrates 841r and 842r are connected to the substrate Srr carrying the driver IC 81r and the substrate Src carrying the driver IC 82r, respectively.

[3-7] In the multi-layer LCD panel DP1, the respective substrates of the panel elements overlap with each other in the following fashion for mounting the driver ICs directly on each substrate and other purposes. The three panel elements PEb, PEg and PEr overlap as follows.

In each panel element, the rectangular column substrate and the rectangular row substrate overlap with each other to form an L-shaped form with the liquid crystal layer therebetween.

The liquid crystal layer is located between the portion of the column substrate overlapping with the row substrate and the portion of the row substrate overlapping with the column substrate.

The three panel elements PEb, PEg and PEr overlap with each other such that the overlapping portions of the column and row substrates in each panel element overlap with the other overlapping portions of the other panel elements. In this example, all the overlapping portions of the column and row substrates in the respective panel elements have the same sizes, and the three panel elements overlap not to cause shifting between these portions.

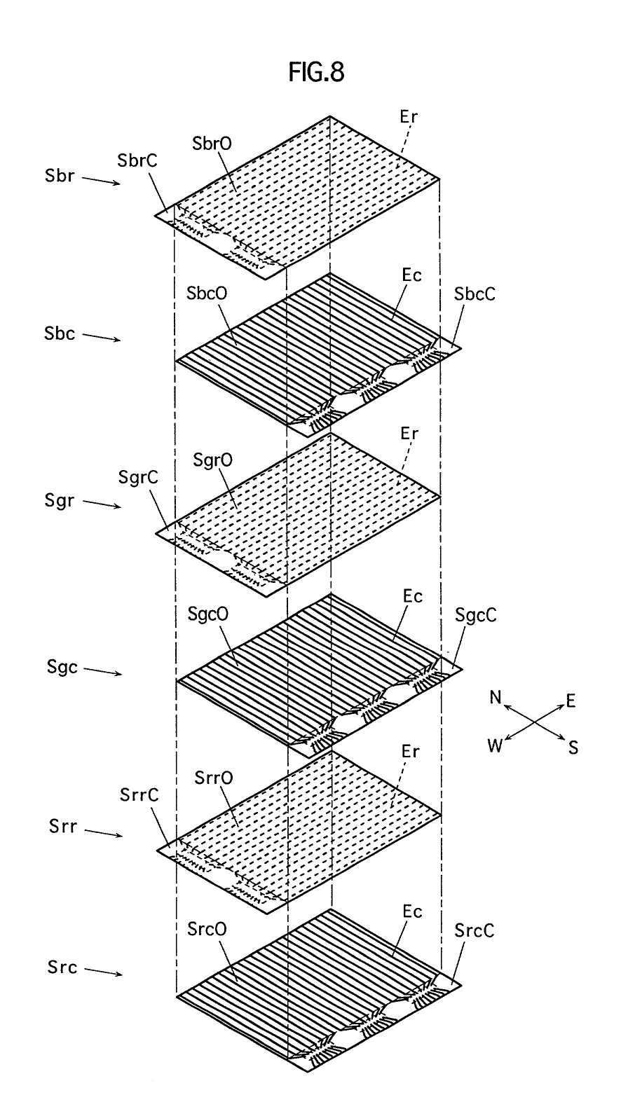

Owing to the above structures, each substrate of each panel element has the following portions. Description will now be given with reference to FIG. 8 showing an exploded view of the multi-layer LCD panel DP1. FIG. 8 shows only the substrates of each panel element, and does not show the liquid crystal layers and others.

The row substrate Sbr of the blue panel element PEb has an overlap portion SbrO overlapping with all the other five substrates Sbc, Sgr, Sgc, Srr and Src, and a connection portion SbrC extending from the overlap portion SbrO and used for connecting the row electrode Er on the substrate Sbr to the driver IC.

Likewise, the column substrate Sbc of the blue panel element PEb has an overlap portion SbcO overlapping with all the other five substrates, and a connection portion SbcC extending from the overlap portion SbcO and used for connecting the column electrode Ec on the substrate Sbc to the driver IC.

The row substrate Sgr of the green panel element PEg has an overlap portion SgrO overlapping with all the other five substrates, and a connection portion SgrC extending from the overlap portion SgrO and used for connecting the row electrode Er on the substrate Sgr to the driver IC.

The column substrate Sgc of the green panel element PEg has an overlap portion SgcO overlapping with all the other five substrates, and a connection portion SgcC extending from the overlap portion SgcO and used for connecting the column electrode Ec on the substrate Sgc to the driver IC.

The row substrate Srr of the red panel element PEr has an overlap portion SrrO overlapping with all the other five substrates, and a connection portion SrrC extending from the overlap portion SrrO and used for connecting the row electrode Er on the substrate Srr to the driver IC.

The column substrate Src of the red panel element PEr has an overlap portion SrcO overlapping with all the other five substrates, and a connection portion SrcC extending from the overlap portion SrcO and used for connecting the column electrode Ec on the substrate Src to the driver IC.

The connection portion SbrC of the row substrate Sbr of the blue panel element PEb extends from the overlap portion SbrO in the same direction as the row electrode Er on the row substrate Sbr extending in the display region. The connection portion SbrC is a substrate portion for mounting the scanning electrode driver IC 81b and for connecting the junction substrate 841b. The connection portion SbrC is provided with an electrode pattern for connecting the row electrode Er to an output lead of the driver IC 81b. More specifically, the connection portion SbrC is provided with an electrode pattern for transforming the pitch of the row electrode Er in the display region to an output lead pitch of the driver IC 81b. The connection portion SbrC is also provided with an electrode pattern for connecting an input lead of the driver IC 81b to the junction substrate 841b. The above is also true with respect to the connection portions of the other substrates.

In the blue panel element PEb, the extending direction of the connection portion SbrC of the row substrate Sbr and the extending direction of the connection portion SbcC of the column substrate Sbc, with respect to a center defined by the overlap portions of the row and column substrates Sbr and Sbc, form an angle of 90 degrees. This is true also with respect to the other panel elements.

The connection portion of each substrate is a substrate projected portion projecting outward from the lap-over portion, where three panel elements (six panel element substrates) are overlapping to each other, when viewing the whole display panel DP1 (see FIG. 2(A) and others).

The substrates of the respective panel elements are layered in the following order. From the observation side, the row substrate Sbr of blue panel element PEb, the column substrate Sbc of blue panel element PEb, the row substrate Sgr of green panel element PEg, the column substrate Sgc of green panel element PEg, the row substrate Srr of red panel element PEr and the column substrate Src of red panel element PEr are layered in this order. That is, one of the neighboring two substrates of the neighboring two panel elements is the column substrate, and the other is the row substrate.

In the multi-layer LCD panel DP1, the connection portions SbrC, SgrC and SrrC of the row substrates of the respective panel elements extend in the same direction and, in this example, toward the west. These connection portions SbrC, SgrC and SrrC have the same width in their extending direction (i.e., west direction in this example). The width of each the connection portions SbrC, SgrC and SrrC is determined to be equal to a minimum value, which is required for mounting the driver ICs and connecting the junction substrate. More specifically, the width of each the connection portions SbrC, SgrC and SrrC is determined to be equal to a minimum value required for mounting the driver ICs and connecting the junction substrate under the condition that the panel element is not overlaid with the other panel element.

The connection portions SbrC, SgrC and SrrC of the row substrates have the same width in their extending direction as described above, and overlap with each other. This structure of the connection portions may be referred to as overlapping structure in the following description.

Likewise, the connection portions SbcC, SgcC and SrcC of the column substrates of the respective panel elements extend in the same direction and, in this example, toward the south. These connection portions SbcC, SgcC and SrcC have the same width in their extending direction (i.e., south direction in this example). The width of each the connection portions SbcC, SgcC and SrcC in their extending direction is determined to be equal to a minimum value, which is required for mounting the driver ICs and connecting the junction substrate. These connection portions SbcC, SgcC and SrcC of the column substrates overlap with each other. Thus, the connection portions of the column substrates have the foregoing overlapping structure similarly to the connection portions of the row substrates.

In this example, the width of the connection portion of each substrate, in a perpendicular direction perpendicular to the extending direction of the connection portion, is equal to the width, in the same perpendicular direction, of the overlap portion from which the connection portion is extended. For example, the connection portion SbrC of the row substrate Sbr has the width, in the perpendicular direction (i.e., north or south direction in this example) perpendicular to the extending direction (i.e., west direction in this example) of the connection portion SbrC, equal to the width in the same perpendicular direction (i.e., north or south direction in this example) of the overlap portion SbrO from which the connection portion SbrC is extended.

In the multi-layer LCD panel DP1, the connection portion of each column substrate has the same extending direction as the others, and the connection portion of each row substrate has the same extending direction as the others. Thus, the connection portions extend only in the two directions from the overlap portions of the respective panel elements. Further, each of the connection portions of the column and row substrates has the width, in its extending direction, equal to the minimum value, which is required for mounting the driver IC and connecting the junction substrate. Thereby, the frame size can be small, compared with case where the connection portions of the column and row substrates extend in three or four directions in total, and/or the case where the connection portions of the column or row substrates have a stepwise structure described later.

In the multi-layer LCD panel DP1, the row substrates Sbr, Sgr and Srr of the respective panel elements have the same form and size, and carry the row electrodes of the same pattern. Likewise, the column substrates Sbc, Sgc and Src of the respective panel elements have the same form and size, and carry the column electrodes of the same pattern. Accordingly, kinds of parts (substrates and others) required for producing the display panel DP1 can be small in number. This improves the manufacturing efficiency.

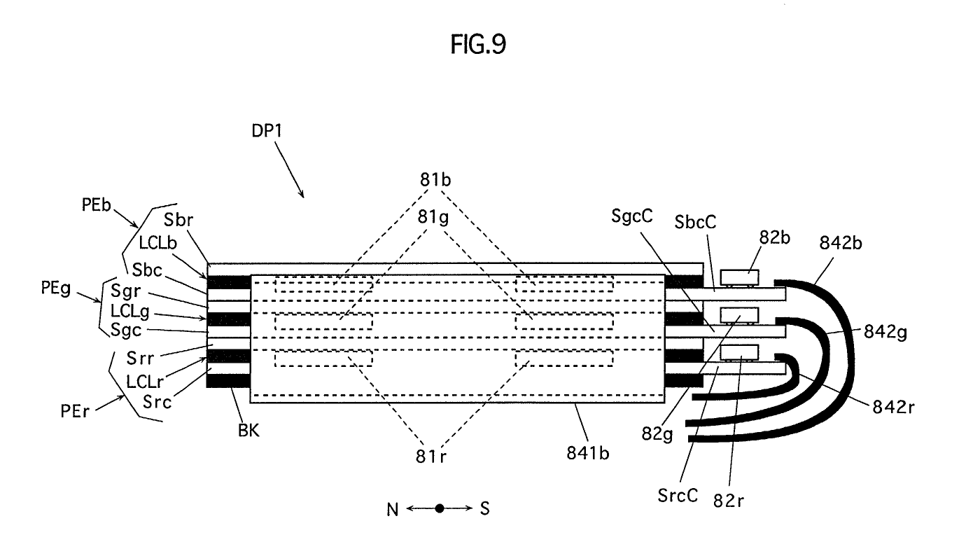

In the multi-layer LCD panel DP1 shown in FIG. 1(A), the connection portions of the column substrates as well as the connection portions of the row substrates have the overlapping structures as described above. Therefore, some of the electrode formation surfaces of the substrate connection portions are hidden by the other panel elements. Accordingly, it is extremely difficult to perform operation such as mounting of the driver IC onto each connection portion after all the panel elements are overlaid and adhered as shown in FIG. 2(A). However, a method of manufacturing the multi-layer LCD panel DP1 is presented later, in which operation such as mounting of the driver element can be performed easily onto every connection portion.

[4] In the multi-layer LCD panel DP1 shown in FIG. 1(A), the junction substrates 841b, 841g, 841r, 842b, 842g and 842r may be folded toward the back side of the LCD panel DP1 as shown in FIG. 9.

By employing, e.g., a flexible substrate as the junction substrate, the junction substrates can be folded. By folding the junction substrates toward the back side, the frame size of the multi-layer LCD panel DP1 can be reduced.

In other types of multi-layer display panels, which will be described later, similar effects can be achieved by folding the junction substrate toward the back side.

[5] In the multi-layer LCD panel DP1 shown in FIG. 1(A), the driver IC is directly mounted on each substrate for connecting the electrode on the substrate to the driver IC. Instead of this, a driver IC carrier substrate carrying the driver IC may be connected to the panel element substrate for connecting the electrode on the panel element substrate to the driver IC.

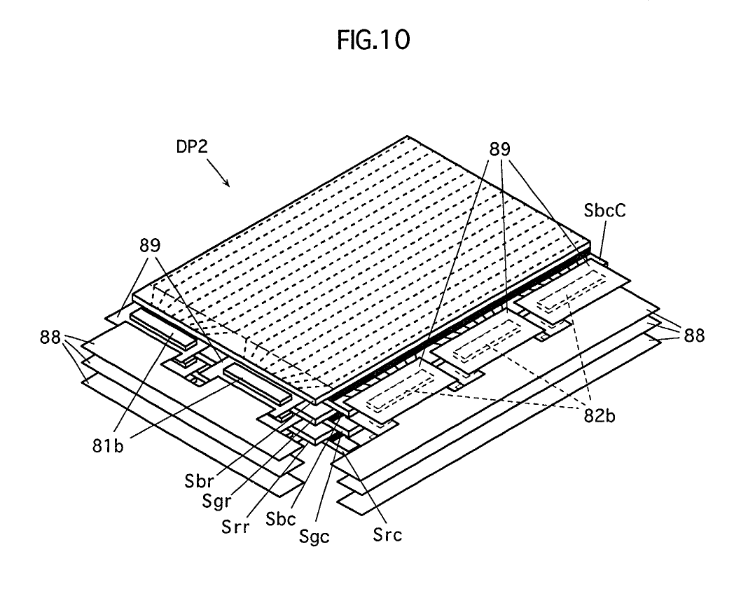

FIG. 10 shows a multi-layer LCD panel having such the structure.

In a multi-layer LCD panel DP2 shown in FIG. 10, a driver IC carrier substrate 89 carrying the driver IC is connected to each substrate of each panel element. Each driver IC carrier substrate 89 is so called a TCP (Tape Carrier Package). The driver IC carrier substrate 89 is a flexible substrate.

A junction substrate 88 is connected to each the driver IC carrier substrate 89. This junction substrate 88 is provided for connecting the driver IC on the driver IC carrier substrate 89 to the control portion 83 of the driver device 8.

Each driver element carrier substrate 89 or each junction substrate 88 may be folded toward the back side, similarly to the junction substrate shown in FIG. 9, whereby the frame size of the multi-layer LCD panel DP2 can likewise be reduced.

In the multi-layer LCD panel DP2, the connection portion of each substrate is merely required to have the width for allowing connection of the driver IC carrier substrate 89. Therefore, the width, in the extending direction, of each connection portion can be reduced, and therefore the frame width can be reduced, as compared with the multi-layer LCD panel DP1 shown in FIG. 1(A).

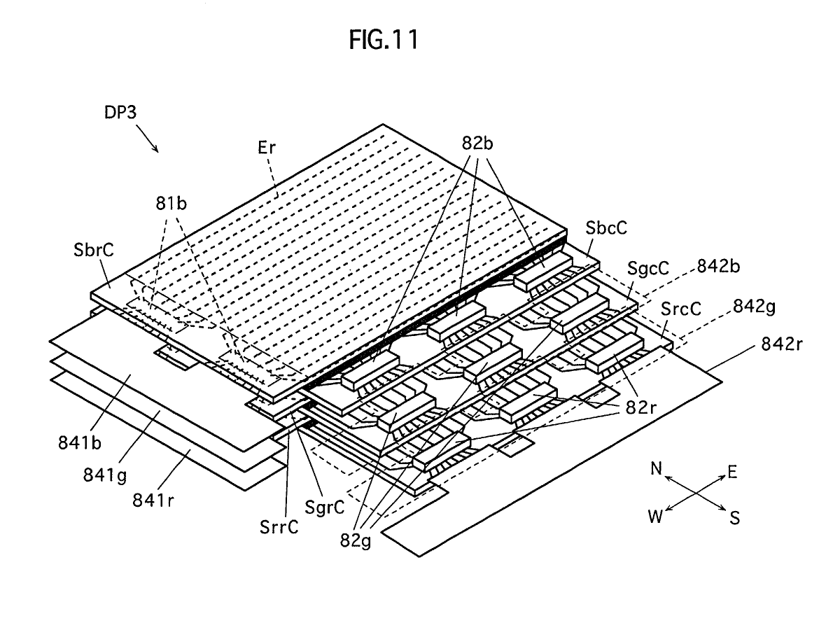

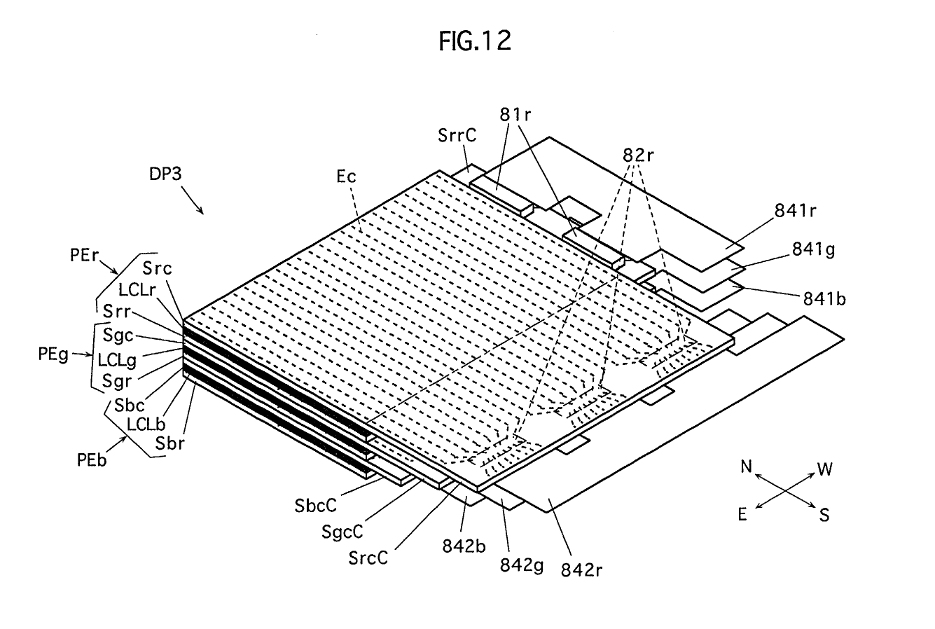

In each of multi-layer LCD panels, which will be described later, instead of mounting the driver IC directly on the connection portion of the panel element substrate, the driver IC carrier substrate may be connected to the connection portion of the panel element substrate for connecting the electrode on the panel element substrate to the driver IC.

[6] FIGS. 11 and 12 are schematic perspective views of further another example of the multi-layer LCD panel.

The multi-layer LCD panel DP3 shown in FIGS. 11 and 12 have the three liquid crystal panel elements PEb, PEg and PEr, which are layered together, similarly to the foregoing multi-layer LCD panel DP1.

Each of the panel element of the multi-layer LCD panel DP3 has the same basic structure as the panel element of the display panel DP1 shown in FIG. 1(A).

In the multi-layer LCD panel DP3, similarly to the display panel DP1, the driver ICs are mounted on the respective connection portions of the panel element substrates, and the junction substrates are connected to the respective connection portions of the panel element substrates. In FIG. 11, the junction substrates 842b and 842g connected to the connection portions SbcC and SgcC are depicted by dotted line for easy understanding.

In the multi-layer LCD panel DP3, the connection portions SbrC, SgrC and SrrC of the row substrates have the overlapping structure, similarly to the display panel DP1.

In the multi-layer LCD panel DP3, the connection portions SbcC, SgcC and SrcC of the column substrates have the following stepwise structure.

In the display panel DP3, the connection portions SbcC, SgcC and SrcC of the column substrates have different widths in their extending direction (south direction in this example), and these widths increase in accordance with the layering order of the column substrates. More specifically, the widths of the connection portions SbcC, SgcC and SrcC increase when viewed from the side allowing viewing of the electrode formation surfaces of the column substrates (i.e., when viewed from the front side in this example). Thus, the connection portion SbcC has the smallest width, and the connection portion SrcC has the largest width.

Owing to the above stepwise structure, the electrode formation surfaces (the driver IC mounting surfaces and the junction substrate connecting surfaces) of the connection portions SbcC, SgcC and SrcC are exposed at least partially. More specifically, each of the electrode formation surfaces of the connection portions SbcC, SgcC and SrcC is exposed to an extent allowing connection of the driver ICs and the junction substrates in the state that all the panel elements are overlaid and adhered together.

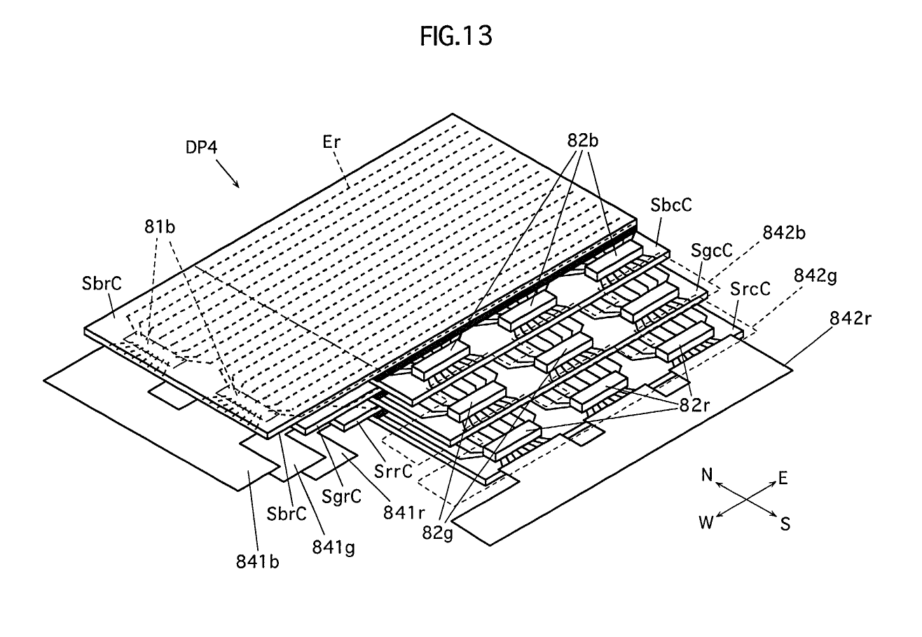

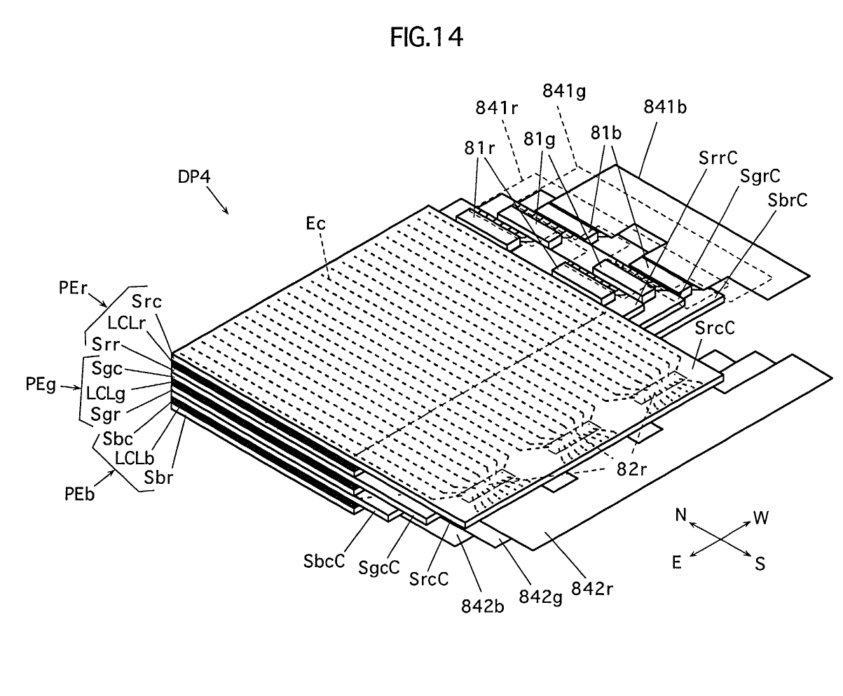

In the multi-layer LCD panel DP3, therefore, mounting of the driver ICs and connection of the junction substrates can be effected on the connection portions of the column substrates even in the state where all the panel elements overlap with each other. Further, repairing of the driver IC mounting and repairing of the junction substrate connection can be performed in the state where all the panel elements overlap with each other.

[7] The connection portions of the column substrates as well as the connection portions of the row substrates may have the stepwise structures, as is done in a multi-layer LCD panel DP4 shown in FIGS. 13 and 14.

In FIG. 13, the junction substrates 842b and 842g are depicted by dotted line for easy understanding. In FIG. 14, the junction substrates 841r and 841g are likewise depicted by dotted line for easy understanding.

In the multi-layer LCD panel DP4, similarly to the connection portions of the column substrates, the connection portions SbrC, SgrC and SrrC of the row substrates have different widths in their extending direction (i.e., west direction in this example), and these widths increase in accordance with the layering order of the row substrates Sbr, Sgr and Srr. More specifically, the widths of the connection portions SbrC, SgrC and SrrC increase when viewed from the side allowing viewing of the electrode formation surfaces of the row substrates (i.e., when viewed from the back side in this example). Thus, the connection portion SrrC has the smallest width, and the connection portion SbrC has the largest width.

Owing to the above, the electrode formation surface of each connection portion is exposed at least partially in the display panel DP4.

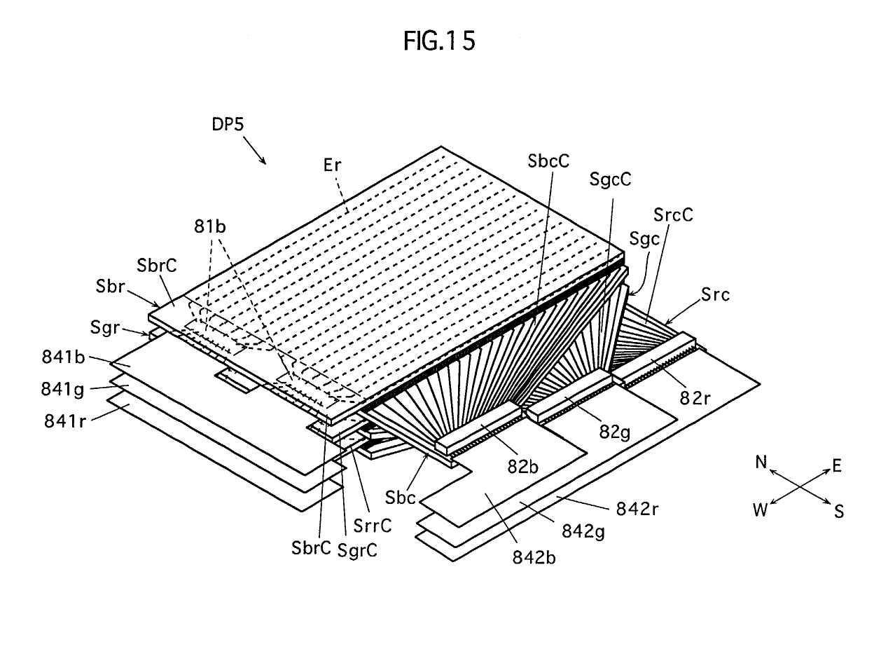

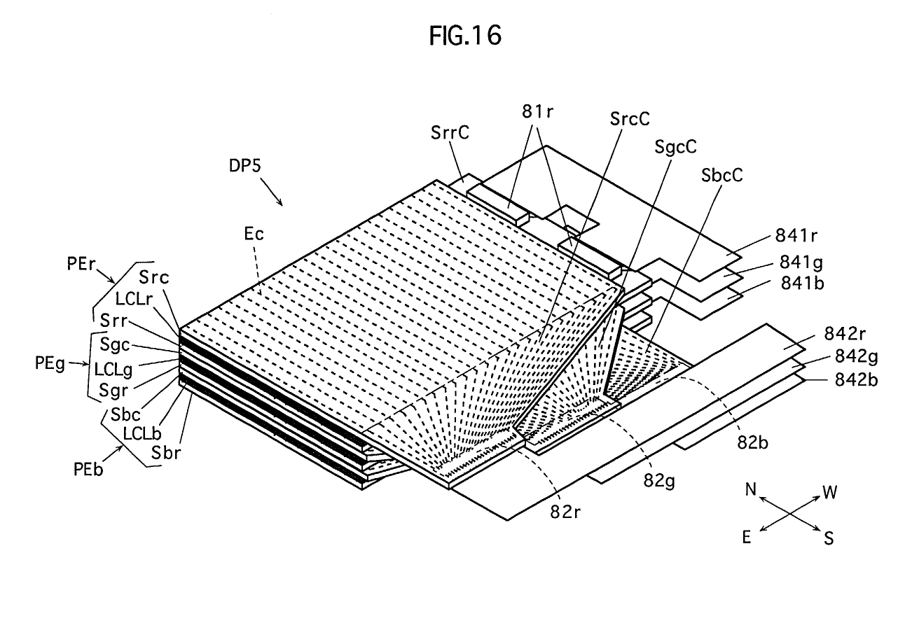

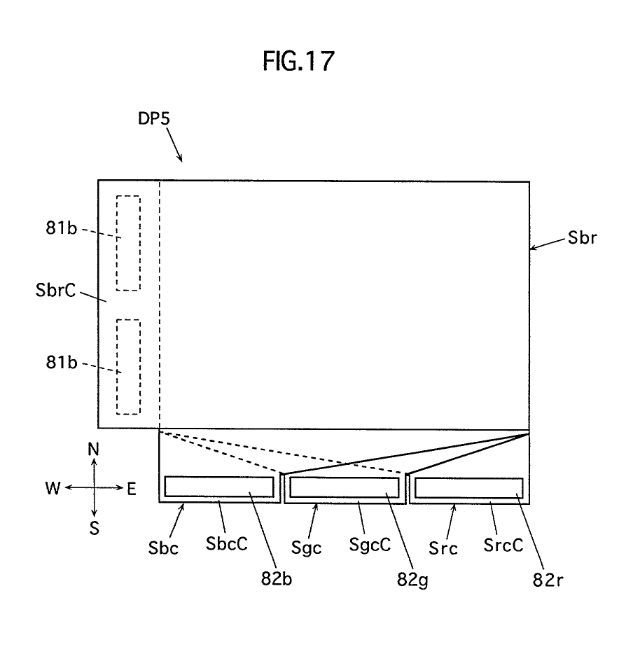

Therefore, mounting of the driver IC and connection of the junction substrate can be effected onto each of the connection portions of the substrates even in the state where all the panel elements overlap with each other. Further, repairing of the driver IC mounting and repairing of the junction substrate connection can be performed in the state where all the panel elements overlap with each other.

[8] FIGS. 15 and 16 are schematic perspective views of further another example of the multi-layer LCD panel. FIG. 17 is a plan showing the multi-layer LCD panel of FIGS. 15 and 16.

The multi-layer LCD panel DP5 shown in FIGS. 15, 16 and 17 has the three liquid crystal panel elements PEb, PEg and PEr layered together, similarly to the display panel DP1.

Each of the panel element of the multi-layer LCD panel DP5 has the same basic structure as the panel element of the display panel DP1 shown in FIG. 1(A).

In the multi-layer LCD panel DP5, similarly to the display panel DP1, the driver ICs are mounted on the connection portions of the panel element substrates, and the junction substrates are connected to the connection portions of the panel element substrates, respectively. In FIG. 17, the junction substrates are not illustrated for easy understanding.

In the multi-layer LCD panel DP5, the connection portions SbrC, SgrC and SrrC of the row substrates have the overlapping structure, similarly to the display panel DP1.

In the multi-layer LCD panel DP5, the connection portions SbcC, SgcC and SrcC of the column substrates have the following shift structure.

In the display panel DP5, the connection portions SbcC, SgcC and SrcC of the column substrates have the same width in their extending direction (i.e., south direction in this example).

In the display panel DP5, the width of the connection portion SbcC, in the perpendicular direction (i.e., east or west direction in this example) perpendicular to the extending direction of the connection portion SbcC, decreases as the position moves away from the overlap portion SbcO from which the connection portion SbcC is extended. The width of the end of the connection portion SbcC is smaller than 1/3 of the width of the overlap portion SbcO. The width of the connection portion SbcC gradually decreases such that the end of the connection portion SbcC is located at a position corresponding to a west portion among east, middle and west portions, which are prepared by dividing the overlap portion SbcO into three.

Likewise, the width of the connection portion SgcC, in the perpendicular direction (i.e., east or west direction in this example) perpendicular to the extending direction of the connection portion SgcC, decreases as the position moves away from the overlap portion SgcO from which the connection portion SgcC is extended. The width of the end of the connection portion SgcC is smaller than ⅓ of the width of the overlap portion SgcO. The width of the overlap portion SgcO is equal to the width of overlap portion SbcO. The width of the connection portion SgcC gradually decreases such that the end of the connection portion SgcC is located at the position corresponding to the middle portion among the east, middle and west portions, which are prepared by dividing the overlap portion SgcO into three.

Likewise, the width of the connection portion SrcC, in the perpendicular direction (i.e., east or west direction in this example) perpendicular to the extending direction of the connection portion SrcC, decreases as the position moves away from the overlap portion SrcO from which the connection portion SrcC is extended. The width of the end of the connection portion SrcC is smaller than ⅓ of the width of the overlap portion SrcO. The width of the overlap portion SrcO is equal to the width of overlap portion SbcO. The width of the connection portion SrcC gradually decreases such that the end of the connection portion SrcC is located at the position corresponding to the east portion among the east, middle and west portions, which are prepared by dividing the overlap portion SrcO into three.

Owing to the above, the positions of the south end portions of the connection portions SbcC, SgcC and SrcC of the column substrates do not overlap with each other, and are shifted in the east (or west) direction. The connection portions SbcC, SgcC and SrcC are disposed in the tab-like fashion shifted in the east (or west) direction.

Each of the electrode formation surfaces of the connection portions SbcC, SgcC and SrcC is exposed at least partially. The driver IC mounted regions and the junction substrate connected regions of the respective connection portions SbcC, SgcC and SrcC of the column substrates are shifted to each other in the perpendicular direction (i.e., east or west direction in this example) perpendicular to the extending direction of the connection portion of the column substrate.

For exposing the driver IC mounted regions and the junction substrate connected regions of the respective connection portions SbcC, SgcC and SrcC at least partially, the positions of these regions are shifted in the perpendicular direction (i.e., east or west direction in this example), and for this purpose, the positions of the connection portions SbcC, SgcC and SrcC are shifted as described above. Similar structures may be employed if connecting the driver element carrier substrates carrying the driver elements to the connection portions, respectively.

In the multi-layer LCD panel DP5, therefore, mounting of the driver ICs and connection of the junction substrates can be effected on the connection portions of the column substrates even in the state where all the panel elements overlap with each other. Further, repairing of the driver IC mounting and repairing of the junction substrate connection can be performed in the state where all the panel elements overlap with each other.

[9] In the display panel DP5 shown in FIGS. 15, 16 and 17, the shift structure is employed in the connection portions of the column substrates such that the overlap portion of each column substrate is provided with one tab. Instead of this, the connection portions of the substrates may have the shift structure such that the each overlap portion is provided with two or more tabs.

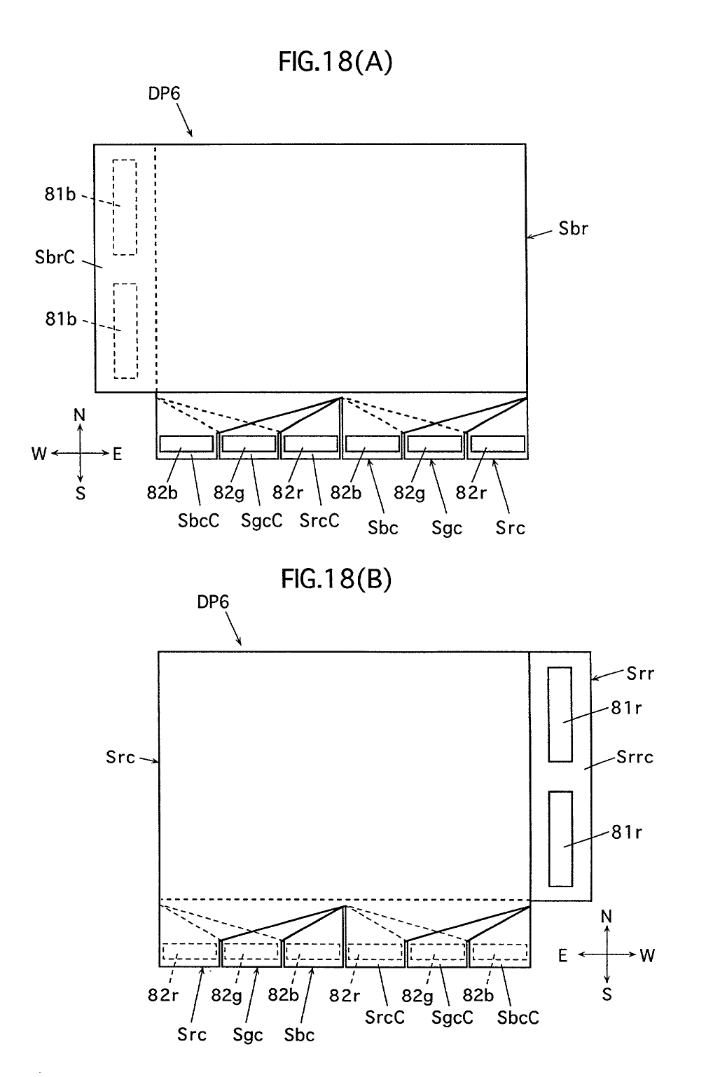

FIGS. 18(A) and 18(B) are plans showing a multi-layer LCD panel DP6 having such connection portions. In. FIGS. 18(A) and 18(B), the junction substrates are not illustrated.

In the multi-layer LCD panel DP6 shown in FIGS. 18(A) and 18(B), the connection portions SbcC, SgcC and SrcC of the column substrates have the shift structure such that the overlap portion of each the column substrate is provided with two tabs.

In the multi-layer LCD panel DP6, the electrode formation surfaces of the connection portions SbcC, SgcC and SrcC of the column substrates are exposed at least partially, respectively.

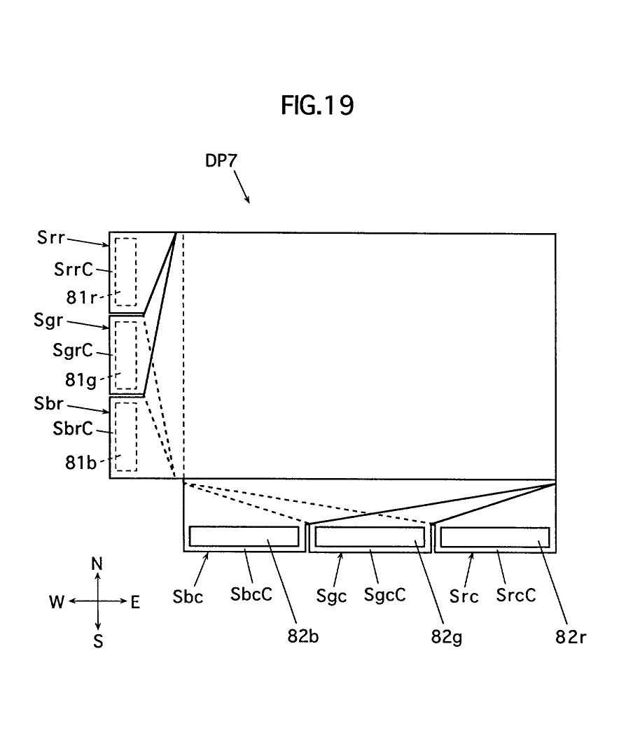

In the multi-layer LCD panel DP6, therefore, mounting of the driver ICs and connection of the junction substrates can be effected on the connection portions of the column substrates even in the state where all the panel elements overlap with each other. Further, repairing of the driver IC mounting and repairing of the junction substrate connection can be performed in the state where all the panel elements overlap with each other.

[10] The connection portions of the column substrates as well as the connection portions of the row substrates may have the shift structures, as is done in a multi-layer LCD panel DP7 shown in FIG. 19. In FIG. 19, the junction substrates are not illustrated.

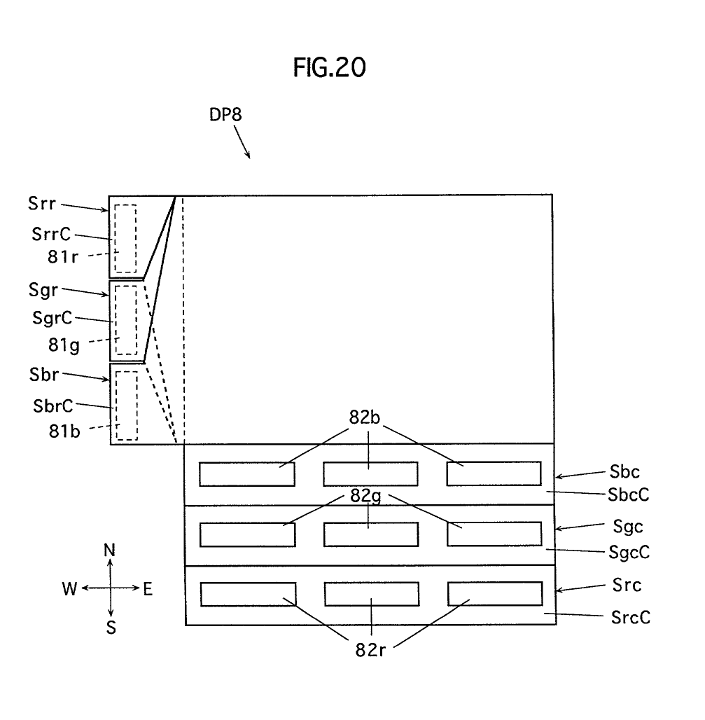

According to this structure, mounting of the driver ICs and connection of the junction substrates can be effected to all the connection portions of the multi-layer LCD panel DP7 even in the state where all the panel elements overlap with each other. Further, repairing of the driver IC mounting and repairing of the junction substrate connection can be performed in the state where all the panel elements overlap with each other.

[11] One of the shift structure and the stepwise structure may be employed in the connection portions of the column substrates, and the other may be employed in the connection portions of the row substrates, as is done in a multi-layer LCD panel DP8 shown in FIG. 20. In FIG. 20, the junction substrates are not illustrated.

In the multi-layer LCD panel DP8, the shift structure is employed in the connection portions SbrC, SgrC and SrrC of the row substrates, and the stepwise structure is employed in the connection portions of the column substrates SbcC, SgcC and SrcC.

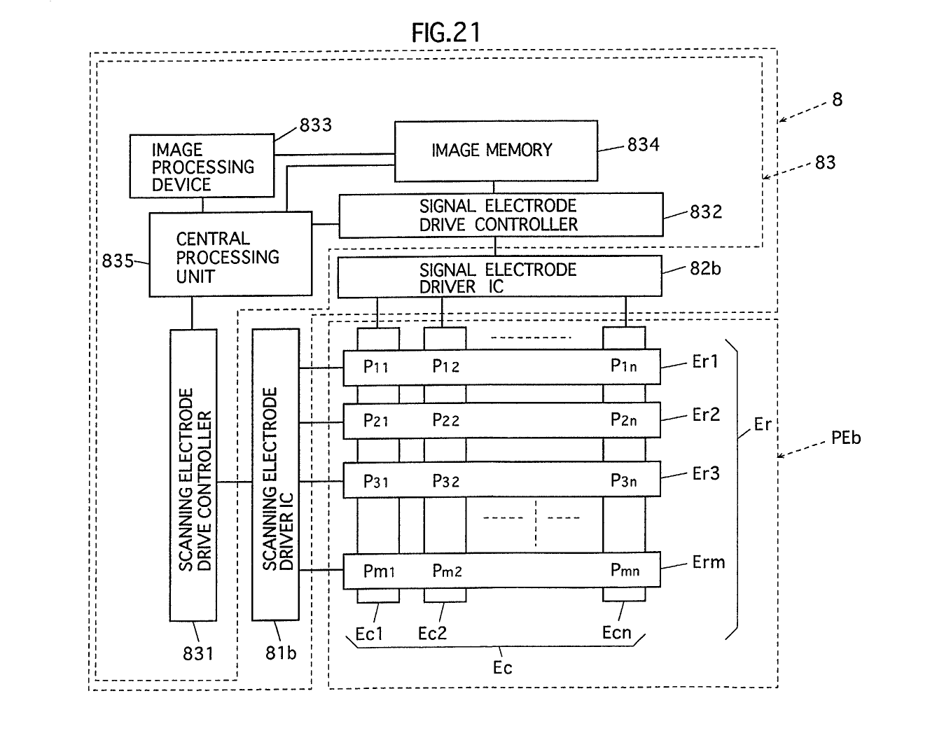

According to this structure, mounting of the driver ICs and connection of the junction substrates can be effected to all the connection portions of the multi-layer LCD panel DP8 even in the state where all the panel elements overlap with each other. Further, repairing of the driver IC mounting and repairing of the junction substrate connection can be performed in the state where all the panel elements overlap with each other.

[12] Description will now be given on the method of performing the simple matrix driving of the multi-layer liquid crystal display panel DP1 shown in FIG. 1(A) with reference to FIG. 21.

FIG. 21 shows the driver device 8 for the display panel DP1 together with the column electrode Ec and row electrode Er of the blue panel element PEb. Although FIG. 21 does not show the electrodes of the green and red panel elements PEg and PEr, these panel elements are driven in a manner similar to the following manner of driving the blue panel element.

The column electrode (signal electrode) Ec is formed of the plurality of belt-like electrodes as described before, and the belt-like electrodes forming the column electrode Ec correspond to electrodes Ec1-Ecn (n: natural number) in FIG. 21, respectively.

Likewise, the row electrode (scanning electrode) Er is formed of the plurality of belt-like electrodes as described before, and the belt-like electrodes forming the row electrode Er correspond to electrodes Er1-Erm (m: natural number) in FIG. 21, respectively.

In the blue panel element PEb, the orientation of the liquid crystal can be changed in each unit formed of a region, where one scanning electrode and one signal electrode cross each other, and its neighboring region. In the blue panel element PEb, the region, where one scanning electrode and one signal electrode cross each other, and its neighboring region form one pixel. The pixel in the position, where the scanning and signal electrodes Erp and Ecq cross each other, is represented as the pixel Ppq, where p is a natural number satisfying a relationship of 1≦p≦m, and q is a natural number satisfying a relationship of 1≦q≦n.

In blue panel element PEb, an image corresponding to the image data can be displayed in the following manner based on the image data, which is written into an image memory 834 by an image processing device 833 and a central processing unit 835.

The scanning electrode driver IC 81b issues a select signal to a predetermined scanning electrode among the scanning electrodes Er1-Erm for setting the scanning electrode to a selected state, and issues non-selection signals to the other scanning electrodes for setting the other scanning electrodes to unselected states. The scanning electrode driver IC 81b switches the scanning electrodes to be set to the selected state at predetermined time intervals, and each scanning electrode is successively set to the selected state. The above control is performed by a scanning electrode drive controller 831.

The signal electrode driver IC 82b issues signal voltages for rewriting the respective pixels on the scanning electrode in the selected state, and more specifically, issues simultaneously the signal voltages corresponding to the image data of the these drive target pixels to the respective signal electrodes so that the orientation of the liquid crystal of these drive target pixels change in accordance with the image data. For example, when the scanning electrode Er1 is selected, the orientations of the liquid crystal of the pixels P11-P1n on the scanning electrode Er1 change in accordance with the image data of these drive target pixels. The voltage difference, which is produced between the voltage applied to the scanning electrode of the drive target pixel, and the voltage applied to the signal electrode and corresponding to the image data, is applied to the liquid crystal of the drive target pixel. Therefore, the orientation of the liquid crystal of the drive target pixel changes in accordance with the image data.

Every time the selected scanning electrode is changed, the signal electrode driver IC 82b changes the orientations of the liquid crystal of the drive target pixels in accordance with the image data. This control is performed by the signal electrode drive controller 832 in parallel with the operation of reading image data from the image memory 834.

As described above, the liquid crystal of the drive target pixel is supplied with the voltage corresponding to the image data (tone data) of the drive target pixel. Therefore, in accordance with the image data of the drive target pixel, the liquid crystal of the drive target pixel can be set to a planar state, a focal conic state or a state where these states are mixed at a ratio corresponding to the display tone. Accordingly, gradation display corresponding to the image data can be performed.

The green and red panel elements PEg and PEr can be driven in accordance with the image data in a similar manner as described above, and thereby can perform the gradation display. By driving the three panel elements PEb, PEg and PEr in accordance with the image data, the full color display can be performed.

The controllers 831 and 832, image processing device 833, image memory 834 and central processing unit 835 in FIG. 21 correspond to the control portion 83 in the driver device 8 shown in FIG. 7.

The other multi-layer LCD panels can be driven in the simple matrix driving manner similar to the above.

[13] Description will now be given on the method of manufacturing the multi-layer LCD panel.

In the following description, the method for manufacturing the multi-layer LCD panel DP1 shown in FIG. 1(A) and others is presented.

For manufacturing the multi-layer LCD panel DP1, firstly, the three panel elements PEb, PEg and PEr are respectively formed (panel element forming step).

Thereafter, the panel elements thus formed are adhered together in a predetermined order (adhering step). The driver IC is mounted on the connection portion of each of the substrates of the panel elements in accordance with a predetermined timing, and the electrode on the substrate is connected to the driver IC (driver element connecting step). Further, the junction substrate is connected to the connection portion of each of the substrates of the panel elements in accordance with a predetermined timing (junction substrate connecting step).

In the process of manufacturing the multi-layer LCD panel DP1 shown in FIG. 1(A), the timings of connecting the driver IC and the junction substrate to the respective connection portions are different.

Description will be given on the respective steps starting from the panel element forming step.

[13-1] Panel Element Forming Step

In the panel element forming step, the three panel elements, i.e., blue, green and red panel elements PEb, PEg and PEr are formed.

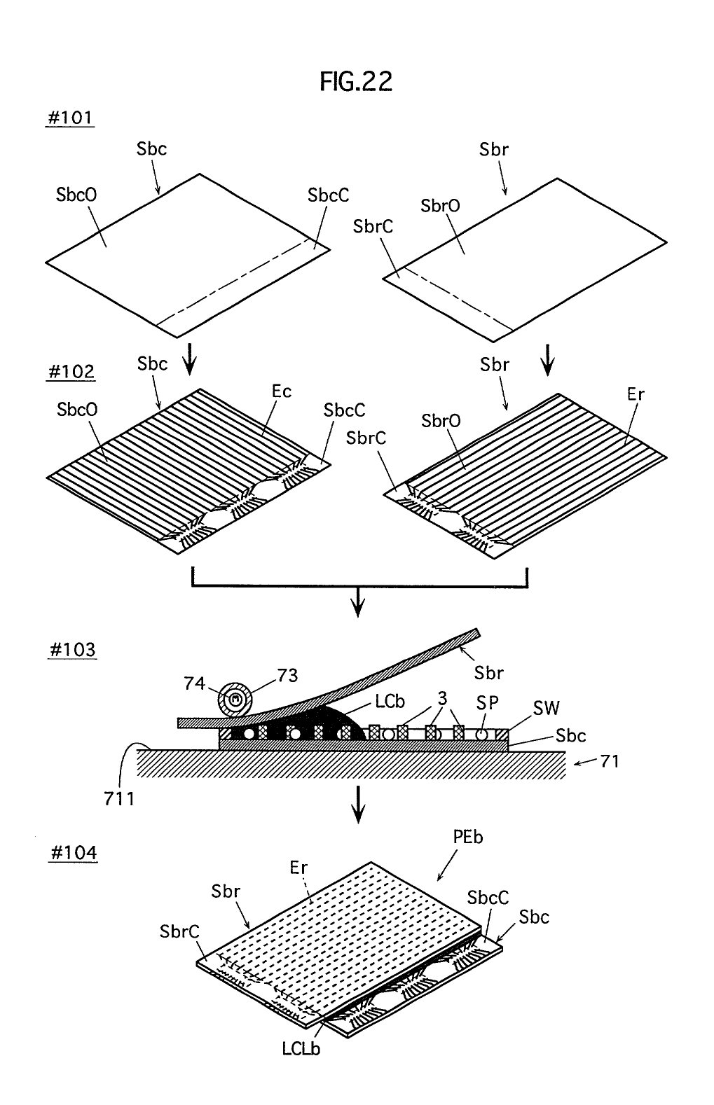

Referring to FIG. 22, description will be primarily given on the process of forming the blue panel element PEb. The green and red panel elements PEg and PEr can be formed similarly to the blue panel element PEb except for the kind of liquid crystal disposed between the substrates.

[13-1-1] Preparing Step

First, the resin substrate Sbc for forming the column electrode and others thereon as well as the resin substrate Sbr for forming the row electrode and others thereon are prepared (#101). In this example, polycarbonate films are used as the substrates Sbr and Sbc.

The column substrate Sbc has the overlap portion SbcO, which finally overlaps with the other five substrates, and the connection portion SbcC, which extends from the overlap portion and used for mounting the driver IC 82b and connecting the junction substrate 842b.

Likewise, the row substrate Sbr has the overlap portion SbrO, which finally overlaps with the other five substrates, and the connection portion SbrC, which extends from the overlap portion and used for mounting the driver IC 81b and connecting the junction substrate 841b.

For the other panel elements, the column and row substrates having similar structures are prepared.

In this stage in the process of producing the multi-layer LCD panel DP1, the column substrates of the respective panel elements have the same size, and there is no difference between them. Likewise, the column substrates of the respective panel elements in this stage have the same size, and there is no difference between them. Accordingly, commonality of kinds of parts of the multi-layer LCD panel DP1 can be achieved.

[13-1-2] Electrode Forming Step

Then, the column substrate Ec is formed on the column substrate Sbc of blue panel element PEb, and the row electrode Er is formed on the row substrate Sbr (#102). The column and row electrodes are likewise formed on the column and row substrates of the other panel elements.

The column electrode Ec may be formed on the column substrate Sbc of the blue panel element PEb in the following manner. First, a conductive film (ITO film in this example) is uniformly formed on the column substrate Sbc. Etching is effected, while utilizing photolithography method, on this conductive film to form a predetermined configuration so that a predetermined electrode pattern including a pattern of the column electrode Ec is formed. For example, photosensitive resist film is uniformly formed on the conductive film, and then is exposed via a mask having apertures of the pattern (positive pattern) corresponding to the electrode pattern to be formed. The resist film portion other than the exposed resist film portion is removed, and the etching is effected on the conductive film portion not covered with the resist film so that a predetermined electrode pattern is formed.

More specifically, a pattern of a plurality of belt-like electrodes, which are arranged parallel to each other with predetermined pitches, is formed on the overlap portion SbcO of the column substrate.

An electrode pattern for connecting the column electrode Ec on the overlap portion SbcO to the output lead (output bump) of the driver IC 82b is also formed on the connection portion SbcC of the column substrate Sbc. More specifically, the electrode pattern for transforming the electrode pitch on the overlap portion SbcO to the output lead pitch of the driver IC 82b is formed on the connection portion SbcC. An electrode pattern for connecting the input lead of the driver IC 82b to the junction substrate 842b is also formed on the connection portion SbcC.

The alignment marks (registration marks, target marks) to be used for the positioning in later steps are formed on the column substrate Sbc, in addition to the foregoing electrode pattern. The alignment marks are formed simultaneously with the foregoing electrode pattern, using the electrode material (ITO in this example).

The alignment marks for the following positioning or alignment are formed. The alignment marks for alignment of the column substrate Sbc and row substrate Sbr when these substrates are overlaid together with the liquid crystal therebetween to form the blue panel element PEb are formed. The alignment marks for aligning the panel elements when adhering these panel elements together in the adhering step are formed. The alignment marks for positioning the mounting position of the driver IC when mounting the driver IC onto the substrate connection portion of the panel element are formed. The alignment marks for positioning the connection position of the junction substrate when connecting the junction substrate to the substrate connection portion of the panel element are formed.

The alignment marks to be used for aligning the column and row substrates when these substrates are overlaid together may be the same as those used for aligning the panel elements when these panel elements are adhered together. These alignment marks may be formed on the overlap portion SbcO of the column substrate Sbc or the connection portion SbcC.

The alignment mark used for the mounting of the driver IC may be formed, e.g., within the mounting region, at which the driver IC is mounted, of the substrate. The alignment mark used for the connection of the junction substrate may be formed, e.g., within the connection region, at which the junction substrate is connected, of the panel element substrate.

Similar to the above, the row electrode Er and others are formed on the row substrate Sbr in a similar manner. More specifically, a pattern of the plurality of belt-like electrodes, which are arranged parallel to each other with predetermined pitches, are formed on the overlap portion SbrO of the row substrate Sbr. An electrode pattern for connecting the row electrode Er on the overlap portion SbrO to the output lead of the driver IC 81b as well as an electrode pattern for connecting the input lead of the driver IC 81b to the junction substrate 841b are formed on the connection portion SbrC. Alignment marks similar to those on the column substrate Sbc are formed on the row substrate Sbr.

For the other panel elements, the column electrode and others are formed on the column substrate, and the row electrode and others are formed the row substrate. In this example, the same mask is used for forming the column electrode and others on the column substrate of each of the panel elements. Also, the same mask is used for forming the row electrode and others on the row substrate of each of the panel elements. In this stage in the process of manufacturing the multi-layer LCD panel DP1, therefore, the column substrate of each panel element provided with the column electrode and others is the same as those of the other panel elements, and the row substrate of each panel element provided with the row electrode and others is the same as those of the other panel elements. Accordingly, the electrodes and others can be formed with high efficiency. Further, commonality of kinds of parts of the multi-layer LCD panel DP1 can be achieved.

[13-1-3] Step of Forming Insulating Film and Orientation Film

The insulating film I1 and the orientation film A1 are successively formed on the column electrode Ec of the column substrate Sbc. Also, the insulating film I2 and the orientation film A2 are successively formed on the row electrode Er of the row substrate Sbr.

Likewise, the insulating film and the orientation film are formed on the column electrode of the column substrate in each of the other panel elements. Also, the insulating film and the orientation film are formed on the row electrode of the row substrate in each of the other panel elements.

[13-1-4] Step of Forming Columnar Resin Structure

The columnar resin structures 3 are formed on one of the column and row substrates Sbc and Sbr. In this example, the resin structures are formed on the orientation film of the column substrate Sbc.

The resin structure may be made of a material which can be softened when heated, and can be solidified by cooling. An organic material which does not chemically react with the liquid crystal material, and has an appropriate elasticity is suitable for the material of the resin structures. The material of the resin structure may be a thermoplastic polymer material. The thermoplastic polymer material may be, e.g., polyvinyl dichloride resin, polyvinylidene chloride resin, polyvinyl acetate resin, methacrylate ester resin, polyacrylate ester resin, polystyrene resin, polyamide resin, polyethylene resin, polypropylene resin, fluororesin, polyurethane resin, polyacrylonitrile resin, polyvinyl ether resin, polyvinyl ketone resin, polyester resin, polyvinyl pyrolidone resin, saturated polyester resin, polycarbonate resin, chlorinated polyether resin or the like. The resin structure may be made of one or more of the above materials.

The resin structure can be formed, e.g., by a printing method, in which a paste containing resin (e.g., resin dissolved in solvent) is discharged onto the substrate by a squeeze through a screen or metal mask. The resin structure can be formed also by discharging the resin from nozzles onto the substrate in a dispenser method or an ink jet method. The resin structure can be formed in a transfer method in which the resin is supplied onto a flat plate or a roller, and then the resin is transferred onto the substrate. At this stage, the height of the resin structure is preferably larger than the intended thickness of the liquid crystal layer in view of the adhesion of the two substrates by this resin structure.

The resin structures are likewise formed on the column substrates of the other panel elements, respectively.

[13-1-5] Spacer Dispersing Step

The spacers SP are dispersed on one of the column and row substrates Sbc and Sbr. In this example, spacers SP are dispersed on orientation film of the column substrate Sbc.

The spacers may be preferably formed of particles, which are made of a hard material having a sufficient deformation resistance against heat and pressure. The spacer may be made of, e.g., an inorganic material such as finely divided glass fibers, silicate glass in the ball-like form or alumina powder, or spheric particles of an organic material such as divinylbenzene-contained cross-linked polymer or polystyrene-contained cross-linked polymer.

The spacers may be dispersed onto the substrate, e.g., by wet dispersing method or a dry dispersing method.

The spacers are likewise dispersed on the column substrates of the other panel elements, respectively.

[13-1-6] Seal Wall Forming Step

The seal wall SW is formed on one of the column substrate Sbc and the row substrate Sbr. In this example, the seal wall SW is formed on the column substrate Sbc.

The seal wall SW is formed on the overlap portion SbcO of the column substrate Sbc to have an annular form.

The seal wall SW may be made of, e.g., resin such as ultraviolet-curing resin or thermosetting resin.

The resin seal wall can be formed by discharging the resin from the nozzles onto the substrate, e.g., by the dispenser method or ink jet method. The resin seal wall can also be formed by a printing method using a screen or a metal mask. The resin seal wall can also be formed in a transfer method in which the resin is supplied onto a flat plate or a roller, and then the resin is transferred onto the substrate.

The seal walls are likewise formed on the column substrates of the other panel elements.

The resin structure forming step, the spacer dispersing step and the seal wall forming step may be performed in any order.

[13-1-7] Substrate Adhering Step

Then, droplets of the liquid crystal LCb are applied onto the region of column substrate Sbc surrounded by the seal wall SW, and then the column substrate Sbc and the row substrate Sbr are adhered together with the liquid crystal LCb therebetween (#103).

More specifically, the column substrate Sbc is laid on a plane 711 of a holding member 71. For preventing shifting of the position of the column substrate Sbc on the plane 711, the substrate Sbc may be sucked toward the plane 711 by air suction.

Then, droplets of the liquid crystal LCb having the selective reflection wavelength in the blue range are applied to the end portion of the foregoing region of the column substrate Sbc.

Then, only one end portion of the row substrate Sbr is overlaid on the column substrate Sbc with the liquid crystal LCb therebetween. At this stage, the substrate Sbr is bent or curved so that the other end portion of the row substrate Sbr is not overlaid on the column substrate Sbc. Since the row substrate Sbr is formed of the resin film, the row substrate Sbr can be bent as described above.

Then, a roller 73, internally provided with a heater 74, pushes the row substrate Sbr toward the column substrate Sbc while moving the pushed position from one end portion of the substrates toward the other end portion. The roller 73 may be moved. Alternatively, the substrates may be moved.

In this manner, the column and row substrates Sbc and Sbr are overlaid and adhered together from one end portion to the other end portion with the liquid crystal therebetween while spreading the liquid crystal LCb. By the heat of the heater 74, the resin structures 3 and the seal wall SW are welded to both the column and row substrates Sbc and Sbr for adhering them together. By overlaying and adhering the substrates from one end portion toward the other end portion while spreading the liquid crystal LCb, it is possible to suppress remaining of bubbles between the substrates and suppress remaining of bubbles into the liquid crystal. The thickness of the liquid crystal is adjusted to a predetermined thickness by the spacers SP. Instead of dispersing the spacers on the substrate, the spacers may be dispersed in the liquid crystal to be applied onto the substrate.

In this substrate adhering step, the column substrate Sbc and the row substrate Sbr are adhered together such that both the column and row electrodes Ec and Er are located inside of the substrates. Also, these substrates are adhered such that the column and row electrodes Ec and Er form a matrix structure. These substrates are adhered together after aligning these substrates by using alignment marks formed thereon.

Thereby, the blue panel element PEb is completed (#104). The other panel elements can be produced in a similar manner as described above. Since all the panel elements have the same basic structure, the respective panel elements can be formed only by changing the liquid crystal to be applied onto the substrate. Therefore, the panel elements can be manufactured with high efficiency.

The panel element may be formed in a vacuum-supply method.

[13-2] Panel Element Adhering Step, Driver Element Connecting Step and Junction Substrate Connecting Step

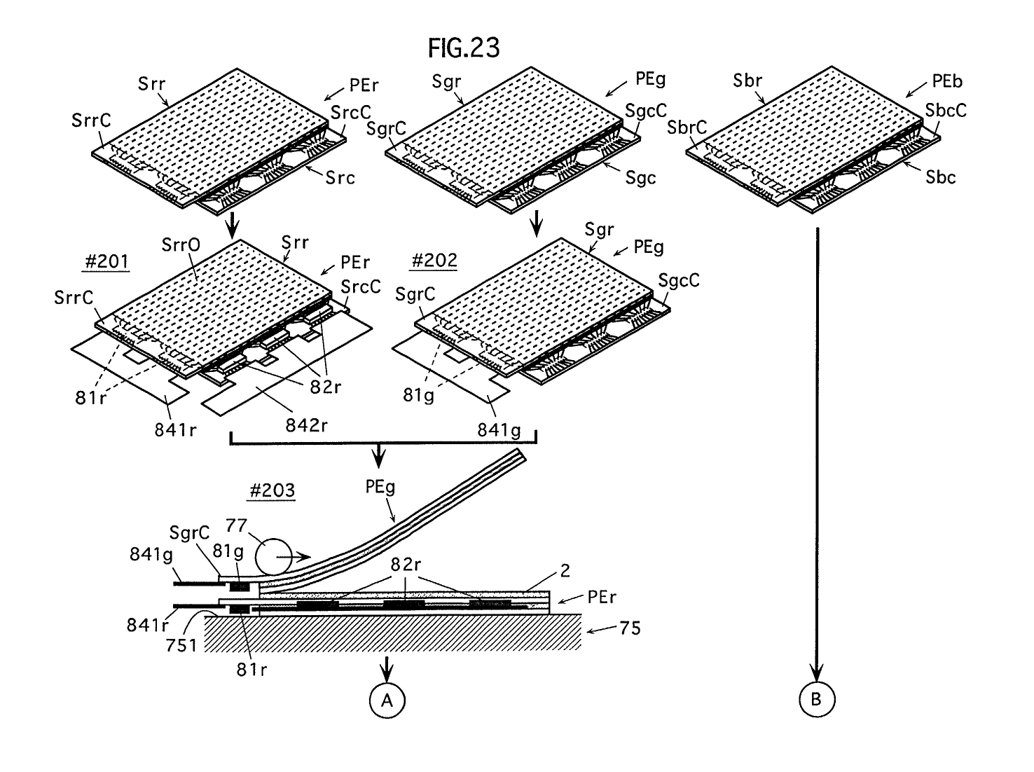

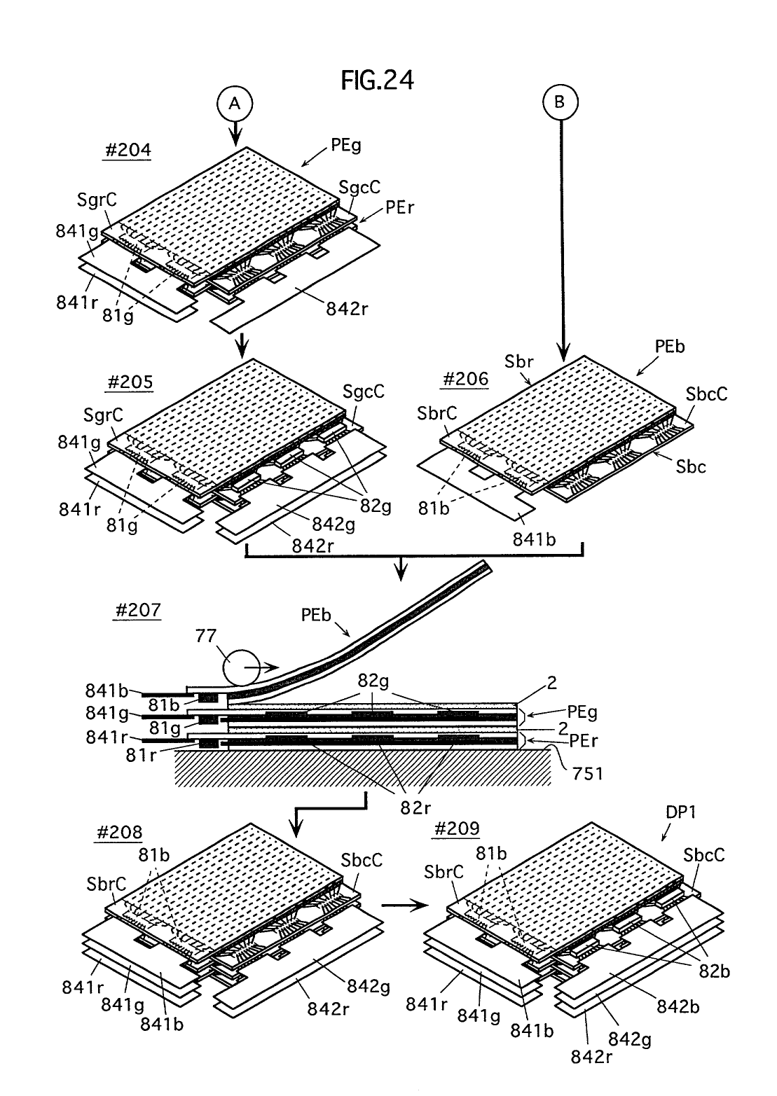

Description will now be given on the adhering step of adhering the three panel elements PEb, PEg and PEr thus prepared, the driver element mounting step of mounting the driver IC onto the substrate connection portion of the panel element (i.e., driver element connecting step of connecting the electrode on the panel element substrate to the driver IC), and the junction substrate connecting step of connecting the junction substrate to the substrate connection portion of the panel element with reference to FIGS. 23 and 24.

In this example, the green panel element PEg is firstly adhered to the red panel element PEr. Thereafter, the blue panel element PEb is adhered to the red and green panel elements PEr and PEg already adhered together.

In the panel element adhering step, the adhering of the panel elements is performed while handling one or more of the panel elements to be adhered is handled as “additional-adhered panel element”, and the other (remaining panel element(s)) is handled as “base panel element” to which the additional-adhered panel element is adhered.

In this example, when adhering the red and green panel elements PEr and PEg together, the red panel element PEr, which will be finally located in the outermost position, is handled as the base panel element, and the green panel element PEg is handled as the additional-adhered panel element to be adhered to the base panel element. Thus, in this example, the red panel element PEr is firstly handled as the base panel element.

After adhering the red and green panel elements PEr and PEg together, and when the blue panel element PEb is adhered to the panel elements PEr and PEg, the red and green panel elements PEr and PEg are handled as the base panel element, and the blue panel element PEb is handled as the additional-adhered panel element.

Before or after adhering the panel elements, the driver element mounting step and the junction substrate connecting step are performed in accordance with predetermined timing.

[13-2-1] Before Adhering Red and Green Panel Elements

Before adhering the red panel element (base panel element) PEr and the green panel element (additional-adhered panel element) PEg, the driver element connecting step and junction substrate connecting step are performed with respect to the following connection portions of the substrates of the red and green panel elements.

The driver IC 82r is mounted onto the connection portion SrcC of the red panel element (base panel element) PEr in advance before adhering the red and green panel elements (#201). Also, the junction substrate 842r is connected to the connection portion SrcC of the red panel element PEr before adhering the red and green panel elements (#201). The connection portion SrcC, to which operations of the mounting of the driver IC 82r and the connection of the junction substrate 842r are effected, of the red panel element (base panel element) PEr has the electrode formation surface to be hidden by the green panel element (additional-adhered panel element) PEg after adhering the red and green panel elements.

In this example, the driver IC 81r and the junction substrate 841r are mounted onto or connected to the other connection portion SrrC of the red panel element (base panel element) PEr before adhering the red and green panel elements (#201).

Thus, in this example, the driver IC and the junction substrate are mounted on or connected to each of the connection portions SrcC and SrrC of the red panel element PEr, which is firstly handled as the base panel element, before adhering the red and green panel elements (#201).

The mounting of the driver IC and the connection of the junction substrate are effected onto the two connection portions of the red panel element PEr, which does not overlay with any one of the other panel elements in this stage. Therefore, these mounting and connection can be performed easily with high efficiency.

Since the electrode formation surface of the connection portion SrrC of the red panel element PEr, which is firstly handled as the base panel element, is exposed even after adhering the three panel elements together, the mounting of the driver IC and the connection of the junction substrate onto the connection portion SrrC may be performed in any timing. For example, the mounting of the driver IC and the connection of the junction substrate onto the connection portion SrrC may be performed after adhering the three panel elements. However, by performing the mounting of the driver IC and the connection of the junction substrate onto the connection portion SrrC before adhering the red and blue panel elements PEr and PEb, these can be performed easily and efficiently.

Before adhering the red and green panel elements PEr and PEg, the driver IC 81g and the junction substrate 841g are also mounted on or connected to the connection portion SgrC of the green panel element (additional-adhered panel element) PEg, of which electrode formation surface is to be hidden by the red panel element (base panel element) PEr after adhering the red and green panel elements (#202).

Since the mounting of the driver IC and the connection of the junction substrate onto the connection portion SgrC of the green panel element PEg are performed before the green panel element PEg is overlaid with the other panel element, these operations can be performed easily and efficiently.

[13-2-2] Adhering of Red and Green Panel Elements

After the driver ICs and the junction substrates are mounted on or connected to the connection portions, having the electrode formation surfaces which will be hidden, of the red and green panel elements, the red and green panel elements PEr and PEg are adhered together as follows (#203).

In this example, the red and green panel elements PEr and PEg are adhered together with an adhesive film 2.

More specifically, the red panel element (base panel element) PEr is laid on a plane 751 of a holding member 75. For preventing shifting of the position of the panel element PEr on the plane 751, air suction may be performed for sucking the panel element PEr toward the plane 751.

Then, the adhesive film 2 is adhered to the overlap portion SrrO of the row substrate Srr of the red panel element PEr. Thus, the adhesive film 2 is applied to the adhesion surface of the red panel element PEr to be adhered with the green panel element PEg.

Then, only one end portion of the green panel element (additional-adhered panel element) PEg is overlaid on the red panel element PEr with the adhesive film 2 therebetween. The green panel element PEg is bent so that the other end portion of the green panel element PEg is not overlaid on the red panel element PEr in this stage.

Since the substrates of the green panel element PEg are the resin film substrates, the green panel element PEg can be bent as described above. Since the driver IC and the junction substrate are mounted on only the connection portion SgrC of the green panel element (additional-adhered panel element) PEg, the green panel element PEg can be bent uniformly. If the driver ICs and the junction substrates are mounted on each of the two connection portions of the green panel element PEg, it is difficult to uniformly bent the green panel element PEg.

Then, the green panel element PEg is pushed by a roller 77 toward the red panel element PEr with the adhesive film 2 therebetween while moving the pushed portion from one end portion toward the other end portion. The roller 77 may be moved. Alternatively, the panel elements may be moved. Thereby, the overlap portion SrrO of the row substrate Srr of the red panel element PEr and the overlap portion SgcO of the column substrate Sgc of the green panel element PEg are adhered together. By adhering the panel elements PEg and PEr from one end portion toward the other portion in above manner, it is possible to suppress remaining of bubbles between the panel elements, and also suppress wrinkling of the panel elements.

If the green panel element PEg cannot be bent uniformly, it is difficult to suppress remaining of bubbles and wrinkling even when the panel elements PEg and PEr are adhered from one end portion toward the other portion as described above. Since the driver ICs and the junction substrates are not mounted on all of the two connection portions of the green panel element (additional-adhered panel element) PEg before adhering the red and green panel elements as described above, the green panel element PEg can be bent uniformly, and thereby remaining of bubbles and wrinkling can be suppressed.

Through the above steps, a structure which has the red and green panel elements PEr and PEg adhered together with the adhesive film 2 therebetween is obtained (#204).

[13-2-3] After Adhering Red and Green Panel Elements, and Before Adhering of Blue Panel Element

After adhering the red and green panel elements PEr and PEg, and before adhering of the blue panel element PEb, the driver IC 82g and the junction substrate 842g are mounted onto or connected to the connection portion SgcC of the green panel element PEg, on which the driver IC and the junction substrate are not yet mounted or connected (#205).

In other words, before the blue panel element (additional-adhered panel element) PEb is adhered to base panel element composed of the red and green panel elements PEr and PEg already adhered, the driver IC 82g and the junction substrate 842g are mounted onto or connected to the connection portion SgcC of the green panel element (base panel element) PEg, of which electrode formation surface is to be hidden by the blue panel element (additional-adhered panel element) PEb after adhering the blue panel element to the red and green panel elements already adhered (#205).

Also, before adhering the blue panel element (additional-adhered panel element) PEb to the base panel element (red and green panel elements PEr and PEg), the driver IC 81b and the junction substrate 841b are mounted on or connected to the connection portion SbrC of the blue panel element (additional-adhered panel element) PEb, of which electrode formation surface is to be hidden by the base panel element after adhering the blue panel element to the red and green panel elements already adhered (#206).

The mounting of the driver IC and the connection of the junction substrate onto the connection portion SbrC of the blue panel element (additional-adhered panel element) PEb are not required to be performed after adhering the red and green panel elements PEr and PEg, and are merely required to be performed before adhering the blue panel element to the base panel element (red and green panel elements PEr and PEg), and therefore may be performed before adhering the red and green panel elements PEr and PEg.

Since the mounting of the driver IC and the connection of the junction substrate onto the connection portion SbrC of the blue panel element PEb is performed in the state where the blue panel element PEb is not overlaid with the other panel element, these mounting and connection can be performed easily and efficiently.

[13-2-4] Adhering of Blue Panel Element

After the driver ICs and the junction substrates are mounted on or connected to the connection portions, having the electrode formation surfaces which will be hidden, of the green and blue panel elements, the blue panel element PEb is adhered to the red and green panel elements PEr and PEg already adhered as follows (#207).

The adhering of the blue panel element PEb is performed similarly to the adhering of the red and green panel elements PEr and PEg.

First, the base panel element (red and green panel elements PEr and PEg) is laid onto the plane 751. The adhesive film 2 is adhered to the base panel element. Only one end portion of the blue panel element (additional-adhered panel element) PEb is overlaid to the base panel element with the adhesive film 2 therebetween. The blue panel element (additional-adhered panel element) PEb is pressed by the roller 77 toward the base panel element with the adhesive film 2 therebetween while moving the pushed portions from one end portion toward the other portion. Thereby, the blue panel element PEb and the base panel element are adhered together from one end portion to the other end portion.

Since the driver IC and the junction substrate are mounted on only one of the connection portions of the blue panel element (additional-adhered panel element) PEb, the blue panel element PEb can be adhered to the base panel element while uniformly bending the blue panel element PEb. Therefore, it is possible to suppress remaining of bubbles between the blue and green panel elements PEb and PEg. Further, wrinkling of the blue, green and red panel elements can be suppressed.

Through the above-steps, the structure including the three panel elements PEr, PEg and PEb adhered together is achieved (#208).

[13-2-5] After Adhering of Blue Panel Element

After adhering of the blue panel element PEb, the driver IC 82b and the junction substrate 842b are mounted onto or connected to the connection portion SbcC of the blue panel element PEb, on which the driver IC and the junction substrate are not yet mounted or connected (#209).

Thereby, the multi-layer LCD panel DP1 shown in FIG. 1(A) is completed.

According to the above manner for manufacturing the multi-layer LCD panel, the mounting of the driver IC and the connection of the junction substrate onto any one of the connection portions of the panel elements can be effected under the condition that the electrode formation surface of the connection portion, to be subjected to these mounting and connection, is not hidden by the other panel element. Thereby, the mounting of the driver IC and the connection of the junction substrate can be performed easily and efficiently.

Since the driver IC and the junction substrate are not mounted on all of the two connection portions of the additional-adhered panel element when adhering the additional-adhered panel element to the base panel element, the additional-adhered panel element can be uniformly bent. Thereby, it is possible to suppress remaining of bubbles between the panel elements and wrinkling of the panel elements.

For suppressing the remaining of bubbles and wrinkling, the driver IC and the junction substrate are mounted on or connected to only one of the connection portions of the additional-adhered panel element before adhering the additional-adhered panel element to the base panel element.

In another view, the driver IC and the junction substrate are mounted on or connected to one of the connection portions of the additional-adhered panel element before adhering the additional-adhered panel element to the base panel element. Thereby, the mounting of the driver IC and the connection of the junction substrate onto one of the connection portions of the additional-adhered panel element can be performed when the additional-adhered panel element is alone, that is, when the additional-adhered panel element is not overlaid with the other panel element. Accordingly, the mounting of the driver IC and the connection of the junction substrate can be effected more easily and more efficiently to one of the connection portions of the additional-adhered panel element.

The above method can be employed for manufacturing the other multi-layer LCD panel.

[14] It can be considered that the panel element adhering step, the driver IC mounting step (driver element connecting step) and the junction substrate connecting step for manufacturing the multi-layer LCD panel DPI described above are performed in the following manners. The description will be made with reference to FIGS. 23 and 24.

[14-1] Before Adhering Red and Green Panel Elements

Before adhering the red panel element (base panel element) PEr and the green panel element (additional-adhered panel element) PEg, the driver elements and junction substrates are mounted onto or connected to the following connection portions of the substrates of these panel elements.

In advance, the driver IC and the junction substrate are mounted on or connected to only one of the connection portions Sgrc and SgcC of green panel element (additional-adhered panel element) PEg before adhering the red and green panel elements. Before adhering the red and green panel elements PEr and PEg, the driver IC and the junction substrate are not mounted on the other connection portion of the green panel element (additional-adhered panel element) PEg.

In this example, the driver IC 81g and the junction substrate 841g are mounted onto or connected to the connection portion SgrC of the substrate Sgr of the green panel element (additional-adhered panel element) PEg. The connection portion SgrC, to which the mounting of the driver IC and the connection of the junction substrate are effected, is the connection portion of the substrate Sgr, to be located remoter between the substrates Sgr and Sgc from the red panel element (the base panel element) PEr after adhering the red and green panel elements, of the green panel element (additional-adhered panel element) PEg. The connection portion SgrC is also the connection portion having the electrode formation surface to be hidden by the red panel element PEr after adhering the red and green panel elements.

Since the driver IC and the junction substrate are mounted on or connected to the connection portion SgrC of the green panel element PEg when the green panel element PEg does not overlap with the other panel element, these mounting and connection can be performed easily and efficiently.

In advance, the driver IC 82r and the junction substrate 842r are mounted on or connected to the connection portion SrcC of the substrate Src of the red panel element (base panel element) PEr (#201). The connection portion SrcC, to which the mounting of the driver IC and the connection of the junction substrate are effected, is the connection portion of the substrate Src which is to be located remoter from the green panel element (additional-adhered panel element) PEg after adhering the red and green panel elements. The connection portion SrcC is also the connection portion having the electrode formation surface to be hidden by the green panel element PEg after adhering the red and green panel elements.

In this example, the driver IC 81r and the junction substrate 841r are, in advance, mounted on or connected to the other connection portion SrrC of the red panel element (base panel element) PEr before adhering the red and green panel elements (#201). Thus, in this example, the driver ICs and the junction substrates are mounted on or connected to each of the connection portions SrcC and SrrC of the red panel element PEr which is firstly handled as the base panel element (#201).

Since the mounting of the driver IC and the connection of the junction substrate to each of the two connection portions of the red panel element PEr are performed when the red panel element PEr is not overlaid with the other panel element, these mounting and connection can be performed easily and efficiently.

[14-2] Adhering of Red and Green Panel Elements

Then, the red and green panel elements PEr and PEg are adhered together in the same manner as already described (#203).

Since the driver IC and the junction substrate are mounted on or connected to only one of the connection portions of the green panel element (additional-adhered panel element) PEg, the green panel element PEg can be adhered while uniformly bending the green panel element PEg. Therefore, it is possible to suppress remaining of bubbles between the red and green panel elements PEr and PEg. Further, wrinkling of these panel elements can be suppressed.

Through the above steps, a structure having the red and green panel elements PEr and PEg adhered together is obtained (#204).

[14-3] After Adhering Red and Green Panel Elements, and Before Adhering of Blue Panel Element

Before the blue panel element (additional-adhered panel element) PEb is adhered to base panel element (red and green panel elements PEr and PEg), the driver ICs and the junction substrates are mounted onto or connected to only one of the connection portions of the blue panel element (additional-adhered panel element) PEb, similarly to the case of adhering of the red and green panel elements PEr and PEg.

Before adhering the blue panel element (additional-adhered panel element) PEb to the base panel element (red and green panel elements PEr and PEg), the driver IC 81b and the junction substrate 841b are mounted onto or connected to the connection portion SbrC of the substrate Sbr of the blue panel element PEb (#206). The connection portion SbrC, to which the mounting of the driver IC and the connection of the junction substrate are effected, of the blue panel element PEb is the connection portion of the substrate Sbr which is to be located remoter from the base panel element after adhering the blue panel element PEb to the base panel element. The connection portion SbrC is also the connection portion, of which electrode formation surface is to be hidden by the base panel element after adhering the blue panel element PEb to the base panel element.

Since the mounting of the driver IC and the connection of the junction substrate to the connection portion SbrC of the blue panel element PEb is performed when the blue panel element PEb does not overlap with the other panel element, these mounting and connection can be performed easily and efficiently.

The mounting of the driver IC and the connection of the junction substrate to the connection portion SbrC of the blue panel element (additional-adhered panel element) PEb is merely required to be performed before adhering the blue panel element to the base panel element (red and green panel elements PEr and PEg).

The driver IC and the junction substrate are also mounted or connected to the connection portion SgcC of the green panel element (base panel element) PEg before adhering the blue panel element (additional-adhered panel element) to the base panel element (#205). That is, the driver IC and the junction substrate are mounted or connected to the connection portion SgcC of the substrate Sgc, to be located remoter from the blue panel element (additional-adhered panel element) after adhering the blue panel element to the base panel element (red and green panel elements PEr and PEg).

If the driver IC and the junction substrate are not mounted or connected to the connection portion SrcC of the red panel element (base panel element) PEr in this stage, that is, to the connection portion of the substrate, to be located remoter from the blue panel element (additional-adhered panel element) PEb, of the red panel element (base panel element) PEr, the mounting of the driver IC and the connection of the junction substrate are effected to the connection portion SrcC, although the mounting of the driver IC and the connection of the junction substrate is already effected to the connection portion SrcC in former stage (that is, before adhering the red and blue panel elements) in this example.

[14-4] Adhering of Blue Panel Element

Then, the blue panel element PEb is adhered to the red and green panel elements PEr and PEg already adhered together (#207). The adhering of the blue panel element PEb is performed similarly to the adhering of the red and green panel elements PEr and PEg.

Since the driver IC and the junction substrate are mounted on or connected to only one of the connection portions of the blue panel element (additional-adhered panel element) PEb, the blue panel element PEb can be adhered while uniformly bending the blue panel element PEb. Therefore, it is possible to suppress remaining of bubbles between the blue and green panel elements PEb and PEg. Further, wrinkling of red, green and blue panel elements can be suppressed.

Through the above steps, a structure having the three panel elements PEr, PEg and PEr adhered together is obtained (#208).

[14-5] After Adhering of Blue Panel Element

After adhering of the blue panel element PEb, the driver IC 82b and the junction substrate 842b are mounted on or connected to the connection portion SbcC of the blue panel element PEb, on which the driver IC and the junction substrate are not yet mounted (#209).

Thereby, the multi-layer LCD panel DP1 shown in FIG. 1(A) is completed.

In the manner described above, the mounting of the driver IC and the connection of the junction substrate are effected on one of the connection portions of the additional-adhered panel element before adhering the additional-adhered panel element to the base panel element. Accordingly, the mounting of the driver IC and the connection of the junction substrate can be effected on one of the connection portions of the additional-adhered panel element when the additional-adhered panel element is alone, that is, when the additional-adhered panel element is not overlaid with the other panel element. Accordingly, the mounting of the driver IC and the connection of the junction substrate can be effected easily and efficiently on one of the connection portions of the additional-adhered panel element. By effecting the mounting of the driver IC and the connection of the junction substrate to the connection portion of the substrate, to be located remoter from the base panel element after adhering the base and additional-adhered panel element, of the additional-adhered panel element, the mounting of the driver IC and the junction substrate can be performed before the electrode formation surface is hidden.

Since the driver IC and the junction substrate are mounted on or connected to only one of the connection portions of the additional-adhered panel element, the additional-adhered panel element can be adhered to the base panel element while uniformly bending the additional-adhered panel element. Therefore, it is possible to suppress remaining of bubbles between the base and additional-adhered panel elements as well as wrinkling of the base and additional-adhered panel elements.

Before adhering the additional-adhered panel element to the base panel element, the driver IC and the junction substrate are also mounted onto or connected to the connection portion of the base panel element, more specifically to the connection portion of the substrate, which is to be located remoter from the additional-adhered panel element after adhering the base and additional-adhered panel elements. Since the connection portion of the substrate, to be located remoter from the additional-adhered panel element after adhering the base and additional-adhered panel elements, of the base panel element has a possibility that its electrode formation surface is to be hidden by the additional-adhered panel element after adhering the base and additional-adhered panel elements, the mounting of the driver IC and the connection of the junction substrate can be effected on the connection portion of the base panel element before the electrode formation surface is hidden. This allows easy mounting of the driver IC and connection of the junction substrate.

The above manners may be employed for manufacturing other type of multi-layer LCD panel.

[15] The manners described in the above item [14] are particularly useful in manufacturing the multi-layer display panel, in which the electrode formation surfaces of all the connection portions are exposed even after all the panel elements are adhered together, such as the multi-layer LCD panel DP4 shown in FIG. 13.

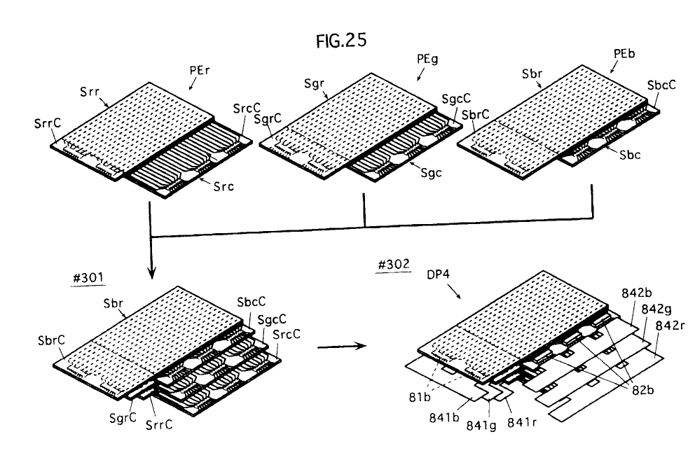

The multi-layer LCD panel DP4 can be manufactured such that, as shown in FIG. 25, the driver ICs and the junction substrates are mounted onto or connected to the respective connection portion after adhering all the panel elements (#301, #302).

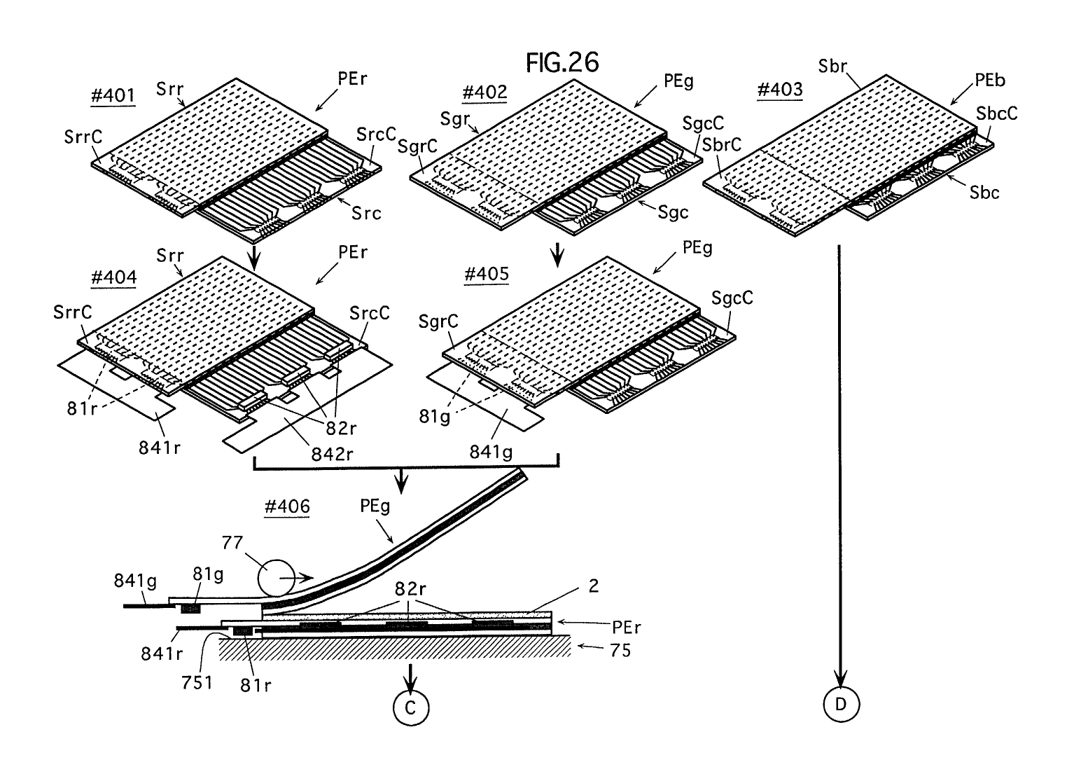

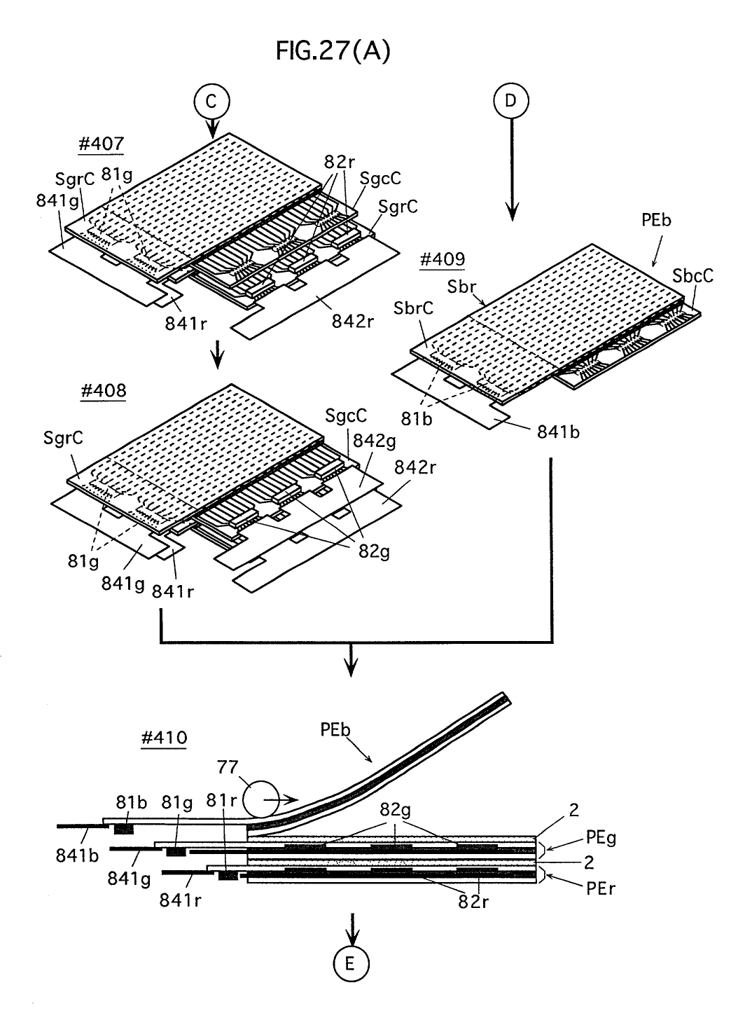

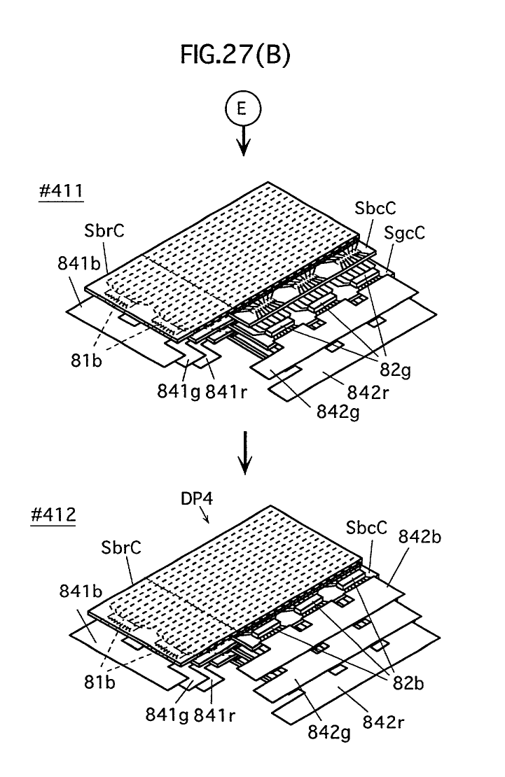

However, according to the following manners for manufacturing the multi-layer LCD panel DP4, the mounting of the driver IC and the connection of junction substrate to the respective connection portions can be performed more easily and efficiently, and therefore the multi-layer LCD panel DP4 can be manufactured efficiently. The manners for manufacturing the multi-layer LCD panel DP4 will be described below with reference to FIGS. 26, 27(A) and 27(B).

The panel elements PEb, PEg and PEr are manufactured in the similar manner as that already described (#401, #402 and #403).

[15-1] Before Adhering Red and Green Panel Elements

Before adhering the red panel element (base panel element) PEr and the green panel element (additional-adhered panel element) PEg, the driver elements and junction substrates are connected to the following connection portions of the substrates of these panel elements.

The driver IC and the junction substrate are mounted on or connected to only one of the connection portions SgrC and SgcC of green panel element (additional-adhered panel element) PEg before adhering the red and green panel elements.

In this example, the driver IC 81g and the junction substrate 841g are mounted onto or connected to the connection portion SgrC of the substrate Sgr, to be located remoter from the red panel element (base panel element) PEr, of the green panel element (additional-adhered panel element) PEg (#405).

The electrode formation surface of each of the connection portions SgrC and SgcC of the green panel element (additional-adhered panel element) PEg is exposed even after adhering all the panel elements. Therefore, the driver IC and the junction substrate may be mounted onto or connected to the connection portion SgcC instead of the connection portion SgrC. However, the driver IC and the junction substrate are not mounted on all the connection portions SgrC and SgcC, and are mounted on only one of these connection portions.

Since the driver IC and the junction substrate are mounted onto or connected to the connection portion SgrC of the green panel element PEg when the green panel element PEg does not overlap with the other panel element, these mounting and connection can be performed easily and efficiently.

The driver ICs and the junction substrates are mounted onto or connected to the respective connection portions SrcC and SrrC of the red panel element PEr, which is firstly handled as the base panel element (#404). More specifically, the driver IC 81r and the junction substrate 841r are mounted on the connection portion SrrC. The driver IC 82r and the junction substrate 842r are mounted on the connection portion SrcC.

Since the driver ICs and the junction substrates are mounted on or connected to the two connection portions of the red panel element PEr while the red panel element PEr is not overlaid with the other panel element, these mounting and connection can be performed easily and efficiently.

[15-2] Adhering of Red and Green Panel Elements

Then, the red and green panel elements PEr and PEg are adhered together in the similar manner as already described (#406).

Since the driver IC and the junction substrate are mounted on only one of the connection portions of the green panel element (additional-adhered panel element) PEg, the green panel element PEg can be adhered while uniformly bending the green panel element PEg. Therefore, it is possible to suppress remaining of bubbles between the red and green panel elements PEr and PEg. Further, wrinkling of these panel elements can be suppressed.

Through the above steps, a structure having the red and green panel elements PEr and PEg adhered together is obtained (#407).

[15-3] After Adhering Red and Green Panel Elements, and Before Adhering of Blue Panel Element

Before the blue panel element (additional-adhered panel element) PEb is adhered to base panel element (red and green panel elements PEr and PEg), the driver IC and the junction substrate are mounted on or connected to only one of the connection portions of the additional-adhered panel element (blue panel element PEb), similarly to the case of the adhering of the red and green panel elements PEr and PEg.

In this example, the driver IC 81b and the junction substrate 841b are mounted onto or connected to the connection portion SbrC of the blue panel element (additional-adhered panel element) PEb before adhering the blue panel element to the red and green panel elements already adhered, that is, to the connection portion SbrC of the substrate Sbr to be located remoter from the base panel element, (#409).

Since the electrode formation surface of each of the connection portions SbrC and SbcC of the blue panel element (additional-adhered panel element) PEb is exposed even after adhering all the panel elements, the driver IC and the junction substrate may be mounted onto or connected to the connection portion SbcC instead of the connection portion SbrC. However, the driver IC and the junction substrate are not mounted on all the connection portions SbrC and SbcC, and are mounted on only one of these connection portions.

Since the driver IC and the junction substrate are mounted on or connected to the connection portion SbrC of the blue panel element PEb while the blue panel element PEb does not overlap with the other panel element, these mounting and connection can be performed easily and efficiently.

In this example, the driver IC 82g and the junction substrate 842g are, in advance, mounted on or connected to the connection portion SgcC of the green panel element (base panel element) PEg, that is, to the connection portion SgcC of the substrate Sgc to be located remoter from the blue panel element (additional-adhered panel element) (#408). The mounting of the driver IC and the connection of the junction substrate to the connection portion SgcC may be performed after adhering all the panel elements.

[15-4] Adhering of Blue Panel Element

Then, the blue panel element PEb is adhered to the red and green panel elements PEr and PEg already adhered together (#410). The adhering of the blue panel element PEb is performed similarly to the adhering of the red and green panel elements PEr and PEg.

Since the driver IC and the junction substrate are mounted on only one of the connection portions of the blue panel element (additional-adhered panel element) PEb, the blue panel element PEb can be adhered while uniformly bending the blue panel element PEb. Therefore, it is possible to suppress remaining of bubbles between the blue and green panel elements PEb and PEg. Further, wrinkling of the red, green and blue panel elements can be suppressed.

Through the above steps, a structure having the three panel elements PEr, PEg and PEr adhered together is obtained (#411).

[15-5] After Adhering of Blue Panel Element

After adhering of the blue panel element PEb, the driver IC and the junction substrate are mounted onto or connected to the connection portion, on which the driver IC and the junction substrate are not yet mounted. That is, the driver IC 82b and the junction substrate 842b are mounted onto or connected to the connection portion SbcC of the blue panel element PEb (#412).

Thereby, the multi-layer LCD panel DP4 shown in FIG. 13 is completed.

By manufacturing the multi-layer LCD panel DP4 as described above, the mounting of the driver ICs and the connection of the junction substrates can be effected on four among the six connection portions while the panel element having the connection portion to be subjected to such mounting operation is not overlaid with the other panel element. Therefore, the mounting of the driver ICs and the junction substrates can be performed easily and efficiently.

[16] Driver IC Mounting Step and Junction Substrate Connecting Step

Description will now be given on the mounting of the driver IC and connecting the junction substrate in greater detail. In the following description, the mounting of the driver IC and connecting the junction substrate are performed for manufacturing the multi-layer LCD panel DP1 shown in FIG. 1(A). The method for manufacturing the multi-layer LCD panel DP1 is already described in the items [13] and [14].

[16-1] Positioning

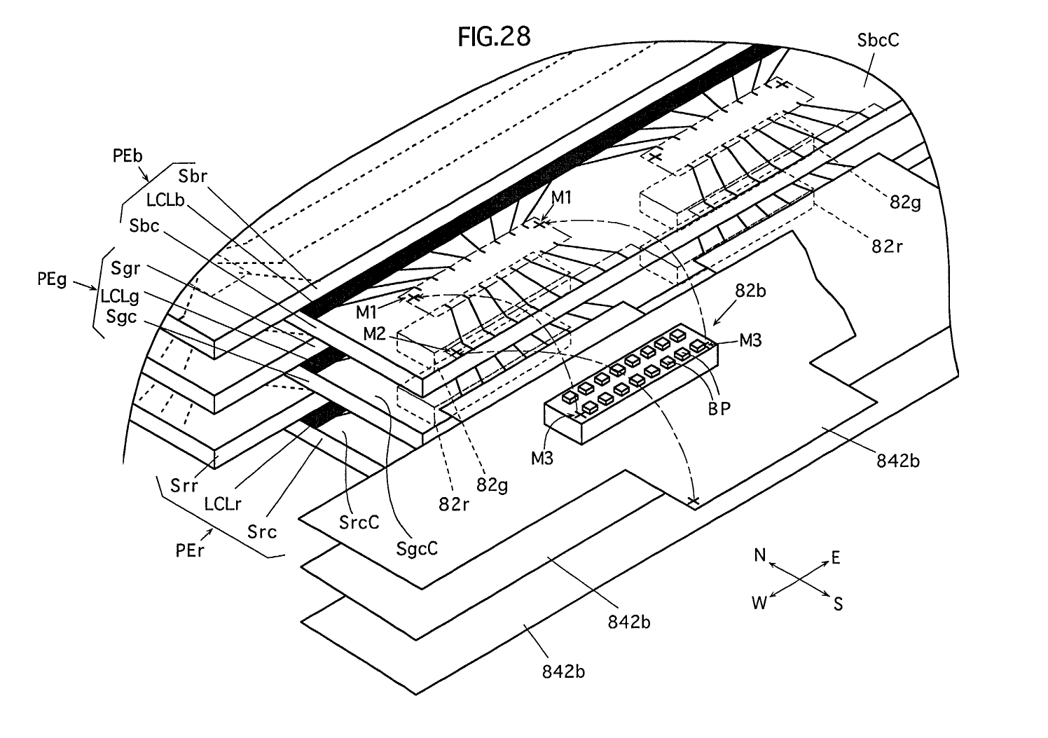

The driver IC is mounted to the connection portion of the panel element substrate after positioning between the driver IC and the connection portion in a manner as follows. The junction substrate is also connected to the connection portion of the panel element substrate after positioning them in the manner as follows. With reference to FIG. 28, description will now be given on the positioning in the case of mounting the driver IC and connecting the junction substrate to the connection portion SbcC of the column substrate Sbc of the blue panel element PEb.

As shown in FIG. 28, two alignment marks (registration marks, target marks) M1 are formed on each mounting region, to which the driver IC 82b is to be mounted, of the connection portion SbcC of column substrate Sbc. The mounting region is indicated by alternate long and short dash line in FIG. 28. Alignment marks M2 are formed on the connection region, to which the junction substrate 842b is to be connected, of the connection portion SbcC. The connection region is indicated by alternate long and short dash line in FIG. 28. Although FIG. 28 shows only one alignment mark M2, the connection portion SbcC is provided with two alignment marks M2. As already described, the alignment marks are made of the electrode material (ITO in this example).

The alignment marks M1 on the substrate connection portion and the alignment marks M3 on the driver IC 82b are used for alignment or positioning so that the driver IC 82b is mounted on the predetermined region of the connection portion SbcC. Thereby, the output leads of the driver IC 82b are connected to the belt-like electrodes composing the column electrode Ec on the substrate Sbc, respectively.

The alignment marks M1 and M3 for driver IC mounting are read by a reading device (not shown) such as a CCD camera or a microscope. The alignment mark M1 on the connection portion SbcC is read from the front side of the connection portion SbcC. Based on the position of the alignment marks read by the reading device and others, positioning of the driver IC 82b is performed employing a known manner such as image processing manner.

As described above, the electrode patterns and others are formed on the column substrates of all the panel elements using the same mask. Accordingly, driver ICs 82b, 82g and 82r are mounted at the positions overlapping to each other on the connection portions SbcC, SgcC and SrcC of the column substrates of the panel elements PEb, PEg and PEr, respectively.

Therefore, when reading out the alignment mark M1 on the connection portion SbcC of the blue panel element PEb from the front side, the driver IC 82g, which is already mounted on the connection portion SgcC located under the connection portion SbcC, is viewed. In this example, each the driver IC is so-called “bare chip”, and an exposure surface of the driver IC is a silicon surface having a metal shine. The exposure surface of the driver IC is the back side surface of an mounting surface of the driver IC. The mounting surface of the driver IC is the surface to be opposed to the connection portion of the panel element substrate to which this driver IC is to be mounted. The exposure surface of the driver IC 82g is the upper surface in FIG. 28. When reading the alignment mark M1 on the connection portion SbcC, the metal-shiny surface of the driver IC 82g may be viewed, and thus may impede the reading of the alignment mark M1.

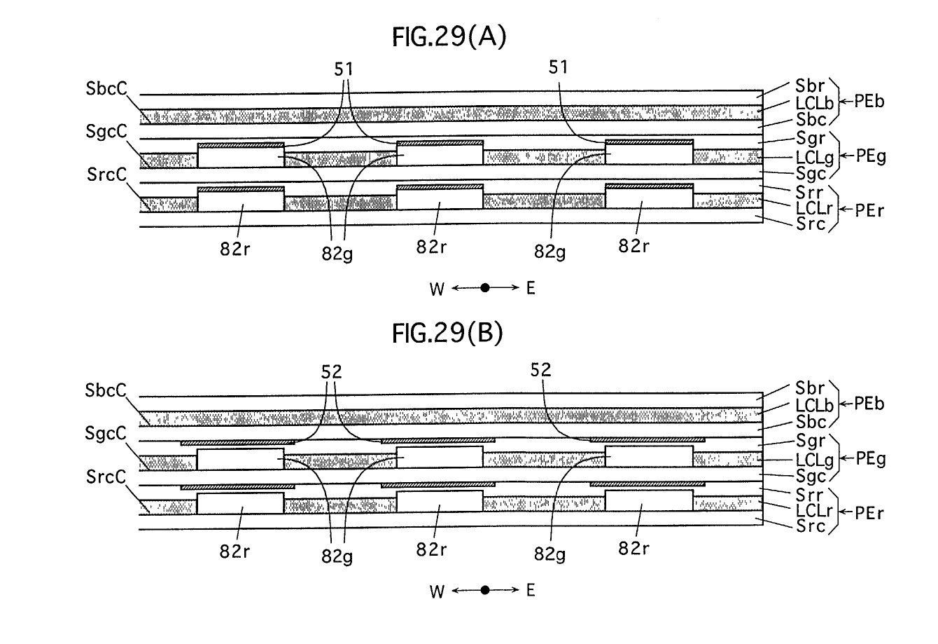

For preventing the above disadvantage, a coating or painting film 51 may be formed on the exposure surface of the driver IC 82g, as shown in FIG. 29(A). The painting film 51 may be formed before mounting the driver IC 82g on the connection portion SgcC. The painting film 51 may be formed after mounting the driver IC 82g on the connection portion SgcC. In either case, the painting film 51 hides or covers the metal-shiny exposure surface of the driver IC 82g when reading the alignment mark M1 on the connection portion SbcC. Therefore, the alignment mark M1 can be read correctly, and the driver IC 82b can be mounted at the correct position. The painting film 51 may be in whitish.

As shown in FIG. 29(B), a painting film (coating film) 52 may be formed on a region of a surface, which is a back surface of the surface carrying the alignment mark M1 to be read, of the connection portion SbcC, and particularly on the region corresponding to the mounting region to which the driver IC 82b is to be mounted. The painting film 52 may be formed at least the region corresponding to the region on which the alignment mark M1 is formed. The painting film 52 may be formed, e.g., before adhering the blue panel element PEb to the green panel element PEg. The painting film 52 may be formed in the panel element forming step. Similarly to the case of employing the painting film 51, the painting film 52 hides the metal-shiny surface of the driver IC 82g with respect to the reading device when reading the alignment mark M1 on the connection portion SbcC. Therefore, the alignment mark M1 can be read correctly, and the driver IC 82b can be mounted at the correct position. The painting film 52 may be in whitish.

The reading of the alignment mark on the connection portion SgcC may be performed in a similar manner.

The positioning of the junction substrate may be performed in a similar manner by using the alignment marks.

[16-2] Mounting With ACF

In this example, the mounting of the driver IC is performed using the ACF (Anisotropic Conductive Film). In this example, the connection of the junction substrate is likewise performed using the ACF.

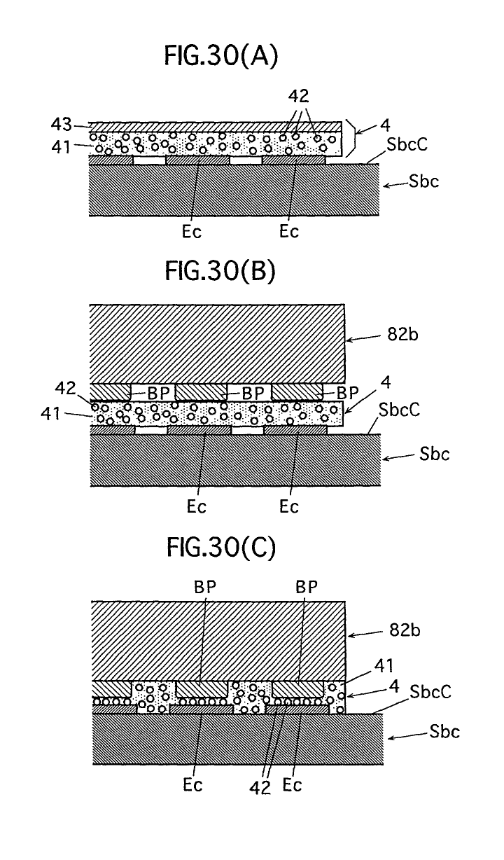

The mounting of the driver IC using the ACF will now be described in greater detail with reference to FIGS. 30(A), 30(B) and 30(C). A manner of mounting the driver IC 82b to the connection portion SbcC for connecting bumps BP of the driver IC 82b to the belt-like electrodes composing the column electrode EC on the connection portion SbcC is shown in FIGS. 30(A), 30(B) and 30(C).

First, a separator is removed from one side of an ACF 4, and the ACF 4 thus prepared is provisionally adhered onto the electrode Ec (see FIG. 30(A)).

The ACF 4 has a binder resin 41 made of thermosetting or thermoplastic resin, and also has electrically conductive particles 42 dispersed in the binder resin 41. Owing to a tack of the binder resin 41, the ACF 4 can be provisionally adhered to the electrode Ec. The provisional adhesion may be performed by applying a heat and a pressure lower than those for completely adhesion, whereby the provisional adhesion can be performed more reliably.

Then, a separator 43 is removed from the other side of the ACF 4.

Then, the driver IC 82b is positioned with respect to the connection portion SbcC, and the bumps BP of the driver IC 82b are laid on the ACF 4 (see FIG. 30(B)).

Thereafter, the driver IC 82b is pushed toward the substrate Sbc, and a heat is applied to the ACF 4. Thereby, bumps BP of the driver IC 82b is connected to the belt-like electrodes composing the column electrode Ec, respectively, via the conductive particles 42 (see FIG. 30(C)). If the binder resin 41 is the thermosetting resin, the binder resin is hardened by the applied heat so that the driver IC 82b is adhered to the substrate Sbc. If the binder resin 41 is thermoplastic resin, it is cooled after heating so that the driver IC 82b is adhered to the substrate Sbc.

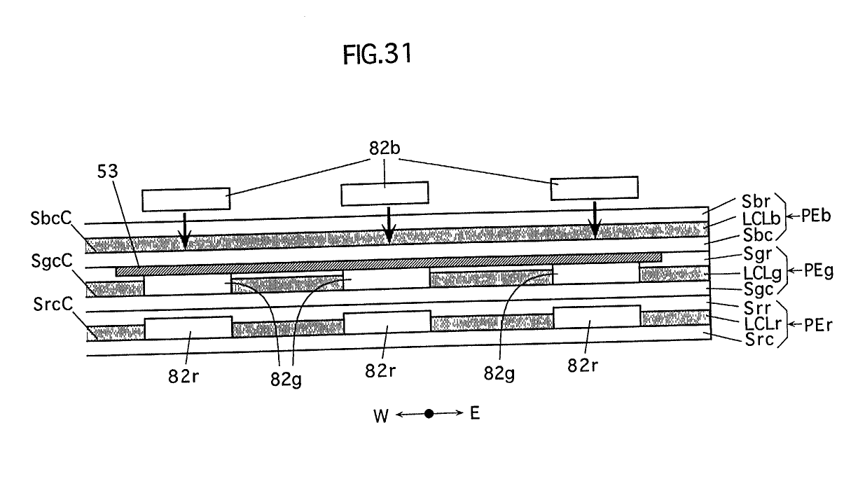

When mounting the driver IC 82b onto the connection portion SbcC, as shown in FIG. 31, the driver ICs 82g and 82r are already mounted on the connection portions SgcC and SrcC located under the connection portion SbcC, respectively.

Therefore, it is difficult to apply the heat and/or pressure only to the driver IC 82b, the substrate connection portion SbcC and the ACF used for mounting the driver IC 82b in some cases.

The pressure may be applied between the front side of the driver IC 82b and the back side of the substrate Src located at the lowermost. The pressure may be applied to the driver IC 82b through the driver ICs 82g and 82r already mounted.

The heat may be applied from the front side of the driver IC 82b to the ACF used for mounting the driver IC 82b. When applying the heat in the manner as described above, if the heat is transferred to the ACF used for mounting the driver ICs 82g and/or 82r, the following disadvantage occurs in some cases.

For example, the heat changes the state of the ACF (particularly, the binder resin of the ACF) used for mounting the driver ICs 82g and/or 82r so that the positions of the driver ICs 82g and/or 82r change in some cases. Further, the pressure is applied to the conductive particles of the ACF used for the driver ICs 82g and/or 82r for an excessively long time so that the conductive particles are collapse in some cases. If the conductive particles collapse, a failure in the electrical connection (conduction) between the bump of the driver IC and the belt-like electrodes is liable to occur. In particular, the above disadvantage is liable to occur if the binder resin of the ACF is thermoplastic resin.

For suppressing the above disadvantage, a heat insulator 53 may be arranged between the connection portion SbcC and the driver IC 82g located under the connection portion SbcC as shown in FIG. 31 when mounting the driver IC 82b onto the connection portion SbcC. The heat insulator 53 can reduce the heat transmitted to the ACF used for mounting the driver ICs 82g and 82r.

The material, specific heat and others of the heat insulator 53 may be determined such that the heat insulator can keep the temperature of the binder resin of the ACF, used for mounting the driver ICs 82g and 82r, not exceeding the softening point (softening temperature) of the binder resin after applying the predetermined pressure and the predetermined heat required for mounting the driver IC 82b for a predetermined time. For example, such the heat insulator may be employed that the heat insulator can keep the temperature of the binder resin of the ACF, used for the driver IC 82g nearer to the driver IC 82b to be mounted, lower than or equal to about 120° C. after the heat of about 140° C. is applied to the driver IC 82b from the front side for about 20 seconds.

By arranging the heat insulator 53 as described above, the driver IC 82b can be mounted while suppressing shifting of positions of the mounted driver ICs 82g and/or 82r.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A multi-layer display panel comprising:
a plurality of panel elements layered together, wherein
each of the panel elements has first and second substrates opposed to each other;
a column electrode is formed on an electrode formation surface of the first substrate of each of the panel elements, the electrode formation surface of the first substrate of the panel element being opposed to the second substrate of the same panel element;
a row electrode is formed on an electrode formation surface of the second substrate of each of the panel elements, the electrode formation surface of the second substrate of the panel element being opposed to the first substrate of the same panel element;
the first substrate of each of the panel elements has an overlap portion overlapping with all the other substrates, and a connection portion extending from the overlap portion and used for connecting the column electrode on the first substrate to a driver element;
the second substrate of each of the panel elements has an overlap portion overlapping with all the other substrates, and a connection portion extending from the overlap portion and used for connecting the row electrode on the second substrate to a driver element;
all extending directions of the connection portions of the first substrates of the panel elements are same; and
all extending directions of the connection portions of the second substrates of the panel elements are same.

2. The multi-layer display panel according to claim 1, wherein
all the connection portions of the first substrates of the panel elements have same width in the extending direction thereof, and overlap with each other.

3. The multi-layer display panel according to claim 1, wherein
widths, in the extending direction of the connection portion of the first substrate, of the connection portions of the respective first substrates are different from each other, and are increased in accordance with a layering order of the first substrates; and
at least a portion of the electrode formation surface of the connection portion of each of the first substrates is exposed.

4. The multi-layer display panel according to claim 1, wherein
at least a portion of the connection portion of each of the first substrates has a width, in a perpendicular direction perpendicular to the extending direction of the connection portion of the first substrate, smaller than a width, in the perpendicular direction, of the overlap portion from which the connection portion of the first substrate is extended, and
positions of the connection portions of the respective first substrates are shifted from each other in the perpendicular direction such that at least a portion of the electrode formation surface of the connection portion of each of the first substrates is exposed.

5. The multi-layer display panel according to claim 1, wherein
all the connection portions of the second substrates of the panel elements have same width in the extending direction thereof, and overlap with each other.

6. The multi-layer display panel according to claim 1, wherein
widths, in the extending direction of the connection portion of the second substrate, of the connection portions of the respective second substrates are different from each other, and are increased in accordance with a layering order of the second substrates; and
at least a portion of the electrode formation surface of the connection portion of each of the second substrates is exposed.

7. The multi-layer display panel according to claim 1, wherein
at least a portion of the connection portion of each of the second substrates has a width, in a perpendicular direction perpendicular to the extending direction of the connection portion of the second substrate, smaller than a width, in the perpendicular direction, of the overlap portion from which the connection portion of the second substrate is extended, and
positions of the connection portions of the respective second substrates are shifted from each other in the perpendicular direction such that at least a portion of the electrode formation surface of the connection portion of each of the second substrates is exposed.

8. The multi-layer display panel according to claim 1, wherein
the driver element is mounted on the connection portion of the substrate of the panel element.

9. The multi-layer display panel according to claim 8, wherein
a junction substrate is connected to the connection portion of the substrate of the panel element for connecting the driver element to a control portion of a driver device.

10. The multi-layer display panel according to claim 1, wherein
a driver element carrier substrate carrying the driver element is connected to the connection portion of the substrate of the panel element.

11. The multi-layer display panel according to claim 1, wherein
one of the neighboring two substrates of the neighboring two panel elements is the first substrate, and the other is the second substrate.

12. The multi-layer display panel according to claim 1, wherein
all the electrode formation surfaces of the first substrates of the panel elements are directed in same direction, and
all the electrode formation surfaces of the second substrates of the panel elements are directed in same direction.

13. A method of manufacturing a multi-layer display panel provided with a plurality of panel elements layered together, comprising:
a panel element forming step of forming each of the panel elements using a first substrate provided with a column electrode at an electrode formation surface and a second substrate provided with a row electrode at an electrode formation surface;
an adhering step of adhering the panel elements in a predetermined order; and
a driver element connecting step of connecting the electrode on the substrate of the panel element to a driver element by mounting the driver element onto the substrate of the panel element or by connecting a driver element carrier substrate carrying the driver element to the substrate of the panel element, wherein
the multi-layer display panel is manufactured such that the first substrate of each of the panel elements is provided with an overlap portion overlapping with all the other substrates of the panel elements, and a connection portion extending from the overlap portion and used for connecting the column electrode on the first substrate to the driver element,
the multi-layer display panel is manufactured such that the second substrate of each of the panel elements is provided with an overlap portion overlapping with all the other substrates of the panel elements, and a connection portion extending from the overlap portion and used for connecting the row electrode on the second substrate to the driver element,
in the panel element forming step, the first and second substrates of the same panel element are overlaid together to form the panel element such that each of the column and row electrodes is located at an inner side of the overlaid first and second substrates,
in the driver element connecting step, the driver element is mounted onto the connection portion of the substrate of the panel element, or the driver element carrier substrate is connected to the connection portion of the substrate of the panel element, for connecting the electrode on the substrate of the panel element to the driver element,
in the adhering step, the panel elements are adhered together while handling at least one of the panel elements to be adhered together as a base panel element, and handling at least one of the panel elements to be adhered together as an additional-adhered panel element to be adhered to the base panel element,
the driver element connecting step with respect to the connection portion, having the electrode formation surface to be hidden by the additional-adhered panel element after adhering the base and additional-adhered panel elements, of the substrate of the base panel element is performed before adhering the base and additional-adhered panel elements, and
the driver element connecting step with respect to the connection portion, having the electrode formation surface to be hidden by the base panel element after adhering the base and additional-adhered panel elements, of the substrate of the additional-adhered panel element is performed before adhering the base and additional-adhered panel elements.

14. The method of manufacturing the multi-layer display panel according to claim 13, wherein
when three or more of the panel elements are adhered together in the adhering step,
firstly, two panel elements among the three or more panel elements are adhered together while handling one of the two panel elements as the base panel element and handling the other panel element as the additional-adhered panel element,
thereafter, the remaining panel element(s) are adhered one by one to the panel elements already adhered while handling the panel elements already adhered as the base panel element.

15. The method of manufacturing the multi-layer display panel according to claim 13, wherein
the driver element connecting step with respect to the connection portion, having the electrode formation surface to be exposed even after adhering the base and additional-adhered panel elements, of the substrate of the additional-adhered panel element is performed after adhering the base and additional-adhered panel elements.

16. The method of manufacturing the multi-layer display panel according to claim 13, wherein
the driver element connecting step with respect to the connection portion of each of the first and second substrates of the panel element firstly handled as the base panel element is performed before adhering the panel element firstly handled as the base panel element and the additional-adhered panel element.

17. The method of manufacturing the multi-layer display panel according to claim 13, further comprising:
a junction substrate connecting step of connecting a junction substrate to the connection portion of the substrate of the panel element for connecting the driver element to be mounted on the same connection portion to a control portion of a driver device, wherein
the junction substrate connecting step with respect to the connection portion, having the electrode formation surface to be hidden by the other panel element after all the panel elements are adhered together, of the substrate of the panel element is performed in same timing as the driver element is mounted onto the same connection portion.

18. The method of manufacturing the multi-layer display panel according to claim 13, further comprising:
a coating step of applying a predetermined coating onto at least a portion of a surface of the driver element mounted on or to be mounted onto the connection portion of the substrate of the panel element, the surface, onto which the predetermined coating is applied, of the driver element being a back surface of a surface, opposed to or to be opposed to the connection portion of the substrate of the panel element, of the driver element.

19. The method of manufacturing the multi-layer display panel according to claim 18, wherein
the coating is applied in a whitish color in the coating step.

20. The method of manufacturing the multi-layer display panel according to claim 13, further comprising:
a coating step of applying a predetermined coating onto at least a portion of a surface of the connection portion of the substrate of the panel element, the surface onto which the predetermined coating is applied being a back surface of a surface, onto which the driver element is to be mounted, of the connection portion of the substrate of the panel element, the portion onto which the predetermined coating is applied being corresponding to a driver element mounting region, onto which the driver element is to be mounted, of the connection portion of the substrate of the panel element.

21. The method of manufacturing the multi-layer display panel according to claim 20, wherein
the coating is applied in a whitish color in the coating step.

22. The method of manufacturing the multi-layer display panel according to claim 13, wherein
the driver element is mounted onto the connection portion of each of the first substrates of each of the panel elements, and the driver elements mounted on the connection portions of the first substrates are located at positions overlapping with each other.

23. The method of manufacturing the multi-layer display panel according to claim 22, wherein
when mounting the driver element at a position, on the first substrate of the panel element, overlapping with the driver element already mounted on the connection portion of the other first substrate of the other panel element in the driver element connecting step, a heat insulator is arranged between the connection portion of the first substrate onto which the driver element is to be currently mounted and the driver element already mounted on the connection portion of the other first substrate.

24. The method of manufacturing the multi-layer display panel according to claim 23, wherein
a specific heat of the heat insulator is smaller than a specific heat of the first substrate of the panel element.

25. The method of manufacturing the multi-layer display panel according to claim 13, wherein
the driver element is mounted onto the connection portion of each of the second substrates of each of the panel elements, and the driver elements mounted on the connection portions of the second substrates are located at positions overlapping with each other.

26. The method of manufacturing the multi-layer display panel according to claim 25, wherein
when mounting the driver element at a position, on the second substrate of the panel element, overlapping with the driver element already mounted on the connection portion of the other second substrate of the other panel element in the driver element connecting step, a heat insulator is arranged between the connection portion of the second substrate onto which the driver element is to be currently mounted and the driver element already mounted on the connection portion of the other second substrate.

27. The method of manufacturing the multi-layer display panel according to claim 26, wherein
a specific heat of the heat insulator is smaller than a specific heat of the second substrate of the panel element.

28. The method of manufacturing the multi-layer display panel according to claim 13, wherein
the base and additional-adhered panel elements are adhered together from one end portion thereof to the other end portion in the adhering step.

29. The method of manufacturing the multi-layer display panel according to claim 13, wherein
the base and additional-adhered panel elements are adhered together from a central portion thereof to opposite end portions in the adhering step.

30. The method of manufacturing the multi-layer display panel according to claim 13, wherein
the multi-layer display panel, in which all the electrode formation surfaces of the connection portions of the first and second substrates of all the panel elements are exposed even after adhering all the panel elements, is manufactured, and
the driver element connecting step with respect to all the connection portions of the first and second substrates of all the panel elements are performed after adhering all the panel elements.

31. The method of manufacturing the multi-layer display panel according to claim 13, wherein
the multi-layer display panel, in which at least one electrode formation surface of the connection portion of the substrate of the panel element is hidden by the other panel element after adhering all the panel elements, is manufactured.

32. A method of manufacturing a multi-layer display panel provided with a plurality of panel elements layered together, comprising:
a panel element forming step of forming each of the panel elements using a first substrate provided with a column electrode at an electrode formation surface and a second substrate provided with a row electrode at an electrode formation surface;
an adhering step of adhering the panel elements in a predetermined order; and
a driver element connecting step of connecting the electrode on the substrate of the panel element to a driver element by mounting the driver element onto the substrate of the panel element or by connecting a driver element carrier substrate carrying the driver element to the substrate of the panel element, wherein
the multi-layer display panel is manufactured such that the first substrate of each of the panel elements is provided with an overlap portion overlapping with all the other substrates of the panel elements, and a connection portion extending from the overlap portion and used for connecting the column electrode on the first substrate to the driver element,
the multi-layer display panel is manufactured such that the second substrate of each of the panel elements is provided with an overlap portion overlapping with all the other substrates of the panel elements, and a connection portion extending from the overlap portion and used for connecting the row electrode on the second substrate to the driver element,
in the panel element forming step, the first and second substrates of the same panel element are overlaid together to form the panel element such that each of the column and row electrodes is located at an inner side of the overlaid first and second substrates,
in the driver element connecting step, the driver element is mounted onto the connection portion of the substrate of the panel element, or the driver element carrier substrate is connected to the connection portion of the substrate of the panel element, for connecting the electrode on the substrate of the panel element to the driver element,
in the adhering step, the panel elements are adhered together while handling at least one of the panel elements to be adhered together as a base panel element, and handling at least one of the panel elements to be adhered together as an additional-adhered panel element to be adhered to the base panel element, and
the driver element connecting step with respect to the connection portion of only one of the first and second substrates of the additional-adhered panel element is performed before adhering the base and additional-adhered panel elements, and the driver element connecting step with respect to the connection portion of the other substrate of the additional-adhered panel element is performed after adhering the base and additional-adhered panel elements.

33. The method of manufacturing the multi-layer display panel according to claim 32, wherein
when three or more of the panel elements are adhered together in the adhering step,
firstly, two panel elements among the three or more panel elements are adhered together while handling one of the two panel elements as the base panel element and handling the other panel element as the additional-adhered panel element,
thereafter, the remaining panel element(s) are adhered one by one to the panel elements already adhered while handling the panel elements already adhered as the base panel element.

34. The method of manufacturing the multi-layer display panel according to claim 32, wherein
the connection portion, with respect to which the driver element connecting step is performed before adhering the base and additional-adhered panel elements, of the substrate of the additional-adhered panel element is the connection portion of the substrate, to be located remoter from the base panel element, among the first and second substrates of the additional-adhered panel element.

35. The method of manufacturing the multi-layer display panel according to claim 32, wherein
the driver element connecting step with respect to the connection portion of the substrate, to be located remoter from the additional-adhered panel element, among the first and second substrates of the base panel element is performed before adhering the base and additional-adhered panel elements.

36. The method of manufacturing the multi-layer display panel according to claim 32, wherein
the driver element connecting step with respect to the connection portion of each of the first and second substrates of the panel element firstly handled as the base panel element is performed before adhering the panel element firstly handled as the base panel element and the additional-adhered panel element.

37. The method of manufacturing the multi-layer display panel according to claim 32, further comprising:
a junction substrate connecting step of connecting a junction substrate to the connection portion of the substrate of the panel element for connecting the driver element to be mounted on the same connection portion to a control portion of a driver device, wherein
the junction substrate connecting step with respect to the connection portion, having the electrode formation surface to be hidden by the other panel element after all the panel elements are adhered together, of the substrate of the panel element is performed in same timing as the driver element is mounted onto the same connection portion.

38. The method of manufacturing the multi-layer display panel according to claim 32, further comprising:
a coating step of applying a predetermined coating onto at least a portion of a surface of the driver element mounted on or to be mounted onto the connection portion of the substrate of the panel element, the surface, onto which the predetermined coating is applied, of the driver element being a back surface of a surface, opposed to or to be opposed to the connection portion of the substrate of the panel element, of the driver element.

39. The method of manufacturing the multi-layer display panel according to claim 38, wherein
the coating is applied in a whitish color in the coating step.

40. The method of manufacturing the multi-layer display panel according to claim 32, further comprising:
a coating step of applying a predetermined coating onto at least a portion of a surface of the connection portion of the substrate of the panel element, the surface onto which the predetermined coating is applied being a back surface of a surface, onto which the driver element is to be mounted, of the connection portion of the substrate of the panel element, the portion onto which the predetermined coating is applied being corresponding to a driver element mounting region, onto which the driver element is to be mounted, of the connection portion of the substrate of the panel element.

41. The method of manufacturing the multi-layer display panel according to claim 40, wherein
the coating is applied in a whitish color in the coating step.

42. The method of manufacturing the multi-layer display panel according to claim 32, wherein
the driver element is mounted onto the connection portion of each of the first substrates of each of the panel elements, and the driver elements mounted on the connection portions of the first substrates are located at positions overlapping with each other.

43. The method of manufacturing the multi-layer display panel according to claim 42, wherein
when mounting the driver element at a position, on the first substrate of the panel element, overlapping with the driver element already mounted on the connection portion of the other first substrate of the other panel element in the driver element connecting step, a heat insulator is arranged between the connection portion of the first substrate onto which the driver element is to be currently mounted and the driver element already mounted on the connection portion of the other first substrate.

44. The method of manufacturing the multi-layer display panel according to claim 43, wherein
a specific heat of the heat insulator is smaller than a specific heat of the first substrate of the panel element.

45. The method of manufacturing the multi-layer display panel according to claim 32, wherein
the driver element is mounted onto the connection portion of each of the second substrates of each of the panel elements, and the driver elements mounted on the connection portions of the second substrates are located at positions overlapping with each other.

46. The method of manufacturing the multi-layer display panel according to claim 45, wherein
when mounting the driver element at a position, on the second substrate of the panel element, overlapping with the driver element already mounted on the connection portion of the other second substrate of the other panel element in the driver element connecting step, a heat insulator is arranged between the connection portion of the second substrate onto which the driver element is to be currently mounted and the driver element already mounted on the connection portion of the other second substrate.

47. The method of manufacturing the multi-layer display panel according to claim 46, wherein
a specific heat of the heat insulator is smaller than a specific heat of the second substrate of the panel element.

48. The method of manufacturing the multi-layer display panel according to claim 32, wherein
the base and additional-adhered panel elements are adhered together from one end portion thereof to the other end portion in the adhering step.

49. The method of manufacturing the multi-layer display panel according to claim 32, wherein
the base and additional-adhered panel elements are adhered together from a central portion thereof to opposite end portions in the adhering step.

50. The method of manufacturing the multi-layer display panel according to claim 32, wherein
the multi-layer display panel, in which all the electrode formation surfaces of the connection portions of the first and second substrates of all the panel elements are exposed even after adhering all the panel elements, is manufactured.

51. The method of manufacturing the multi-layer display panel according to claim 32, wherein
the multi-layer display panel, in which at least one electrode formation surface of the connection portion of the substrate of the panel element is hidden by the other panel element after adhering all the panel elements, is manufactured.
